(19) United States
(12) Patent Application Publication
(10) Pub. No.: US 2016/0005155 A1
(43) Pub. Date: Jan. 7, 2016

(54) IMAGE PROCESSING DEVICE AND IMAGE PROCESSING METHOD

(71) Applicant: SONY CORPORATION, Minato-ku, Tokyo (JP)

(72) Inventor: KAZUSHI SATO, KANAGAWA (JP)

(73) Assignee: SONY CORPORATION, Minato-ku, Tokyo (JP)

(21) Appl. No.: 14/770,875

(22) PCT Filed: Jan. 14, 2014
(86) PCT No.: PCT/JP2014/050483

§ 371 Date: Aug. 27, 2015

(30) Foreign Application Priority Data
Mar. 19, 2013 (JP) 2013-056702
Apr. 5, 2013 (JP) 2013-079667
Jul. 9, 2013 (JP) 2013-143703
Oct. 2, 2013 (JP) 2013-207300

(51) Int. Cl. G06T 5/10

(52) U.S. Cl. CPC G06T 5/10; G06T 2207/10024

(57) ABSTRACT

There is provided an image processing device including an upsampling filter configured to upsample an image of a first layer referred to at a time of decoding of an image of a second layer with a higher space resolution than the first layer, and a control section configured to switch a filter configuration of the upsampling filter for each block of an image.

### TECHNICAL FIELD

The present disclosure relates to an image processing device and an image processing method.

### BACKGROUND ART

The standardization of an image coding scheme called High Efficiency Video Coding (HEVC) by Joint Collaboration Team-Video Coding (JCTVC), which is a joint standardization organization of ITU-T and ISO/IEC, is currently under way for the purpose of improving encoding efficiency more than H. 264/AVC (for example, Non-Patent Literature 1 below).

HEVC provides not only coding of a single layer but also scalable video coding, as in known image coding schemes such as MPEG2 and Advanced Video Coding (AVC) (for example, see Non-Patent Literature 2 below). An HEVC scalable video coding technology is also called Scalable HEVC (SHVC). In SHVC, while an enhancement layer is encoded in the HEVC scheme, a base layer may be encoded in the HEVC scheme or encoded in an image coding scheme other than the HEVC scheme (for example, Non-Patent Literature 2 below).

Generally, scalable video coding refers to a technology for hierarchically encoding a layer transmitting a rough image signal and a layer transmitting a fine image signal. Typical attributes hierarchized in the scalable video coding mainly include the following three:
Space scalability: Spatial resolutions or image sizes are hierarchized.
Time scalability: Frame rates are hierarchized.
Signal-to-noise ratio (SNR) scalability: SN ratios are hierarchized.

Further, though not yet adopted in the standard, the bit depth scalability and chroma format scalability are also discussed.

In the scalable video coding for realizing the space scalability, an image in a lower layer is upsampled, and then is used to encode or decode an image in an upper layer. According to Non-Patent Literature 2, an upsampling filter used in SHVC is designed to be the same as an interpolation filter for performing motion compensation. An interpolation filter for motion compensation defined in Non-Patent Literature 1 has 7 taps or 8 taps for a luma component and 4 taps for a chroma component.

In Non-Patent Literature 3, several schemes for inter-layer prediction are proposed. A decoded image in a base layer is upsampled in intra BL prediction among the schemes, and then is referred to in an enhancement layer. In intra residual prediction and inter residual prediction, a predicted error (residual) image in a base layer is upsampled, and then is referred to in an enhancement layer.

### CITATION LIST

### Non-Patent Literature

Non-Patent Literature 1: “High Efficiency Video Coding (HEVC) text specification draft 10 (for FDIS & Consent)” by Benjamin Bross, Woo-Jin Han, Gary J. Sullivan, Jens-Rainer Ohm, Gary J. Sullivan, Ye-Kui Wang, Thomas Wiegand, (JCTVC-L1003v4, 14 to 23 Jan. 2013)
Non-Patent Literature 2: “SHVC Test Model 1 (SHM 1)” by Jianle Chen, Jill Boyce, Yan Ye, Miska M. Hannuksela, (JCTVC-L1007, 14 to 23 Jan. 2013)
Non-Patent Literature 3: “Description of scalable video coding technology proposal by Qualcomm (configuration 2)” by Jianle Chen, el. al, (JCTVC-K0036, 10 to 19 Oct. 2012)

### SUMMARY OF INVENTION

### Technical Problem

In general, a calculation cost of upsampling depends on the configuration of an upsampling filter and a space resolution. To suppress the calculation cost, for example, it is desirable to reduce the number of filter taps. However, uniform reduction in the filter taps results in deterioration in image quality.

Accordingly it is desirable to supply a structure capable of adaptively controlling the configuration of an upsampling filter while preventing deterioration in image quality.

### Solution to Problem

According to the present disclosure, there is provided an image processing device including: an upsampling filter configured to upsample an image of a first layer referred to at a time of decoding of an image of a second layer with a higher space resolution than the first layer; and a control section configured to switch a filter configuration of the upsampling filter for each block of an image.

The image processing device may be implemented as an image decoding device that decodes an image. The image processing device may be implemented as an image encoding device including a local decoder.

According to the present disclosure, there is provided an image processing method including: upsampling an image of a first layer referred to at a time of decoding of an image of a second layer with a higher space resolution than the first layer using an upsampling filter; and switching a filter configuration of the upsampling filter for each block of an image.

### Advantageous Effects of Invention

According to the technology according to an embodiment of the present disclosure, it is possible to adaptively control the configuration of the upsampling filter while preventing the deterioration in image quality.

### BRIEF DESCRIPTION OF DRAWINGS

FIG. 1 is an illustrative diagram for describing scalable video coding.

FIG. 2A is an illustrative diagram for describing upsampling of a decoded image.

FIG. 2B is an illustrative diagram for describing upsampling of a predicted error image.

FIG. 3 is a block diagram showing a schematic configuration of an image encoding device.

FIG. 4 is a block diagram showing a schematic configuration of an image decoding device.

FIG. 5 is a block diagram showing an example of a configuration of an EL encoding section according to a first embodiment.

FIG. 6 is a block diagram illustrating an example of a configuration of an upsampling section according to a first execution example.

FIG. 7A is an illustrative diagram for describing a first example of a relation between a high-frequency component parameter and the number of filter taps.

FIG. 7B is an illustrative diagram for describing a second example of a relation between a high-frequency component parameter and the number of filter taps.

FIG. 7C is an illustrative diagram for describing a third example of a relation between a high-frequency component parameter and the number of filter taps.

FIG. 7D is an illustrative diagram for describing a fourth example of a relation between a high-frequency component parameter and the number of filter taps.

FIG. 7E is an illustrative diagram for describing a fifth example of a relation between a high-frequency component parameter and the number of filter taps.

FIG. 7F is an illustrative diagram for describing a sixth example of a relation between a high-frequency component parameter and the number of filter taps.

FIG. 7G is an illustrative diagram for describing a seventh example of a relation between a high-frequency component parameter and the number of filter taps.

FIG. 8 is a block diagram illustrating an example of a configuration of an upsampling section according to a second execution example.

FIG. 9 is a flow chart showing an example of the flow of a schematic process for encoding.

FIG. 10 is a flow chart showing a first example of the flow of an upsampling process according to the first execution example in an encoding process for an enhancement layer.

FIG. 11 is a flow chart showing a second example of the flow of an upsampling process according to the first execution example in an encoding process for an enhancement layer.

FIG. 12 is a flow chart showing an example of the flow of an upsampling process according to the second execution example in an encoding process for an enhancement layer.

FIG. 13 is a flow chart showing an example of the flow of an upsampling process according to a modification example related to upsampling of a chroma component.

FIG. 14 is a block diagram illustrating an example of a configuration of an EL decoding section according to the first embodiment.

FIG. 15 is a block diagram illustrating an example of a configuration of the upsampling section according to the first execution example.

FIG. 16 is a block diagram illustrating an example of a configuration of an upsampling section according to the second execution example.

FIG. 17 is a flow chart showing an example of the flow of a schematic process for decoding.

FIG. 18 is a flow chart showing an example of the flow of an upsampling process according to the second execution example in a decoding process for an enhancement layer.

FIG. 19 is a flow chart showing an example of the flow of an inverse quantization process in a decoding process for an enhancement layer.

FIG. 20 is a block diagram showing an example of a configuration of an EL encoding section according to a second embodiment.

FIG. 21 is a block diagram illustrating an example of the configuration of the upsampling section illustrated in FIG. 20.

FIG. 22 is an illustrative diagram for describing a modification example of the second embodiment.

FIG. 23 is a block diagram showing an example of a configuration of an EL decoding section according to the second embodiment.

FIG. 24 is a block diagram illustrating an example of a configuration of the upsampling section illustrated in FIG. 23.

FIG. 25 is a flow chart showing an example of the flow of an upsampling process in the encoding process for the enhancement layer.

FIG. 26 is a flow chart showing an example of the flow of an upsampling process in a decoding process for the enhancement layer.

FIG. 27 is a block diagram showing an example of a schematic configuration of a television.

FIG. 28 is a block diagram showing an example of a schematic configuration of a mobile phone.

FIG. 29 is a block diagram showing an example of a schematic configuration of a recording and reproduction device.

FIG. 30 is a block diagram showing an example of a schematic configuration of an imaging device.

FIG. 31 is an illustrative diagram for describing a first example of use of the scalable video coding.

FIG. 32 is an illustrative diagram for describing a second example of use of the scalable video coding.

FIG. 33 is an illustrative diagram for describing a third example of use of the scalable video coding.

FIG. 34 is an illustrative diagram for describing a multi-view codec.

FIG. 35 is a block diagram showing a schematic configuration of an image encoding device for the multi-view codec.

FIG. 36 is a block diagram showing a schematic configuration of an image decoding device for the multi-view codec.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

The description will be made in the following order.

1. Overview

1-1. Scalable video coding

1-2. Upsampling of image in base layer

1-3. Basic configuration example of an encoder

1-4. Basic configuration example of a decoder

2. Configuration example of an EL encoding section (First embodiment)

2-1. Overall configuration

2-2. Upsampling section (First execution example)

2-3. Upsampling section (Second execution example)

3. Flow of a process for encoding (First embodiment)

3-1. Schematic flow

3-2. Upsampling process

3-3. Modification example

4. Configuration example of an EL decoding section (First embodiment)

4-1. Overall configuration

4-2. Upsampling section (First execution example)

4-3. Upsampling section (Second execution example)

5. Flow of a process of decoding (First embodiment)

5-1. Schematic flow

5-2. Upsampling process

5-3. Modification example

5-4. Inverse quantization process

6. Second Embodiment

6-1. Configuration example of EL encoding section

6-2. Configuration example of EL decoding section

6-3. Flow of upsampling process for encoding

6-4. Flow of upsampling process for decoding

7. Application example

7-1. Application to various products

7-2. Various uses of scalable video coding

7-3. Others

8. Conclusion

### 1. Overview

[1-1. Scalable Video Coding]

In scalable video coding, a plurality of layers, each containing a series of images, are encoded. A base layer is a layer encoded first to represent a roughest image. An encoded stream of the base layer may be independently decoded without decoding encoded streams of other layers. Layers other than the base layer are layers called enhancement layers representing finer images. Encoded streams of the enhancement layers are encoded by using information contained in the encoded stream of the base layer. Therefore, to reproduce an image of an enhancement layer, encoded streams of both the base layer and the enhancement layer are decoded. The number of layers handled in the scalable video coding may be any number equal to or greater than 2. When three layers or more are encoded, the lowest layer is the base layer and the remaining plural layers are enhancement layers. For an encoded stream of a higher enhancement layer, information contained in encoded streams of a lower enhancement layer and the base layer may be used for encoding and decoding.

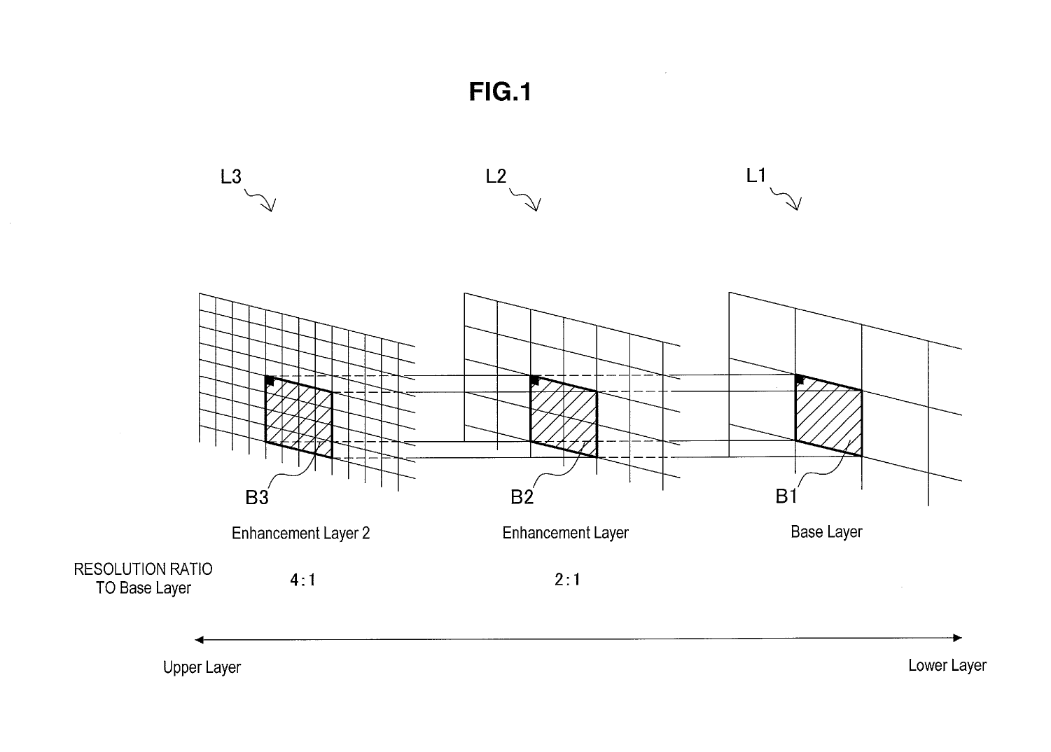

FIG. 1 shows three layers L1, L2, and L3 subjected to scalable video coding. The layer L1 is a base layer and the layers L2 and L3 are enhancement layers. Note that, among various kinds of scalabilities, space scalability is taken as an example herein. A space resolution ratio of the layer L2 to the layer L1 is 2:1. A space resolution ratio of the layer L3 to the layer L1 is 4:1. The resolution ratios herein are merely examples, and for example, a resolution ratio of a non-integer such as 1.5:1 may be used. A block B1 of the layer L1 is a processing unit of an encoding process in a picture of the base layer. A block B2 of the layer L2 is a processing unit of an encoding process in a picture of the enhancement layer to which a common scene to the block B1 is projected. The block B2 corresponds to the block B1 of the layer L1. A block B3 of the layer L3 is a processing unit of an encoding process in a picture of the enhancement layer higher than the layers to which the common scene to the blocks B1 and B2 is projected. The block B3 corresponds to the block B1 of the layer L1 and the block B2 of the layer L2.

[1-2. Upsampling of Image in Base Layer]

In the layer structure exemplified in FIG. 1, the textures of the images are similar between the layers to which the common scene is projected. That is, the textures of the images of the block B1 of the layer L1, the block B2 of the layer L2, and the block B3 of the layer L3 are similar. Therefore, when the pixels of the block B2 or the block B3 are predicted using, for example, the block B1 as a reference block or the pixels of the block B3 are predicted using the block B2 as a reference block, there is a probability of high prediction accuracy being obtainable. Such prediction between the layers is referred to as inter layer prediction. In Non-Patent Literature 3, several schemes for inter-layer prediction are proposed. In the intra BL prediction among these schemes, a decoded image (reconstructed image) of the base layer is used as a reference image for predicting a decoded image of an enhancement layer. In intra residual prediction and inter residual prediction, a predicted error (residual) image of the base layer is used as a reference image for predicting a predicted error image of an enhancement layer. When spatial scalability is realized, the space resolution of the enhancement layer is higher than the space resolution of the base layer. Therefore, to use the image of the base layer as the reference image, it is necessary to upsample the image according to a resolution ratio.

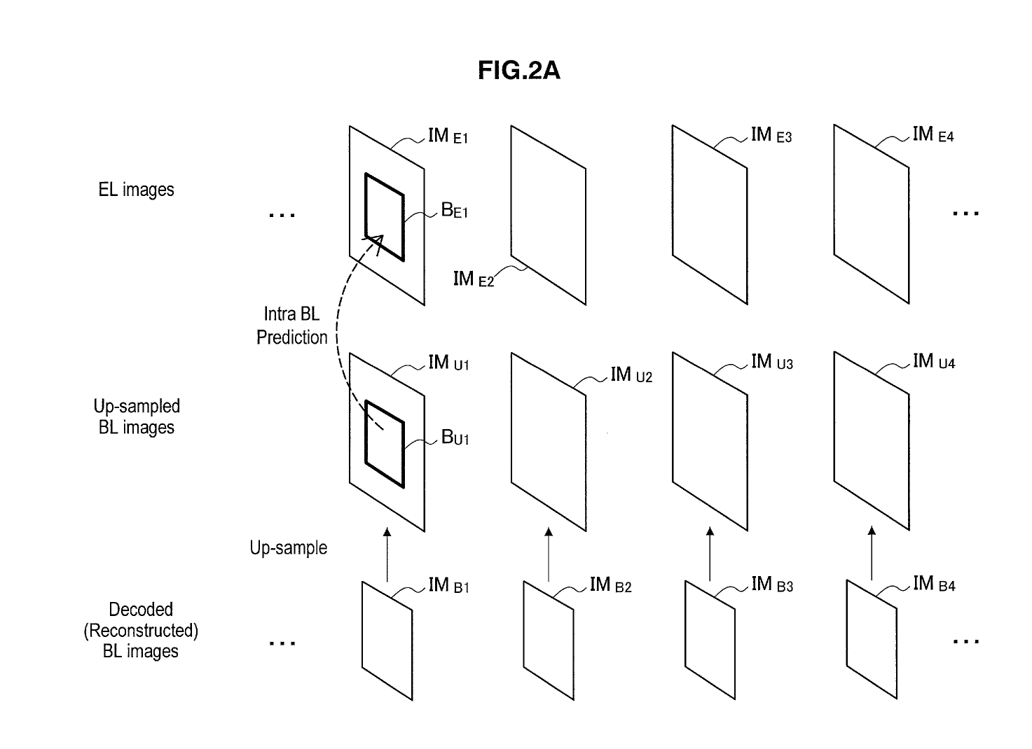

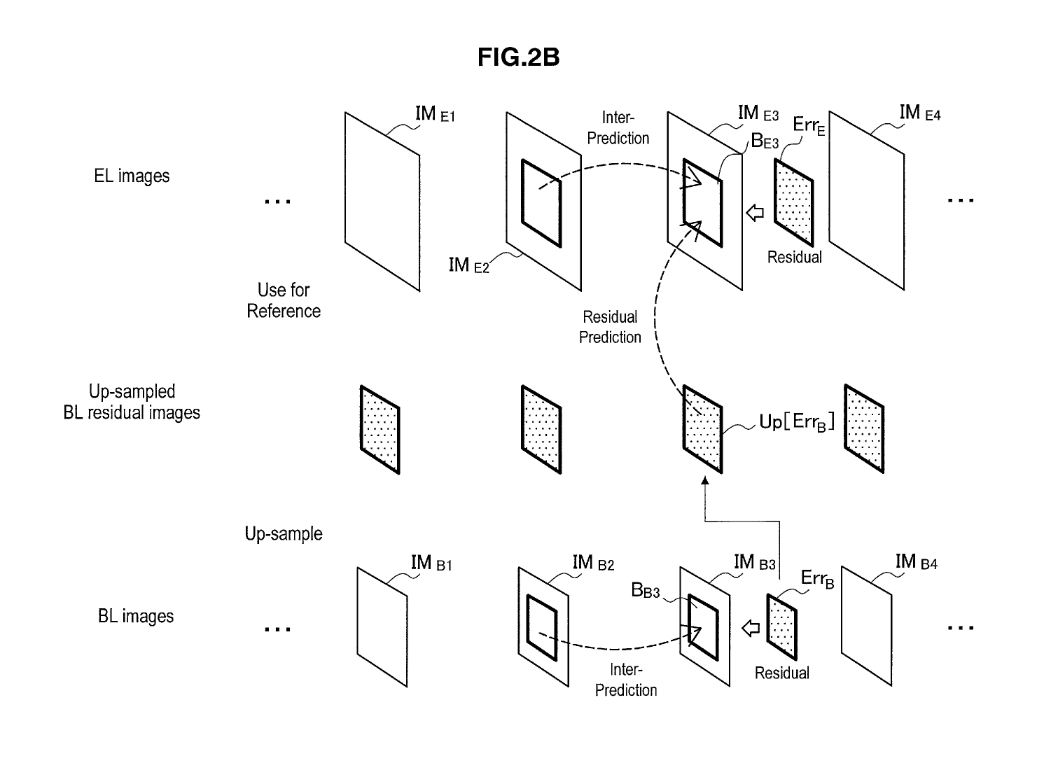

FIG. 2A is an illustrative diagram for describing upsampling of a decoded image. In the lower part of FIG. 2A, base layer images IM_{B1} to IM_{B4} are illustrated. The base layer images IM_{B1} to IM_{B4} are reconstructed images that are generated in an encoding process or a decoding process (including local decoding in an encoder) for the base layer. The base layer image is upsampled according to the resolution ratio between the layers. In the middle part of FIG. 2A, upsampled base layer images IM_{U1} to IM_{U4} are illustrated. In the upper part of FIG. 2A, enhancement layer images IM_{E1} to IM_{E4} are illustrated. For example, a block B_{E1} of the enhancement layer image IM_{E1} is assumed to be a prediction target block. When the intra BL prediction is executed, a difference in the resolution between the prediction target block and the reference block is cancelled by using a block B_{U1} of the upsampled base layer image IM_{U1} as the reference block. Further, high prediction accuracy can be achieved based on correlation of the image between the layers.

FIG. 2B is an illustrative diagram for describing upsampling of a predicted error image. The base layer images IM_{B1} to IM_{B4} are illustrated again in the lower part of FIG. 2B and the enhancement layer images IM_{E1} to IM_{E4} are illustrated again in the upper part thereof. For example, a block B_{E3} of the enhancement layer image IM_{E3} is assumed to be a prediction target block of the inter prediction and the enhancement layer image IM_{B2} is assumed to be a reference picture of the inter prediction. When the inter residual prediction is further executed, a block B_{B3} of the base layer image IM_{B3} is a co-located block of the prediction target block B_{E3} and is a reference block of the inter residual prediction. A relation of a decoded image Cur_{B} of the block B_{B3} with a predicted image Pred_{B} and a predicted error image Err_{B} of the inter prediction in the base layer is expressed as in the following expression.

[Math 1]

Cur_{B}=Pred_{B}+Err_{B} (1)

Further, a relation of a decoded image Cur_{E} of the prediction target block B_{E3} with a predicted image Pred_{E} and a predicted error image Err_{E} of the inter prediction in the enhancement layer is expressed as in the following expression using an upsampled predicted error image Up [Err_{B}] of the base layer.

[Math 2]

Cur_{E}=Pred_{E}+Up[Err_{B}]+Err_{E} (2)

In this way, the difference in the resolution between the prediction target block and the reference block is cancelled by upsampling the predicted error image of the base layer in the residual prediction. Further, based on the correlation of the predicted error between the layers, it is possible to reduce predicted error data (Err_{E}) to be encoded.

The inter layer prediction described herein is merely an example. That is, the technology according to the present disclosure can also be applied to kinds of inter layer prediction different from the intra BL prediction and the residual prediction described above.

An upsampling filter for the inter layer prediction is designed generally like an interpolation filter for motion compensation. Referring to “Fractional sample interpolation process” in 8.5.3.2.2 of Non-Patent Literature 1, an interpolation filter for motion compensation includes 7 taps or 8 taps for a luma component and 4 taps for a chroma component. When there are more taps, an image of a high-frequency component is reproduced better. Therefore, from the viewpoint of maintenance or improvement in image quality, it is important to configure the upsampling filter with a sufficient number of taps. However, calculation cost of upsampling depends on the configuration of the upsampling filter and a space resolution. When the number of taps of the upsampling filter is large, the calculation cost of the upsampling is also considerable. Accordingly, in the first embodiment to be described below, the filter configuration of the upsampling filter is switched adaptively for each block of an image. The first embodiment includes two main execution examples. In a first execution example, the strength of a high-frequency component of an image for each block is determined on both of an encoding side and a decoding side and the filter configuration of the upsampling filter is switched according to the determined strength of the high-frequency component. In particular, for a block in which the high-pass component of the image is not present or is weak, the image quality does not considerably deteriorate, although the high-pass component is not reproduced, as the result obtained by reducing the number of taps. Therefore, by adaptively switching the filter configuration of the upsampling filter, it is possible to suppress the calculation cost of the upsampling while preventing the deterioration in the image quality. In a second execution example, the filter configuration optimum for each block is determined on the encoding side and filter configuration information indicating the determined filter configuration is encoded. On the decoding side, the filter configuration of the upsampling filter is switched according to the decoded filter configuration information. In the second embodiment, the filter configuration of the upsampling filter is switched adaptively in units rougher than a picture, a sequence, or the like.

[1-3. Basic Configuration Example of an Encoder]

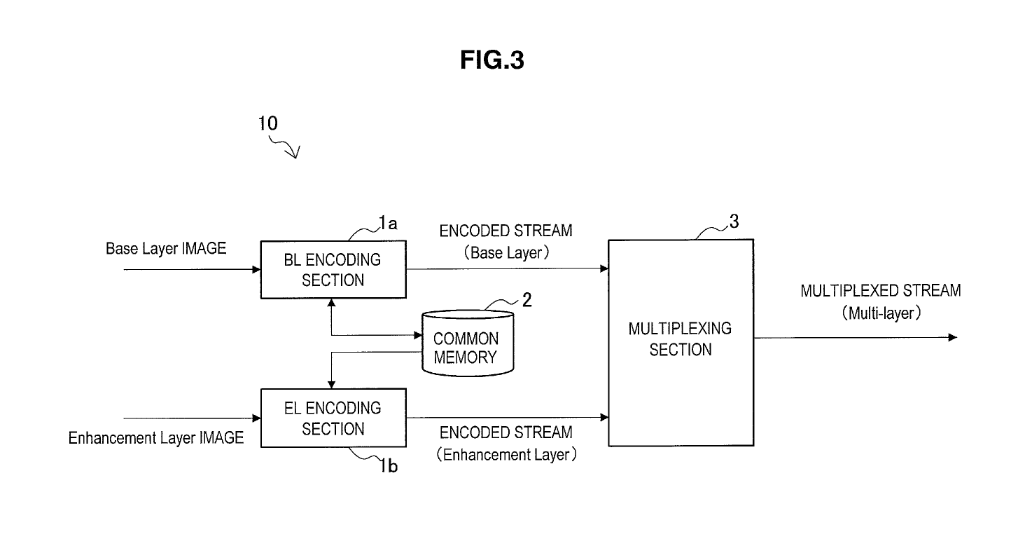

FIG. 3 is a block diagram showing a schematic configuration of an image encoding device 10 supporting scalable video coding. Referring to FIG. 3, the image encoding device 10 includes a base layer (BL) encoding section 1a, an enhancement layer (EL) encoding section 1b, a common memory 2, and a multiplexing section 3.

The BL encoding section 1a encodes a base layer image to generate an encoded stream of the base layer. The EL encoding section 1b encodes an enhancement layer image to generate an encoded stream of an enhancement layer. The common memory 2 stores information commonly used between layers. The multiplexing section 3 multiplexes an encoded stream of the base layer generated by the BL encoding section 1a and an encoded stream of one or more enhancement layers generated by the EL encoding section 1b to generate a multilayer multiplexed stream.

[1-4. Basic Configuration Example of a Decoder]

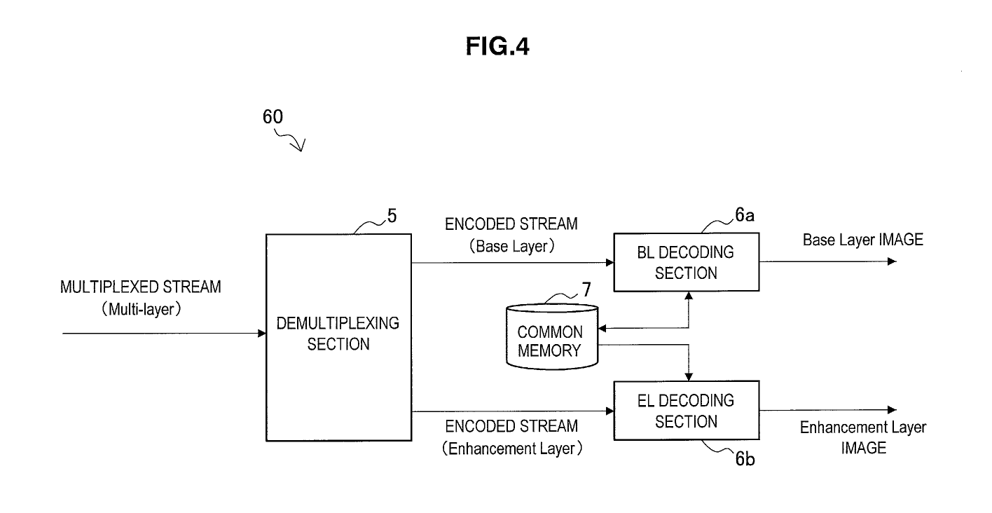

FIG. 4 is a block diagram showing a schematic configuration of an image decoding device 60 supporting scalable video coding. Referring to FIG. 4, the image decoding device 60 includes a demultiplexing section 5, a base layer (BL) decoding section 6a, an enhancement layer (EL) decoding section 6b, and a common memory 7.

The demultiplexing section 5 demultiplexes a multilayer multiplexed stream into an encoded stream of the base layer and an encoded stream of one or more enhancement layers. The BL decoding section 6a decodes a base layer image from an encoded stream of the base layer. The EL decoding section 6b decodes an enhancement layer image from an encoded stream of an enhancement layer. The common memory 7 stores information commonly used between layers.

In the image encoding device 10 illustrated in FIG. 3, the configuration of the BL encoding section 1a to encode the base layer and that of the EL encoding section 1b to encode an enhancement layer are similar to each other. Some parameters and images generated or acquired by the BL encoding section 1a may be buffered by using the common memory 2 and reused by the EL encoding section 1b. In the next section, some of such configurations of the EL encoding section 1b will be described in detail.

Similarly, in the image decoding device 60 illustrated in FIG. 4, the configuration of the BL decoding section 6a to decode the base layer and that of the EL decoding section 6b to decode an enhancement layer are similar to each other. Some parameters and images generated or acquired by the BL decoding section 6a may be buffered by using the common memory 7 and reused by the EL decoding section 6b. Further in the next section, some of such configurations of the EL decoding section 6b will be described in detail.

### 2. Configuration Example of an EL Encoding Section According to an Embodiment

### First Embodiment

### 2-1. Overall Configuration

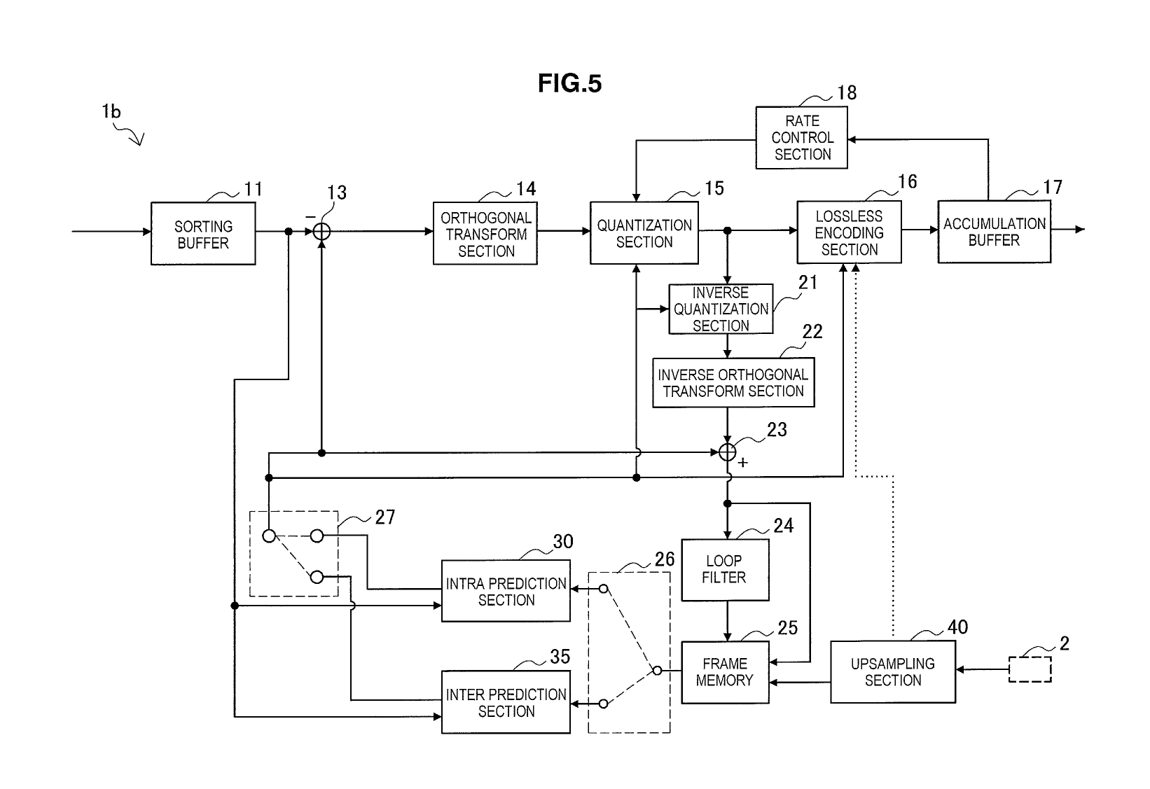

FIG. 5 is a block diagram showing an example of the configuration of the EL encoding section 1b according to the first embodiment. Referring to FIG. 5, the EL encoding section 1b includes a sorting buffer 11, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a loop filter 24, a frame memory 25, selectors 26 and 27, an intra prediction section 30, an inter prediction section 35, and an upsampling section 40.

The sorting buffer 11 sorts the images included in the series of image data. After sorting the images according to a GOP (Group of Pictures) structure according to the encoding process, the sorting buffer 11 outputs the image data which has been sorted to the subtraction section 13, the intra prediction section 30, and the inter prediction section 35.

The image data input from the sorting buffer 11 and predicted image data input by the intra prediction section 30 or the inter prediction section 35 to be described later are supplied to the subtraction section 13. The subtraction section 13 computes predicted error data which is a difference between the image data input from the sorting buffer 11 and the predicted image data and outputs the computed predicted error data to the orthogonal transform section 14.

The orthogonal transform section 14 performs orthogonal transform on the predicted error data input from the subtraction section 13. The orthogonal transform to be performed by the orthogonal transform section 14 may be discrete cosine transform (DCT) or Karhunen-Loeve transform, for example. In HEVC, the orthogonal transform is performed for each block called a transform unit (TU). The TU is a block that is formed by dividing a coding unit (CU). The size of the TU is selected adaptively from 4×4 pixels, 8×8 pixels, 16×16 pixels, and 32×32 pixels. For example, a smaller TU size may be selected so that a fine image can be reproduced in an image region that includes many high-pass (high-frequency band) components. In an image region that does not include many high-pass components, a larger TU size may be selected to reduce the code amount of transform coefficient data. When a certain TU does not include many high-pass components, the transform coefficient data generated as a result of the orthogonal transform on this TU includes many transform coefficients equal to zero. When a certain TU includes many high-pass components, the transform coefficient data generated as a result of the orthogonal transform on this TU include many transform nonzero coefficients. The TU size and the number of transform nonzero coefficients can be known from parameters encoded in each layer. The orthogonal transform section 14 outputs transform coefficient data acquired by the orthogonal transform process to the quantization section 15.

The transform coefficient data input from the orthogonal transform section 14 and a rate control signal from the rate control section 18 to be described below are supplied to the quantization section 15. The rate control signal specifies a quantization parameter of each color component for each block. A quantization matrix (also referred to as a scaling list) can also be specified. The quantization matrix can be defined in advance for each of different TU sizes, color components (Y/Cr/Cb), and prediction modes (intra/inter). The quantization section 15 quantizes the transform coefficient data in a quantization step decided according to the rate control signal. Typically, when the quantization parameter is large, a quantization error of the transform coefficient data is also enlarged. In this case, a high-pass component included in the transform coefficient data is lost more easily than a low-pass component. The value of the quantization parameter can be known from a parameter to be encoded in each layer. When the quantization matrix is used, the quantization section 15 switches the quantization matrix to be used according to the block size of the transform coefficient data, the color component, and a corresponding prediction mode (that is, a prediction mode used when the predicted error data is calculated). The quantization section 15 outputs the quantized transform coefficient data (hereinafter referred to as quantized data) to the lossless encoding section 16 and the inverse quantization section 21.

The value of the transform coefficient data depends on a predicted error of the intra prediction or the inter prediction (here, the transform coefficient data is a result obtained by transforming the predicted error of a space region into a frequency region). In many cases, a reference block of the intra prediction has a different texture (a texture near the same time) from a prediction target block, but a reference block of the inter prediction has the same texture (a texture of the same subject at a different time) as the prediction target block. For this reason, a predicted error of the intra prediction and a predicted error of the inter prediction tend to have different values. This is why different quantization matrixes are defined for the intra prediction and the inter prediction, as described above. However, in intra BL prediction treated as one mode of the intra prediction, a reference block of the base layer at the same position (that is, the same texture) as the prediction target block of the enhancement layer is used. Therefore, when a predicted error is calculated particularly based on the intra BL prediction among the intra prediction modes, the quantization section 15, the quantization section 15 may quantize the transform coefficient data exceptionally using a quantization matrix defined for an inter prediction mode. In this way, it is possible to prevent unintended deterioration in the image quality caused by the quantization after the inter layer prediction.

The lossless encoding section 16 performs a lossless encoding process on the quantized data input from the quantization section 15 to generate an encoded stream of the enhancement layer. The lossless encoding section 16 encodes various parameters referred to when the encoded stream is decoded and inserts the encoded parameters into a header region of the encoded stream. The parameters encoded by the lossless encoding section 16 can include information regarding intra prediction to be described later and information regarding inter prediction. In the first execution example, the parameters related to the strength of the high-pass component can also be encoded in each layer. In the second execution example, the filter configuration information indicating the filter configuration optimum for each block of the upsampling filter can be encoded. Then, the lossless encoding section 16 outputs the generated encoded stream to the accumulation buffer 17.

The accumulation buffer 17 temporarily accumulates the encoded stream input from the lossless encoding section 16 using a storage medium such as a semiconductor memory. Then, the accumulation buffer 17 outputs the accumulated encoded stream to a transmission section that is not shown (for example, a communication interface or a connection interface to peripheral devices) at a rate in accordance with the band of a transmission path.

The rate control section 18 monitors vacant capacity of the accumulation buffer 17. Then the rate control section 18 generates a rate control signal according to the vacant capacity of the accumulation buffer 17 and outputs the generated rate control signal to the quantization section 15. For example, the rate control section 18 generates a rate control signal to reduce the bit rate of the quantized data when the vacant capacity of the accumulation buffer 17 is small. For example, the rate control section 18 generates a rate control signal to increase the bit rate of the quantized data when the vacant capacity of the accumulation buffer 17 is sufficiently large.

The inverse quantization section 21, the inverse orthogonal transform section 22, and the addition section 23 constitute a local decoder. The inverse quantization section 21 inversely quantizes the quantized data of the enhancement layer in the same quantization step as that used by the quantization section 15 to restore the transform coefficient data. When the predicted error data is generated through the intra BL prediction in which the image of the base layer is used as the reference image and the quantization matrix is used, the inverse quantization section 21 may restore the transform coefficient data by inversely quantizing the quantized data of the enhancement layer using the quantization matrix defined for the inter prediction mode. Then the inverse quantization section 21 outputs the restored transform coefficient data to the inverse orthogonal transform section 22.

The inverse orthogonal transform section 22 restores predicted error data by performing an inverse orthogonal transform process on the transform coefficient data input from the inverse quantization section 21. As in the orthogonal transform, the inverse orthogonal transform is executed for each TU. Then, the inverse orthogonal transform section 22 outputs the restored predicted error data to the addition section 23.

The addition section 23 adds the restored predicted error data input from the inverse orthogonal transform section 22 and the predicted image data input from the intra prediction section 30 or the inter prediction section 35 to thereby generate decoded image data (reconstructed image of the enhancement layer). Then, the addition section 23 outputs the generated decoded image data to the loop filter 24 and the frame memory 25.

The loop filter 24 includes a filter group for the purpose of improving the image quality. A deblock filter (DF) is a filter that reduces block distortion occurring when an image is encoded. A sample adaptive offset (SAO) filter is a filter that adds an adaptively decided offset value to each pixel value. Typically, three kinds of offsets, a band offset, an edge offset, and an offset, can be selected as kinds of offsets for each largest coding unit (LCU). When the edge offset is selected, an offset is added to the pixel values of pixels around an edge, and thus mosquito distortion which is an unnecessary high-pass component is removed. When the band offset is selected, an offset is added to a luma component in a specific range, and thus the image quality of a flat image region is improved. An adaptive loop filter (ALF) is a filter that minimizes an error between an original image and an image after the SAO. The loop filter 24 filters the decoded image data input from the addition section 23 and outputs the filtered decoded image data to the frame memory 25.

The frame memory 25 stores the decoded image data of the enhancement layer input from the addition section 23, the filtered decoded image data of the enhancement layer input from the loop filter 24, and the reference image data of the base layer input from the upsampling section 40 using a storage medium.

The selector 26 reads the decoded image data before the filtering used for the intra prediction from the frame memory 25 and supplies the read decoded image data as reference image data to the intra prediction section 30. Further, the selector 26 reads the filtered decoded image data used for the inter prediction from the frame memory 25 and supplies the read decoded image data as reference image data to the inter prediction section 35. When the inter layer prediction is performed in the intra prediction section 30 or the inter prediction section 35, the selector 26 supplies the reference image data of the base layer to the intra prediction section 30 or the inter prediction section 35.

In the intra prediction mode, the selector 27 outputs predicted image data as a result of intra prediction output from the intra prediction section 30 to the subtraction section 13 and also outputs information about the intra prediction to the lossless encoding section 16. Further, in the inter prediction mode, the selector 27 outputs predicted image data as a result of inter prediction output from the inter prediction section 35 to the subtraction section 13 and also outputs information about the inter prediction to the lossless encoding section 16. The information regarding the intra prediction may be output to the quantization section 15 and the inverse quantization section 21 to switch the quantization matrix. The selector 27 switches the inter prediction mode and the intra prediction mode in accordance with the magnitude of a cost function value.

The intra prediction section 30 performs an intra prediction process on each prediction unit (PU) of the HEVC based on the original image data and the decoded image data of the enhancement layer. For example, the intra prediction section 30 evaluates a prediction result according to each candidate mode in a prediction mode set using a predetermined cost function. Next, the intra prediction section 30 selects a prediction mode in which a cost function value is the minimum, i.e., a prediction mode in which a compression ratio is the highest, as an optimum prediction mode. In addition, the intra prediction section 30 generates predicted image data of the enhancement layer according to the optimum prediction mode. The intra prediction section 30 may include the intra BL prediction which is a kind of inter layer prediction in the prediction mode set in the enhancement layer. In the intra BL prediction, a co-located block in the base layer corresponding to the prediction target block in the enhancement layer is used as a reference block and a predicted image is generated based on the decoded image of this reference block. The intra prediction section 30 may include intra residual prediction which is a kind of inter layer prediction. In the intra residual prediction, a predicted error of the intra prediction is predicted based on the predicted error image of the reference block which is the co-located block in the base layer and a predicted image to which the predicted error is added is generated (see the first term and the second term of the right side of Expression (2)). The intra prediction section 30 may apply a smoothing filter to the reference image data in combination of a specific PU size and the intra prediction mode according to a mode-dependent intra smoothing method. The smoothing filter typically includes, 3 taps (here, the filter coefficient is [1, 2, 1]/4), and the high-pass component is easily lost in the block to which the smoothing filter is applied. Further, the intra prediction section 30 outputs information regarding the intra prediction including prediction mode information indicating the selected optimum prediction mode, the cost function value, and the predicted image data to the selector 27.

The inter prediction section 35 performs an inter prediction process on each prediction unit of the HEVC scheme based on the original image data and the decoded image data of the enhancement layer. For example, the inter prediction section 35 evaluates a prediction result according to each candidate mode in a prediction mode set using a predetermined cost function. Next, the inter prediction section 35 selects a prediction mode in which a cost function value is the minimum, i.e., a prediction mode in which a compression ratio is the highest, as an optimum prediction mode. In addition, the inter prediction section 35 generates predicted image data of the enhancement layer according to the optimum prediction mode. In the inter prediction of HEVC, in particular, in a B picture, L0 prediction, L1 prediction, and bi-prediction (B-prediction) can be selected as reference directions for each PU. In the bi-prediction, since a process of averaging two reference blocks is included in the bi-prediction, the high-pass component is easily lost in a block for which the bi-prediction is selected. The inter prediction section 35 may include inter residual prediction which is a kind of inter layer prediction in the prediction mode set in the enhancement layer. In the inter residual prediction, a predicted error of the intra prediction is predicted based on the predicted error image of the reference block which is the co-located block in the base layer and a predicted image to which the predicted error is added is generated (see the first term and the second term of the right side of Expression (2)). Further, the inter prediction section 35 outputs information regarding the inter prediction including prediction mode information and motion information indicating the selected optimum prediction mode, the cost function value, and the predicted image data to the selector 27.

The upsampling section 40 upsamples an image of the base layer buffered by the common memory 2 according to the resolution ratio between the base layer and the enhancement layer. The image upsampled by the upsampling section 40 can be stored in the frame memory 25 and can be used as a reference image in the inter layer prediction by the intra prediction section 30 or the inter prediction section 35. In the first execution example to be described in the following section, the upsampling section 40 switches the filter configuration of the upsampling filter according to the strength of the high-pass component of each block. The upsampling section 40 may switch the filter configuration of the upsampling filter according to a picture type in addition to the strength of the high-pass component of each block. In the following description, a parameter used for the upsampling section 40 to determine the strength of the high-pass component of each block is referred to as a high-pass component parameter. In the following section, several examples of the high-pass component parameters will be described. In the second execution example to be described in the subsequent section, the upsampling section 40 switches an optimum filter configuration of the upsampling filter for each block and causes the lossless encoding section 16 to encode filter configuration information corresponding to the filter configuration applied to each block.

### 2-2. Upsampling Section

### First Execution Example

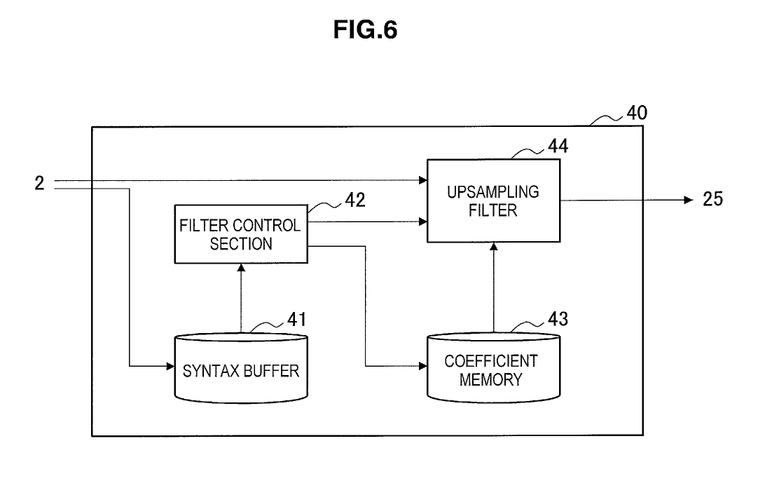

FIG. 6 is a block diagram illustrating an example of a configuration of the upsampling section 40 according to the first execution example. Referring to FIG. 6, the upsampling section 40 includes a syntax buffer 41, a filter control section 42, a coefficient memory 43, and an upsampling filter 44.

(1) Syntax Buffer

The syntax buffer 41 is a buffer that stores parameters used when the filter control section 42 controls the upsampling. For example, the syntax buffer 41 stores a resolution ratio decided in advance between a base layer image and an enhancement layer image. The resolution ratio can be encoded by the lossless encoding section 16 to be inserted into a video parameter set (VPS), or a sequence parameter set (SPS) or a picture parameter set (PPS) of the enhancement layer. The syntax buffer 41 stores a high-pass component parameter related to the strength of the high-pass component of each block of the base layer. For example, the high-pass component parameter may be acquired from the BL encoding section 1a via the common memory 2. The syntax buffer 41 may store the picture type of each picture when the picture type is referred to in order to decide the filter configuration.

(2) Filter Control Section

The filter control section 42 switches the filter configuration of the upsampling filter 44 according to the strength of the high-pass component for each block of an image. The image to be upsampled may be one or both of the predicted error image and the decoded image of the base layer. For example, the filter control section 42 switches the number of filter taps of the upsampling filter 44 according to the strength of the high-pass component of each block. Typically, the filter control section 42 sets the number of filter taps of the block including a strong high-pass component to a relatively large value. Accordingly, the high-pass component is finely reproduced, and thus the image quality is maintained. The filter control section 42 sets the number of filter taps of the block including a weak high-pass component to a relatively small value. Accordingly, the calculation cost of the upsampling is suppressed. In the block having the weak high-pass component, the image quality does not considerably deteriorate even when the number of filter taps is small. The filter control section 42 may switch the filter coefficient of the upsampling filter for each block according to the strength of the high-pass component. The filter coefficient may be the same as or may be different from the interpolation filter disclosed in Non-Patent Literature 2.

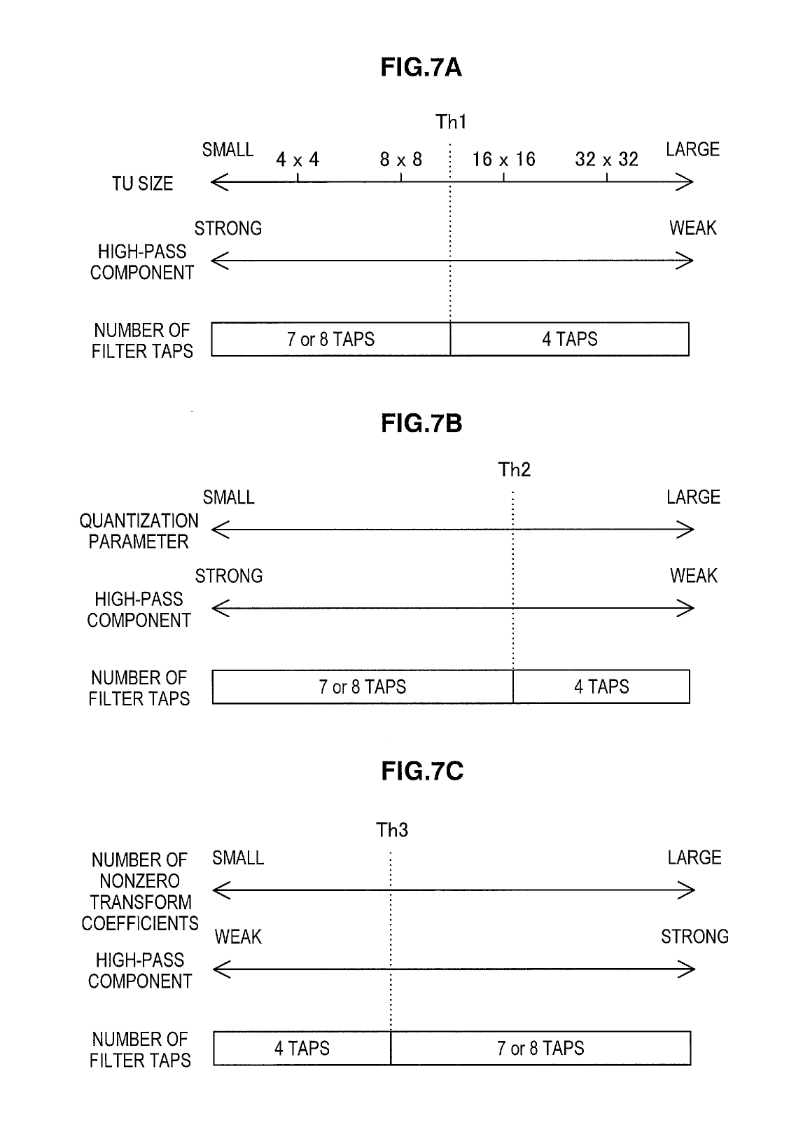

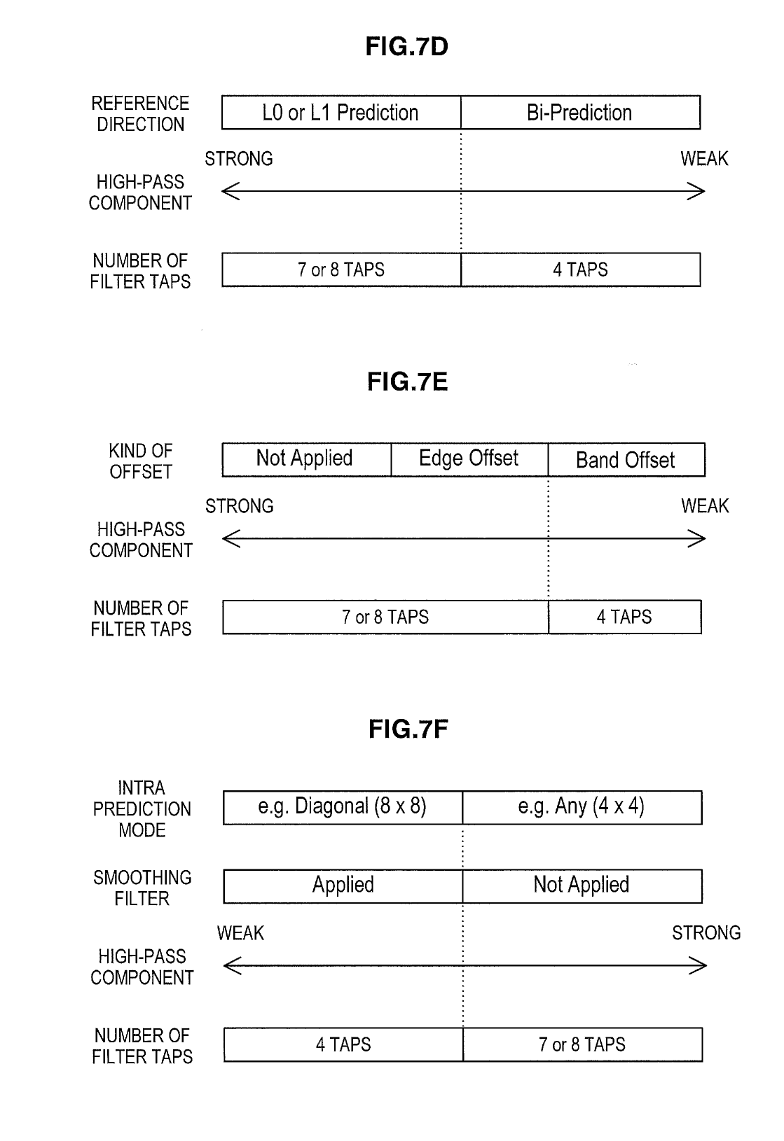

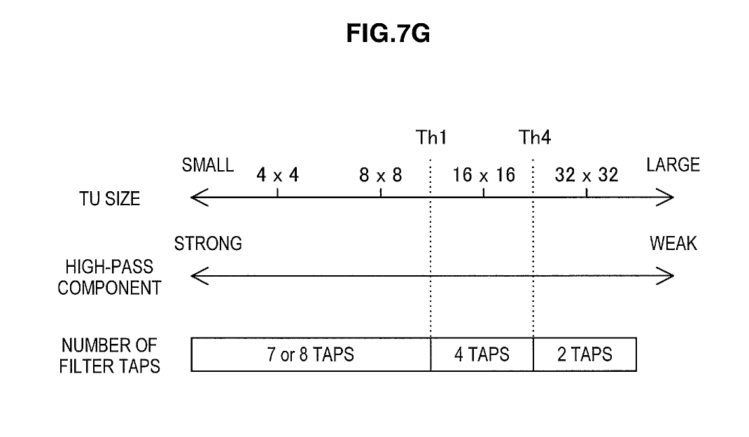

FIG. 7A is an illustrative diagram for describing a first example of a relation between a high-pass component parameter and the number of filter taps. In the first example, the high-pass component parameter is the TU size. In HEVC, as described above, the TU size is 4×4 pixels, 8×8 pixels, 16×16 pixels, or 32×32 pixels. As the TU size is smaller, there is a high possibility of the high-pass component being considerably included in the block. Accordingly, for example, the filter control section 42 compares the TU size of a corresponding block (co-located block) of the base layer with a threshold value Th1. When the TU size is greater than the threshold value Th1, that is, the TU size is 16×16 pixels or 32×32 pixels, the number of filter taps is set to a first value (for example, 4). Conversely, when the TU size of the corresponding block is less than the threshold value Th1, that is, the TU size is 4×4 pixels or 8×8 pixels, the filter control section 42 sets the number of filter taps to a second value (for example, 7 or 8) greater than the first value.

As in the TU size, the CU size or the PU size which can be related to the strength of the high-pass component may be used as a high-pass component parameter instead of the TU size.

FIG. 7B is an illustrative diagram for describing a second example of the relation between the high-pass component parameter and the number of filter taps. In the second example, the high-pass component parameter is a quantization parameter. As described above, when the quantization parameter is large, there is a high possibility of the high-pass component already being lost in a block. Accordingly, for example, the filter control section 42 compares the quantization parameter applied to the corresponding block of the base layer with a threshold value Th2. When the quantization parameter is greater than the threshold value Th2, the number of filter taps is set to a first value (for example, 4). Conversely, when the quantization parameter of the corresponding block is less than the threshold value Th2, the filter control section 42 sets the number of filter taps to a second value (for example, 7 or 8) greater than the first value.

FIG. 7C is an illustrative diagram for describing a third example of the relation between the high-pass component parameter and the number of filter taps. In the third example, the high-pass component parameter is the number of nonzero transform coefficients. As described above, when the corresponding block includes many high-pass components, the transform coefficient data generated as the result of the orthogonal transform on the corresponding block includes many nonzero transform coefficients. Accordingly, for example, the filter control section 42 compares the number of nonzero transform coefficients of the corresponding block of the base layer with a threshold value Th3. When the number of nonzero transform coefficients is less than the threshold value Th3, the number of filter taps is set to a first value (for example, 4). Conversely, when the number of nonzero transform coefficients is greater than the threshold value Th3, the filter control section 42 sets the number of filter taps to a second value (for example, 7 or 8) greater than the first value.

FIG. 7D is an illustrative diagram for describing a fourth example of the relation between the high-pass component parameter and the number of filter taps. In the fourth example, the high-pass component parameter is reference direction information in the inter prediction. As described above, when the bi-prediction is selected in the inter prediction of the corresponding block, there is a possibility of the high-pass component being lost through an averaging process. Accordingly, for example, when the reference direction information of the corresponding block of the base layer indicates the bi-prediction, the filter control section 42 sets the number of filter taps to a first value (for example, 4). Conversely, when the reference direction information does not indicate the bi-prediction (for example, indicates the L0 prediction or the L1 prediction), the filter control section 42 sets the number of filter taps to a second value (for example, 7 or 8) greater than the first value.

FIG. 7E is an illustrative diagram for describing a fifth example of the relation between the high-pass component parameter and the number of filter taps. In the fifth example, the high-pass component parameter is a kind of offset in the sample adaptive offset process. As described above, when the edge offset is selected in the sample adaptive offset process of the corresponding block, there is a possibility of the high-pass component being lost along with removal of the mosquito distortion. Accordingly, for example, when the kind of offset selected in the corresponding block of the base layer indicates the edge offset, the filter control section 42 sets the number of filter taps to a first value (for example, 4). Conversely, when the kind of offset does not indicate the edge offset (for example, indicates the band offset or no offset), the filter control section 42 sets the number of filter taps to a second value (for example, 7 or 8) greater than the first value.

FIG. 7F is an illustrative diagram for describing a sixth example of the relation between the high-pass component parameter and the number of filter taps. In the sixth example, the high-pass component parameter is the PU size and the intra prediction mode. As described above, when the smoothing filter is applied at the time of the intra prediction of the corresponding block, there is a possibility of the high-pass component being lost along with smoothing. Accordingly, for example, the filter control section 42 determines whether the smoothing filter is applied to the corresponding block according to a combination of the PU size of the corresponding block and the selected intra prediction mode and sets the number of filter taps to which the smoothing filter is applied to a first value (for example, 4). For example, when angular prediction of a diagonal direction in the PU of 8×8 pixels is selected, the smoothing filter is applied. On the other hand, the filter control section 42 sets the number of filter taps of the block to which the smoothing filter is not applied to a second value (for example, 7 or 8) greater than the first value. For example, the smoothing filter is not applied to the PU of the 4×4 pixels.

FIG. 7G is an illustrative diagram for describing a seventh example of the relation between the high-pass component parameter and the number of filter taps. In the seventh example, the high-pass component parameter is the TU size as in the first example. In the seventh example, the filter control section 42 compares the TU size of the corresponding block of the base layer to the threshold value Th1 and a threshold value Th4. For example, when the TU size is 32×32 pixels, the filter control section 42 sets the number of filter taps to 2. When the TU size is 16×16 pixels, the filter control section 42 sets the number of filter taps to 4. When the TU size is 8×8 pixels or 4×4 pixels, the filter control section 42 sets the number of filter taps to 7 or 8.

The relations between the high-pass component parameter and the number of filter taps are not limited to the examples of FIGS. 7A to 7G. For example, threshold values different from the above-described threshold values Th1 to Th4 may be used. A combination of 6 taps and 12 taps may be used rather than the combination of 4 taps and 7 or 8 taps. To set at least one of the number of taps and the filter coefficient, any combination of two or more high-pass component parameters may be used.

The filter control section 42 may perform the control of the adaptive upsampling for each block depending on the picture type. For example, when the picture type of the reference image indicates the B picture, the filter control section 42 sets the number of taps of the upsampling filter to a small value irrespective of the strength of the high-pass component. When the picture type of the reference image indicates the I picture or the P picture, the number of taps of the upsampling filter may be switched between a plurality of values according to the strength of the high-pass component determined for each block.

(3) Coefficient Memory

The coefficient memory 43 is a memory that stores various candidates for the filter coefficient used by the upsampling filter 44. For example, the coefficient memory 43 stores each filter coefficient set of each combination of the number of taps and a pixel position to be interpolated. The filter coefficient set stored by the coefficient memory 43 is read by the upsampling filter 44 according to the setting by the filter control section 42. The filter coefficient may be dynamically calculated by the filter control section 42.

(4) Upsampling Filter

The upsampling filter 44 upsamples the image of the base layer referred to at the time of the local decoding of the image of the enhancement layer with a higher space resolution than the base layer under the control of the filter control section 42. The image upsampled by the upsampling filter 44 may be one or both of the predicted error image and the decoded image of the base layer. More specifically, the upsampling filter 44 identifies the filter configuration set in regard to the image of the base layer acquired from the common memory 2 according to the resolution ratio and the strength of the high-pass component for each block. Then, the upsampling filter 44 calculates an interpolation pixel value of each of the interpolation pixels scanned in order according to the resolution ratio by filtering the image of the base layer with the filter coefficient acquired from the coefficient memory 43. Therefore, it is possible to improve the space resolution of the image of the base layer used as the reference block up to the same resolution as the enhancement layer. The upsampling filter 44 outputs the reference image data after the upsampling to the frame memory 25.

### 2-3. Upsampling Section

### Second Execution Example

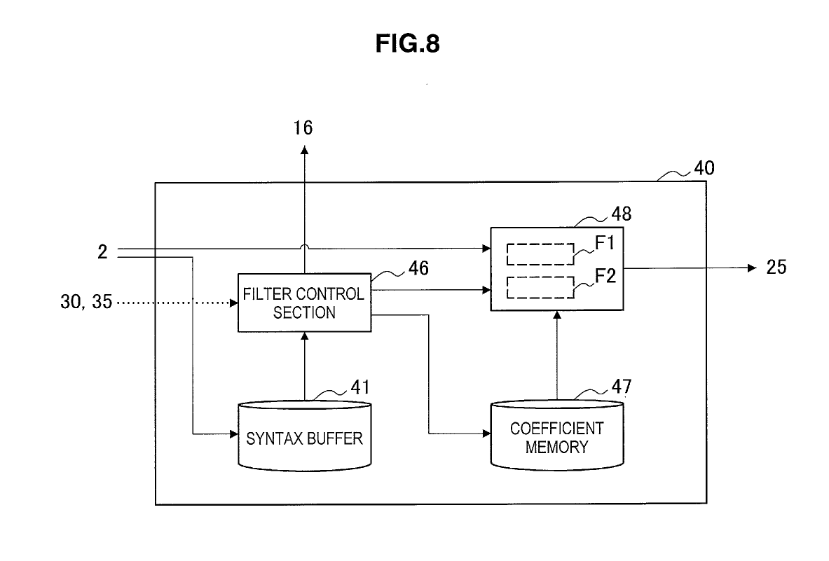

FIG. 8 is a block diagram illustrating an example of a configuration of the upsampling section 40 according to a second execution example. Referring to FIG. 8, the upsampling section 40 includes a syntax buffer 41, a filter control section 46, a coefficient memory 47, and an upsampling filter 48.

(1) Syntax Buffer

The syntax buffer 41 is a buffer that stores a parameter used when the filter control section 46 controls the upsampling. In the second execution example, the syntax buffer 41 stores a resolution ratio decided in advance between the base layer image and the enhancement layer image. The resolution ratio can be encoded by the lossless encoding section 16 to be inserted into a VPS, or an SPS or a PPS of the enhancement layer. The syntax buffer 41 may store the picture type of each picture when the picture type is referred to in order to decide the filter configuration.

(2) Filter Control Section

The filter control section 46 switches the filter configuration of the upsampling filter 48 to be used at the time of the decoding for each block of the image. The upsampled image may be one or both of the decoded image and the predicted error image of the base layer. For example, the filter control section 46 causes the upsampling filter 48 to generate each upsampled image with a plurality of filter configurations in regard to each block. The filter configuration can include at least one of the filter coefficient and the number of filter taps. The upsampled image of each filter configuration is stored in the frame memory 25. The filter control section 46 selects an optimum filter configuration based on the result of the intra prediction by the intra prediction section 30 or the result of the inter prediction by the inter prediction section 35. The optimum filter configuration may be typically a filter configuration in which the cost function value is the minimum. In this case, since the cost function value can be calculated for each PU, it is beneficial to switch the filter configuration for each PU. However, the filter control section 46 may switch the filter configuration in another unit such as the LCU, the CU, or the TU. The filter control section 46 generates the filter configuration information corresponding to the selected filter configuration and outputs the generated filter configuration information to the lossless encoding section 16 for each block. The output filter configuration information is encoded to the encoded stream of the enhancement layer by the lossless encoding section 16.

The filter control section 46 may control the adaptive upsampling for each block depending on the picture type. For example, when the picture type of the reference image indicates the B picture, the filter control section 46 may set a fixed filter configuration (for example, the less number of filter taps). When the picture type of the reference image indicates the I picture or the P picture, the filter configuration of the upsampling filter may be switched adaptively.

(3) Coefficient Memory

The coefficient memory 47 is a memory that stores various candidates for the filter coefficient used by the upsampling filter 48. For example, the coefficient memory 47 stores each filter coefficient set in regard to each combination of the number of taps and a pixel position to be interpolated. For example, in a first filter configuration, the number of filter taps, 7 or 8 taps, and the same filter coefficient as an interpolation filter for the motion compensation can be present for the luma component. In a second filter configuration, the number of filter taps, 4 taps, and the same filter coefficient as an interpolation filter for the DCT can be present. In the first filter configuration, 4 taps and the same filter coefficient as the interpolation filter for the motion compensation can be present for the chroma component. In the second filter configuration, 2 taps and a filter coefficient corresponding to linear interpolation can be present. The filter coefficient set stored by the coefficient memory 47 is read by the upsampling filter 48.

(4) Upsampling Filter

The upsampling filter 48 upsamples the image of the base layer referred to at the time of the local decoding of the image of the enhancement layer with a higher space resolution than the base layer under the control of the filter control section 46. The upsampling filter 48 may include a plurality of filter circuits F1 and F2 corresponding to different filter configurations. More specifically, the upsampling filter 48 identifies the resolution ratio in regard to the image of the base layer acquired from the common memory 2. Then, the upsampling filter 48 calculates a first interpolation pixel value by filtering the image of the base layer of each of the interpolation pixels scanned in order according to the resolution ratio with the first filter configuration and calculates a second interpolation value of each of the interpolation filters by filtering the image of the base layer with the second filter configuration. Accordingly, two kinds of upsampled images with the space resolution increased to the same degree as the enhancement layer are generated. The upsampling filter 48 outputs each of the upsampled images (the reference image data after the upsampling) corresponding to the plurality of filter configurations to the frame memory 25. When the filter control section 46 knows the filter configuration to be applied to a certain block in advance, the upsampling filter 48 may generate only the upsampled image corresponding to the single filter configuration in regard to the block.

### 3. Flow of a Process for Encoding

### First Embodiment

### 3-1. Schematic Flow

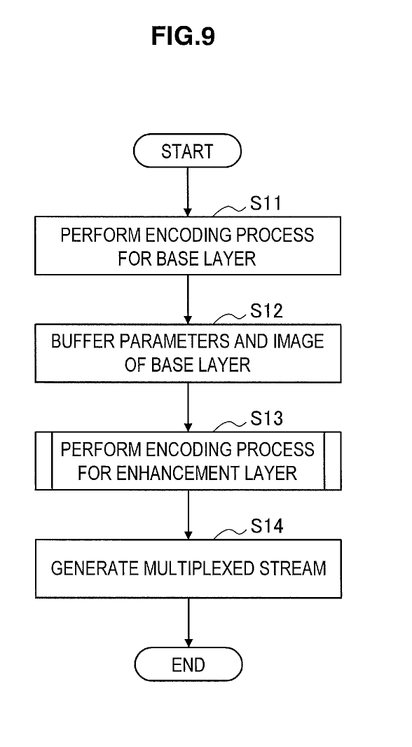

FIG. 9 is a flow chart showing an example of a schematic process flow for encoding. For the sake of brevity of description, process steps that are not directly related to the technology according to the present disclosure are omitted from the drawing.

Referring to FIG. 9, the BL encoding section 1a first performs an encoding process for a base layer to generate an encoded stream of the base layer (Step S11).

The common memory 2 buffers the high-pass component parameters and the image (one or both of the decoded image and the predicted error image) of the base layer generated through the encoding process for the base layer (step S12). The buffered parameters may additionally include the picture type.

Next, the EL encoding section 1b performs the encoding process for the enhancement layer to generate the encoded stream of the enhancement layer (step S13). In the encoding process for the enhancement layer to be performed herein, the image of the base layer buffered by the common memory 2 is upsampled by the upsampling section 40 and is used as the reference image in the inter layer prediction.

Then, the multiplexing section 3 multiplexes the encoded stream of the base layer generated by the BL encoding section 1a and the encoded stream of the enhancement layer generated by the EL encoding section 1b to generate a multilayer multiplexed stream (Step S14).

### 3-2. Upsampling Process

### (1) First Execution Example

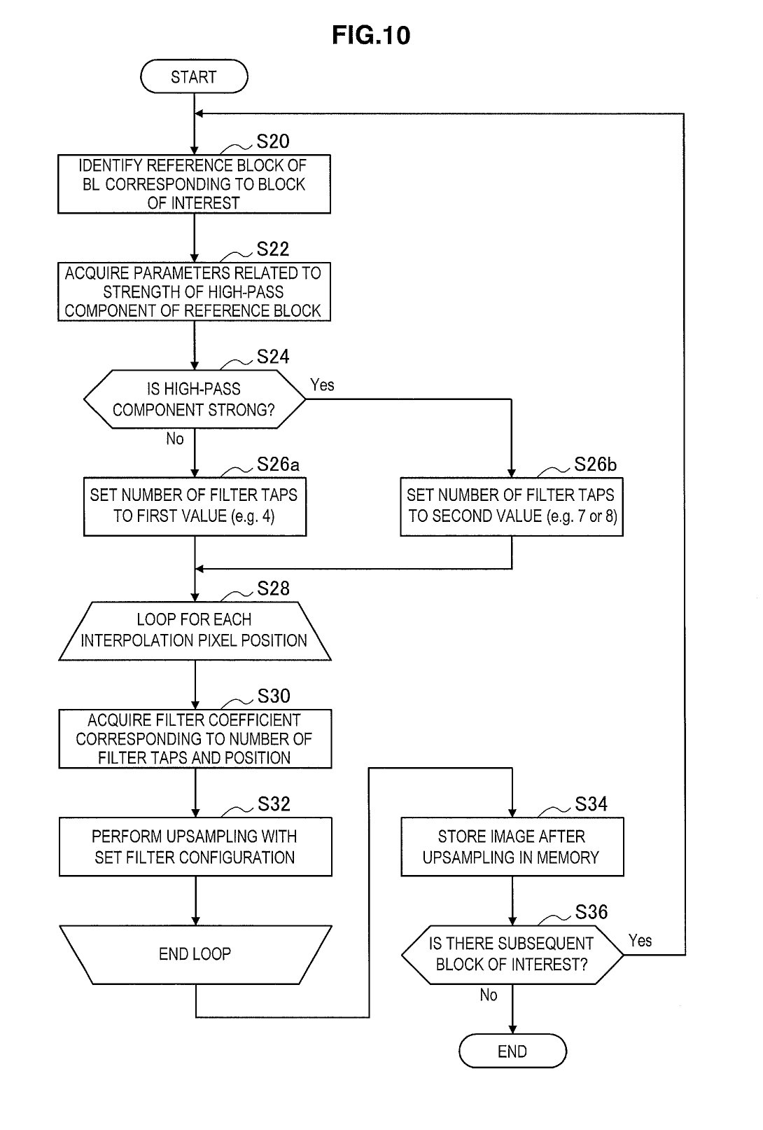

FIG. 10 is a flow chart showing a first example of the flow of an upsampling process according to the first execution example in the encoding process for the enhancement layer.

Referring to FIG. 10, the filter control section 42 first identifies the reference block of the base layer corresponding to a block of interest of the enhancement layer (step S20). The reference block identified herein may be a co-located block (a block occupying the same region in an image) of the block of interest.

Next, the filter control section 42 acquires the high-pass component parameter related to the strength of the high-pass component of the identified reference block from the syntax buffer 41 (step S22). For example, the high-pass component parameters can indicate one or more of the TU size, the quantization parameter, the number of nonzero transform coefficients, the reference direction of the inter prediction, the kind of offset in the sample adaptive offset process, and the intra prediction mode.

Next, the filter control section 42 determines whether the high-pass component in the reference block is strong, using the acquired high-pass component parameters (step S24). When the filter control section 42 determines that the high-pass component in the reference block is not strong, the filter control section 42 sets the number of filter taps of the upsampling filter 44 to the first value (for example, 4) (step S26a). Conversely, when the filter control section 42 determines that the high-pass component in the reference block is strong, the filter control section 42 sets the number of filter taps of the upsampling filter 44 to the second value (for example, 7 or 8) (step S26b).

The processes of steps S30 and S32 are repeated for each interpolation pixel position in the block of interest (step S28). The interpolation pixel position is decided according to the resolution ratio between the layers. In each loop, the upsampling filter 44 acquires the filter coefficient corresponding to the combination of the number of filter taps set by the filter control section 42 and the interpolation pixel position from the coefficient memory 43 (step S30). Then, the upsampling filter 44 calculates the interpolation pixel value by filtering the image of the base layer with the acquired filter coefficient (step S32).

When the loop ends for all of the interpolation pixel positions in the block of interest, the upsampling filter 44 stores the reference image data after the upsampling in the frame memory 25 (step S34).

Thereafter, when there is a subsequent block of interest, the process returns to step S20 and the above-described processes are repeated on the subsequent block of interest (step S36). When there is no subsequent block of interest, the upsampling process of FIG. 10 ends.

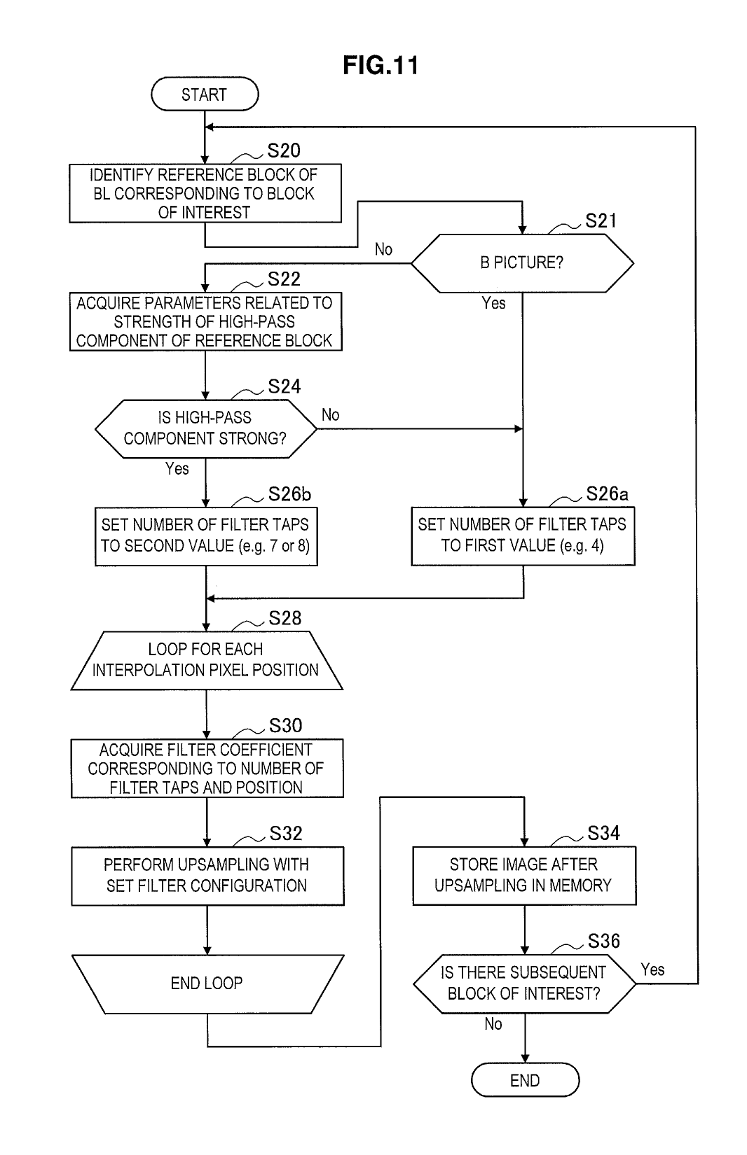

FIG. 11 is a flow chart showing a second example of the flow of an upsampling process according to the first execution example in the encoding process for the enhancement layer. In the second example, the picture type is considered in addition to the high-pass component parameters to set the filter configuration.

Referring to FIG. 11, the filter control section 42 first identifies the reference block of the base layer corresponding to a block of interest of the enhancement layer (step S20). The reference block identified herein may be a co-located block of the block of interest.

Next, the filter control section 42 determines whether the picture type of the reference image is the B picture (step S21). When the picture type of the reference image is the B picture, the filter control section 42 sets the number of filter taps of the upsampling filter 44 to the first value (for example, 4) (step S26a). When the picture type of the reference image is not the B picture, the process proceeds to step S22.

In step S22, the filter control section 42 acquires the high-pass component parameters related to the strength of the high-pass component of the reference block from the syntax buffer 41 (step S22). For example, the high-pass component parameters can indicate one or more of the TU size, the quantization parameter, the number of nonzero transform coefficients, the reference direction of the inter prediction, the kind of offset in the sample adaptive offset process, and the intra prediction mode.

Next, the filter control section 42 determines whether the high-pass component in the reference block is strong, using the acquired high-pass component parameters (step S24). When the filter control section 42 determines that the high-pass component in the reference block is not strong, the filter control section 42 sets the number of filter taps of the upsampling filter 44 to the first value (step S26a). Conversely, when the filter control section 42 determines that the high-pass component in the reference block is strong, the filter control section 42 sets the number of filter taps of the upsampling filter 44 to the second value (for example, 7 or 8) (step S26b).

The subsequent processes of steps S28 to S36 are the same as those of the first example described with reference to FIG. 10. In the second example, the interpolation pixel value is also calculated by filtering the image of the base layer for each interpolation pixel position in the block of interest and the reference image data after the upsampling is stored in the frame memory 25.

### (2) Second Execution Example

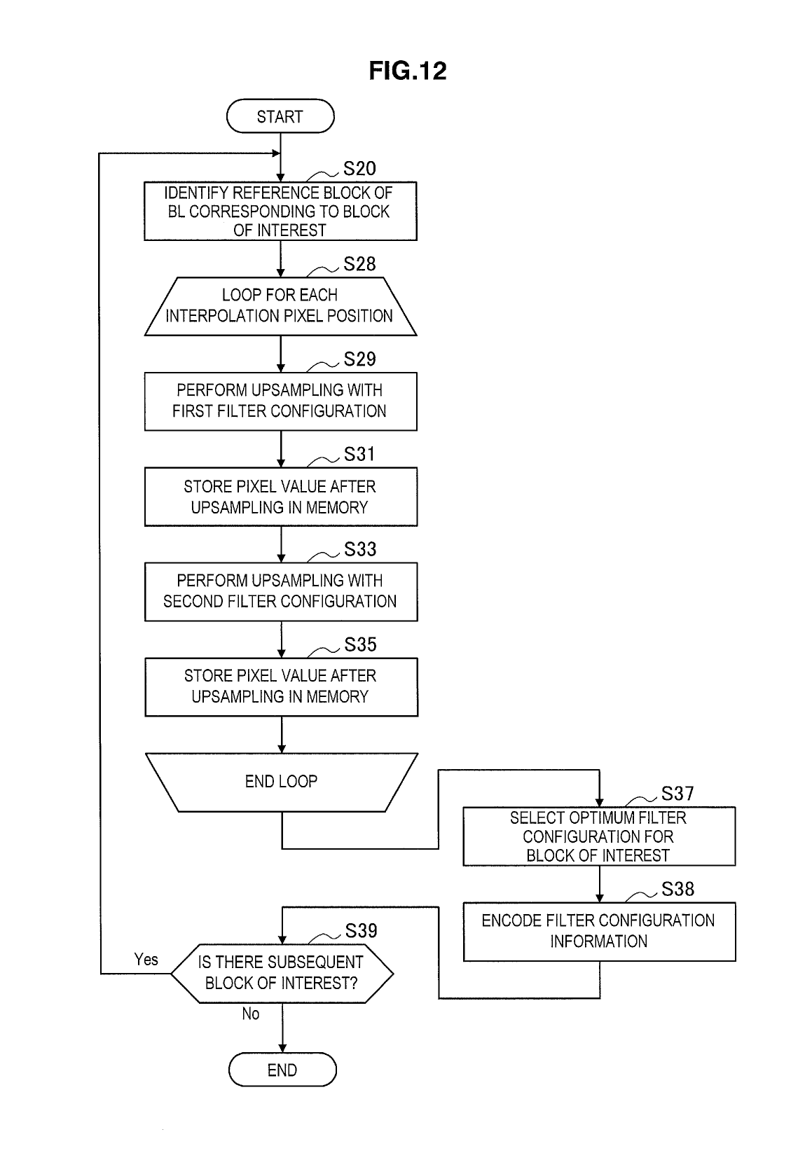

FIG. 12 is a flow chart showing an example of the flow of an upsampling process according to the second execution example in the encoding process for the enhancement layer.

Referring to FIG. 12, the filter control section 46 first identifies the reference block of the base layer corresponding to a block of interest of the enhancement layer (step S20). The reference block identified herein may be a co-located block of the block of interest.

The processes of steps S29 to S35 are repeated for each interpolation pixel position in the block of interest (step S28). The interpolation pixel position is decided according to the resolution ratio between the layers. The upsampling filter 48 calculates the first interpolation pixel value by filtering the image of the base layer with the first filter configuration (for example, 8 taps for the luma component and 4 taps for the chroma component, and the corresponding filter coefficient) (step S29). Next, the upsampling filter 48 stores the first interpolation pixel value in the frame memory 25 (step S31). Further, the upsampling filter 48 calculates the second interpolation pixel value by filtering the image of the base layer with the second filter configuration (for example, 4 taps for the luma component and 2 taps for the chroma component, and the corresponding filter coefficient) (step S33). Next, the upsampling filter 48 stores the second interpolation pixel value in the frame memory 25 (step S35).

When the loop ends for all of the interpolation pixel positions in the block of interest, the filter control section 46 selects an optimum filter configuration of the block of interest from the viewpoint of coding efficiency among the candidates of the filter configuration (step S37). Next, the lossless encoding section 16 encodes the filter configuration information regarding the block of interest generated by the filter control section 46 (step S38).

Thereafter, when there is a subsequent block of interest, the process returns to step S20 and the above-described processes are repeated on the subsequent block of interest (step S39). When there is no subsequent block of interest, the upsampling process of FIG. 12 ends.

### 3-3. Modification Example

The upsampling processes described with reference to FIGS. 10 to 12 are applied to at least one of the luma component and the chroma component. The space resolution of the chroma component depends on a chroma format. In HEVC, candidates for the chroma format are 4:2:0, 4:2:2, and 4:4:4. When the chroma format is 4:2:0, the resolution of the chroma component is half of the resolution of the luma component in both of the horizontal direction and the vertical direction. When the chroma format is 4:2:2, the resolution of the chroma component is half of the resolution of the luma component in the horizontal direction and is the same as the resolution of the luma component in the vertical direction. When the chroma format is 4:4:4, the resolution of the chroma component is the same as the resolution of the luma component in both of the horizontal direction and the vertical direction. Thus, as a modification example, the filter control section 42 switches the filter configuration of the upsampling filter 44 according to the chroma format when the chroma component of the image of the base layer is upsampled by the upsampling filter 44.

In the modification example, the image of the base layer to be upsampled may also be one or both of the decoded image and the predicted error image. For example, when the chroma format is 4:2:0, the filter control section 42 can set a value of the number of filter taps of the upsampling filter applied to the chroma component to be smaller than that of the upsampling filter applied to the luma component in both of the horizontal direction and the vertical direction. For example, the number of filter taps of the luma component may be 7 or 8 and the number of filter taps of the chroma component may be 4. When the chroma format is 4:2:2, the filter control section 42 can set the value of the number of filter taps of the upsampling filter applied to the chroma component to be smaller than that of the upsampling filter applied to the luma component in the horizontal direction and can set the value of the number of filter taps to be the same as that of the upsampling filter applied to the luma component in the vertical direction. When the chroma format is 4:4:4, the filter control section 42 can set the value of the number of filter taps of the upsampling filter applied to the chroma component to be the same as that of the upsampling filter applied to the luma component in both of the horizontal direction and the vertical direction. In the method of the related art, the number of filter taps of the chroma component is normally 4, which is smaller than the number of filter taps of the luma component. On the other hand, when the chroma format indicates that the chroma component has the same space resolution as the luma component, it is possible to prevent the deterioration in the image quality of the chroma component caused by the upsampling by ensuring the sufficient number of filter taps of the chroma component as in the modification example, and thus it is possible to properly reproduce the high-pass component of the chroma component.

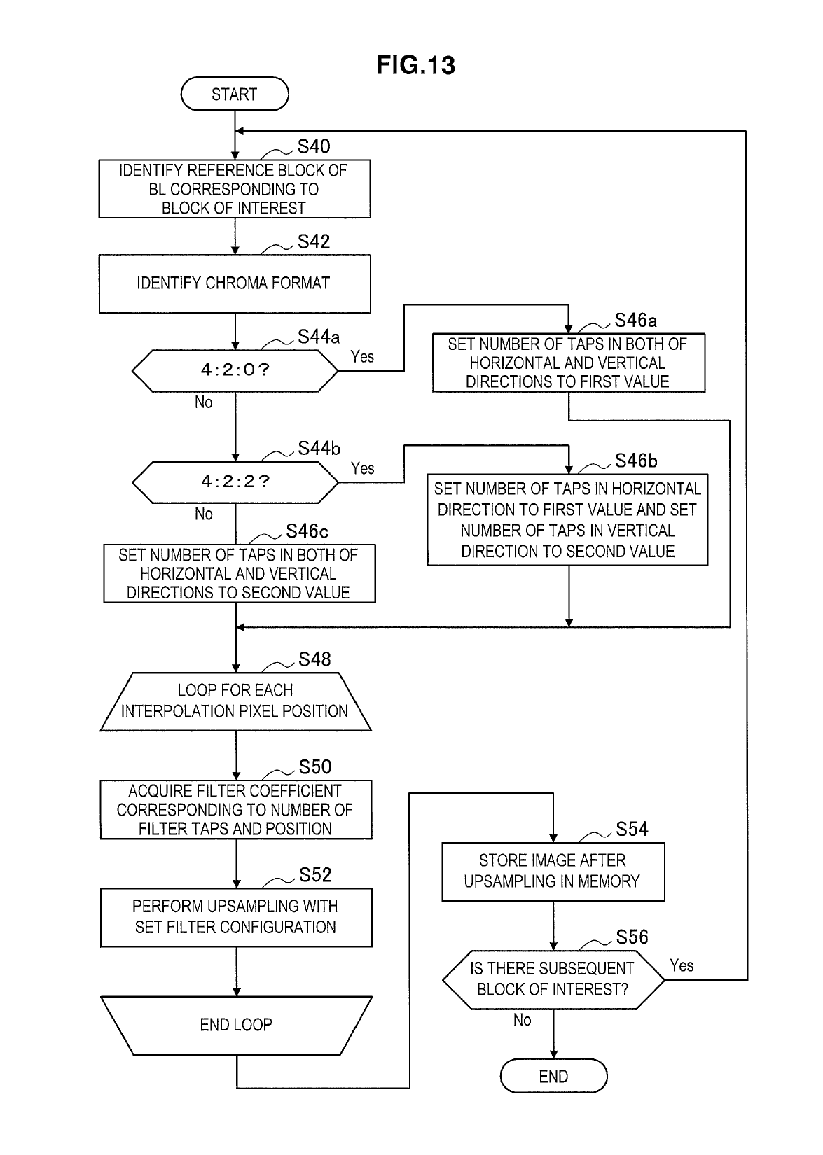

FIG. 13 is a flow chart showing an example of the flow of an upsampling process according to the modification example.

Referring to FIG. 13, the filter control section 42 first identifies the reference block of the base layer corresponding to a block of interest of the enhancement layer (step S40). The reference block identified herein may be a co-located block of the block of interest. The filter control section 42 identifies the chroma format of the identified reference block (step S42). When the chroma format scalability is realized, the chroma format can be indicated by a parameter encoded in the encoded stream of the enhancement layer.

The subsequent process branches depending on the identified chroma format. When the chroma format is 4:2:0 (step S44a), the filter control section 42 sets the number of filter taps in both of the horizontal direction and the vertical direction to a first value (step S46a). The first value may be a value smaller than that of the upsampling filter applied to the luma component.

When the chroma format is 4:2:2 (step S44b), the filter control section 42 sets the number of filter taps of the chroma component in the horizontal direction to the first value and sets the number of filter taps in the vertical direction to a second value (step S46b). The second value may be the same value as that of the upsampling filter applied to the luma component.

When the chroma format is 4:4:4, the filter control section 42 sets the number of filter taps in both of the horizontal direction and the vertical direction to the second value (step S46c).

The processes of steps S50 and S52 are repeated for each interpolation pixel position in the block of interest (step S48). The interpolation pixel position is decided according to the resolution ratio between the layers. In each loop, the upsampling filter 44 acquires the filter coefficient corresponding to the combination of the number of filter taps set by the filter control section 42 and the interpolation pixel position from the coefficient memory 43 (step S50). Then, the upsampling filter 44 calculates the interpolation pixel value by filtering the chroma component of the image of the base layer with the acquired filter coefficient (step S52).

When the loop ends for all of the chroma components in the block of interest, the upsampling filter 44 stores the reference image data after the upsampling in the frame memory 25 (step S54).

Thereafter, when there is a subsequent block of interest, the process returns to step S40 and the above-described processes are repeated on the subsequent block of interest (step S56). When there is no subsequent block of interest, the upsampling process of FIG. 13 ends.

### 4. Configuration Example of an EL Decoding Section

### First Embodiment

### 4-1. Overall Configuration

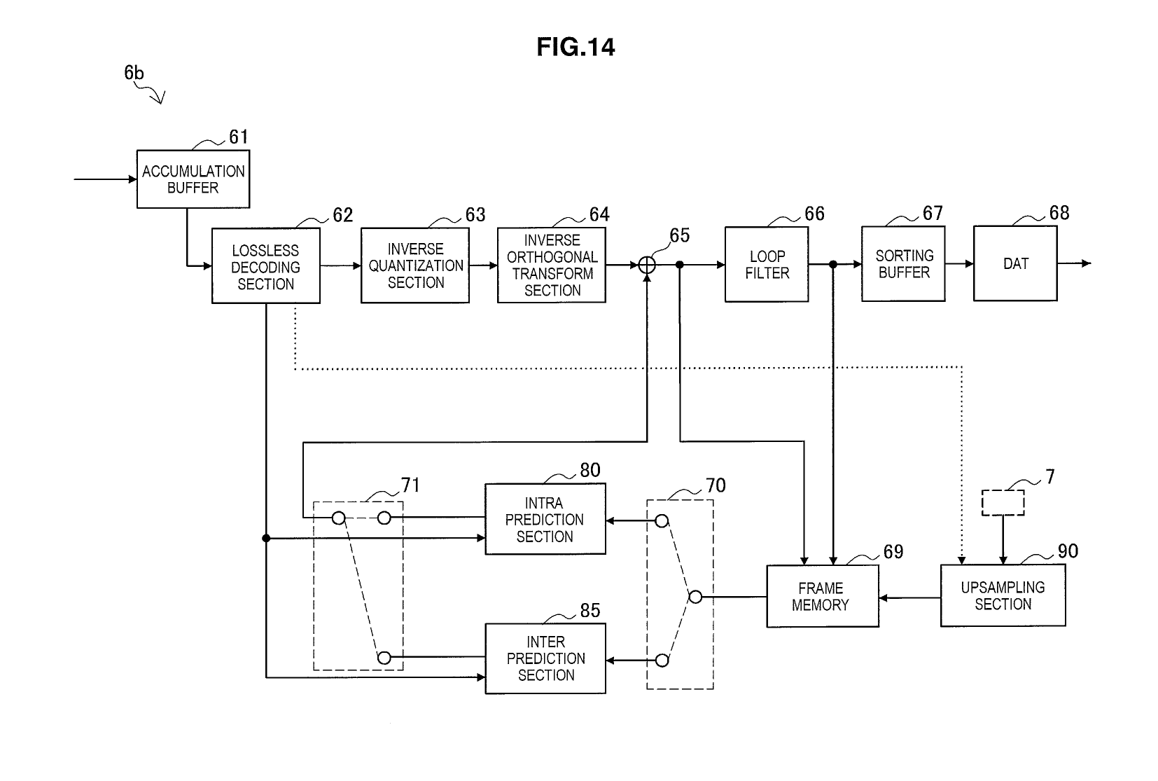

FIG. 14 is a block diagram showing an example of the configuration of the EL decoding section 6b according to the first embodiment. Referring to FIG. 14, the EL decoding section 6b includes an accumulation buffer 61, a lossless decoding section 62, an inverse quantization section 63, an inverse orthogonal transform section 64, an addition section 65, a loop filter 66, a sorting buffer 67, a digital-to-analog (D/A) conversion section 68, a frame memory 69, selectors 70 and 71, an intra prediction section 80, an inter prediction section 85, and an upsampling section 90.

The accumulation buffer 61 temporarily accumulates the encoded stream of the enhancement layer input from the demultiplexing section 5 using a storage medium.

The lossless decoding section 62 decodes the quantized data of the enhancement layer from the encoded stream of the enhancement layer input from the accumulation buffer 61 according to the encoding scheme used at the time of the encoding. In addition, the lossless decoding section 62 decodes the information inserted into the header region of the encoded stream. The information decoded by the lossless decoding section 62 can include, for example, information relating to intra prediction and information relating to inter prediction. In the first execution example, the high-pass component parameters related to the strength of the high-pass component can also be decoded in each layer. In the second execution example, the filter configuration information indicating the filter configuration optimum for each block of the upsampling filter can be decoded from the encoded stream of the enhancement layer. The lossless decoding section 62 outputs the quantized data to the inverse quantization section 63. The lossless decoding section 62 outputs the information regarding the intra prediction to the intra prediction section 80. The information regarding the intra prediction may be output to the inverse quantization section 63 to switch the quantization matrix. The lossless decoding section 62 outputs the information regarding the inter prediction to the inter prediction section 85. In the first execution example, the high-pass component parameters can be buffered by the common memory 7 to be referred to between the layers. In the second execution example, the filter configuration information regarding each block can be output to the upsampling section 90.

The inverse quantization section 63 inversely quantizes the quantized data input from the lossless decoding section 62 in the same quantization step (or with the same quantization matrix) used at the time of the encoding to restore the transform coefficient data of the enhancement layer. The quantization parameter having an influence on the quantization step may be used as a high-pass component parameter. When the quantization matrix is used, the inverse quantization section 63 switches the quantization matrix to be used according to the block size, the color component, and the corresponding prediction mode (that is, the intra prediction or the inter prediction). When the prediction mode is the intra prediction mode and the intra BL prediction in which the image of the base layer is used as a reference image is designated, the inverse quantization section 63 may restore the transform coefficient data by inversely quantizing the quantized data using the quantization matrix defined for the inter prediction mode. Then, the inverse quantization section 63 outputs the restored transform coefficient data to the inverse orthogonal transform section 64.

The inverse orthogonal transform section 64 performs an inverse orthogonal transform on the transform coefficient data input from the inverse quantization section 63 according to the orthogonal transform scheme used at the time of the encoding to generate predicted error data. As described above, the inverse orthogonal transform is executed for each TU. The TU size is selected adaptively from 4×4 pixels, 8×8 pixels, 16×16 pixels, and 32×32 pixels. The TU size and the number of nonzero transform coefficients may be used as high-pass component parameters. The inverse orthogonal transform section 64 outputs the generated predicted error data to the addition section 65.

The addition section 65 adds the predicted error data input from the inverse orthogonal transform section 64 and predicted image data input from the selector 71 to generate decoded image data. Then, the addition section 65 outputs the generated decoded image data to the loop filter 66 and the frame memory 69.

As in the loop filter 24 of the EL encoding section 1b, the loop filter 66 includes a deblock filter that reduces block distortion, a sample adaptive offset filter that adds an offset value to each pixel value, and an adaptive loop filter that minimizes an error from an original image. The kind of offset in the sample adaptive offset process may be used as a high-pass component parameter. The loop filter 66 filters the decoded image data input from the addition section 65 and outputs the filtered decoded image data to the sorting buffer 67 and the frame memory 69.

The sorting buffer 67 sorts the images input from the loop filter 66 to generate a chronological series of image data. Then, the sorting buffer 67 outputs the generated image data to the D/A conversion section 68.

The D/A conversion section 68 converts the image data in a digital format input from the sorting buffer 67 into an image signal in an analog format. Then, the D/A conversion section 68 causes the image of the enhancement layer to be displayed by outputting the analog image signal to, for example, a display (not illustrated) connected to the image decoding device 60.

The frame memory 69 stores the decoded image data input from the addition section 65 before the filtering, the decoded image data input from the loop filter 66 after the filtering, and the reference image data of the base layer input from the upsampling section 90 using a storage medium.

The selector 70 switches an output destination of the image data from the frame memory 69 between the intra prediction section 80 and the inter prediction section 85 for each block in the image according to the mode information acquired by the lossless decoding section 62. For example, when the intra prediction mode is designated, the selector 70 outputs the decoded image data before the filtering supplied from the frame memory 69 as the reference image data to the intra prediction section 80. In addition, when the inter prediction mode is designated, the selector 70 outputs the decoded image data after the filtering as the reference image data to the inter prediction section 85. Further, when the inter layer prediction is performed in the intra prediction section 80 or the inter prediction section 85, the selector 70 supplies the reference image data of the base layer to the intra prediction section 80 or the inter prediction section 85.

The selector 71 switches an output source of the predicted image data to be supplied to the addition section 65 between the intra prediction section 80 and the inter prediction section 85 according to the mode information acquired by the lossless decoding section 62. For example, when the intra prediction mode is designated, the selector 71 supplies the predicted image data output from the intra prediction section 80 to the addition section 65. In addition, when the inter prediction mode is designated, the selector 71 supplies the predicted image data output from the inter prediction section 85 to the addition section 65.

The intra prediction section 80 performs the intra prediction process of the enhancement layer based on the information regarding the intra prediction input from the lossless decoding section 62 and the reference image data from the frame memory 69 to generate predicted image data. The intra prediction process is performed for each PU. When the intra BL prediction or the intra residual prediction is designated as the intra prediction mode, the intra prediction section 80 uses the co-located block in the base layer corresponding to the prediction target block as a reference block. In the case of the intra BL prediction, the intra prediction section 80 generates a predicted image based on the decoded image of the reference block. In the case of the intra residual prediction, the intra prediction section 80 predicts a predicted error of the intra prediction based on the predicted error image of the reference block and generates the predicted image to which the predicted error is added. The intra prediction section 80 may apply a smoothing filter to the reference image data in combination of a specific PU size and the intra prediction mode according to a mode-dependent intra smoothing method. The combination of the PU size and the intra prediction mode may be used as a high-pass component parameter. In addition, the intra prediction section 80 outputs the generated predicted image data of the enhancement layer to the selector 71.

The inter prediction section 85 performs an inter prediction process (a motion compensation process) of the enhancement layer based on the information regarding the inter prediction input from the lossless decoding section 62 and the reference image data from the frame memory 69 to generate predicted image data. The inter prediction process is performed for each PU. When the inter residual prediction is designated as the intra prediction mode, the inter prediction section 85 uses the co-located block in the base layer corresponding to the prediction target block as a reference block. In the case of the inter residual prediction, the inter prediction section 85 predicts a predicted error of the inter prediction based on the predicted error image of the reference block and generates a predicted image to which the predicted error is added. The reference direction information in the inter prediction may be used as a high-pass component parameter. The inter prediction section 85 outputs the generated predicted image data of the enhancement layer to the selector 71.

The upsampling section 90 upsamples an image of the base layer buffered by the common memory 7 according to the resolution ratio between the base layer and the enhancement layer. The image upsampled by the upsampling section 90 can be stored in the frame memory 69 and can be used as a reference image in the inter layer prediction by the intra prediction section 80 or the inter prediction section 85. In the first execution example to be described in the following section, the upsampling section 90 switches the filter configuration of the upsampling filter according to the strength of the high-pass component of each block. The upsampling section 90 may switch the filter configuration of the upsampling filter according to a picture type in addition to the strength of the high-pass component of each block. In the second execution example to be described in the following section, the upsampling section 90 selects the filter configuration of the upsampling filter to be applied to each block according to the filter configuration information decoded from the encoded stream.

### 4-2. Upsampling Section

### First Execution Example

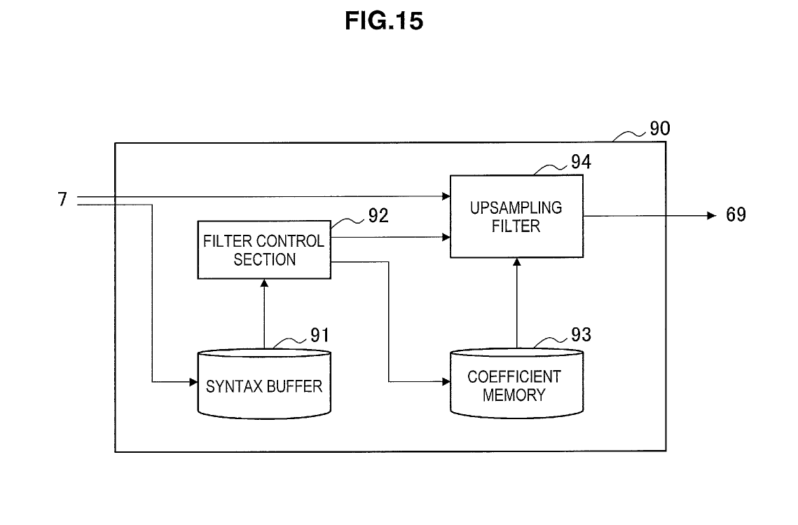

FIG. 15 is a block diagram illustrating an example of the configuration of the upsampling section 90 according to the first execution example. Referring to FIG. 15, the upsampling section 90 includes a syntax buffer 91, a filter control section 92, a coefficient memory 93, and an upsampling filter 94.

(1) Syntax Buffer

The syntax buffer 91 is a buffer that stores parameters used when the filter control section 92 controls the upsampling. For example, the syntax buffer 91 stores the resolution ratio between the base layer image and the enhancement layer image. The resolution ratio can be decoded from the VPS, or the SPS or the PPS of the enhancement layer by the lossless decoding section 62. The syntax buffer 91 stores the high-pass component parameter related to the strength of the high-pass component of each block of the base layer. For example, the high-pass component parameter may be acquired from the BL decoding section 6a via the common memory 7. The syntax buffer 91 may store the picture type of each picture when the picture type is referred to in order to decide the filter configuration.

(2) Filter Control Section

The filter control section 92 switches the filter configuration of the upsampling filter 94 according to the strength of the high-pass component for each block of an image, as in the filter control section 42 described with reference to FIG. 6. The image to be upsampled may be one or both of the predicted error image and the decoded image of the base layer. For example, the filter control section 92 determines the strength of the high-pass component of each block using the high-pass component parameter acquired from the syntax buffer 91 and switches the number of filter taps of the upsampling filter 94 for each block. Typically, the filter control section 92 sets the number of filter taps of the block including a strong high-pass component to a relatively large value. The filter control section 42 sets the number of filter taps of the block including a weak high-pass component to a relatively small value. The relation between the number of filter taps and the high-pass component parameters are exemplified in FIGS. 7A to 7G. The filter control section 92 may switch the filter coefficient of the upsampling filter for each block according to the strength of the high-pass component. The filter coefficient may be the same as or may be different from the interpolation filter disclosed in Non-Patent Literature 2.

The filter control section 92 may perform the control of the adaptive upsampling for each block depending on the picture type. For example, when the picture type of the reference image indicates the B picture, the filter control section 92 sets the number of taps of the upsampling filter to a small value irrespective of the strength of the high-pass component. When the picture type of the reference image indicates the I picture or the P picture, the number of taps of the upsampling filter may be switched between a plurality of values according to the strength of the high-pass component determined for each block.

(3) Coefficient Memory

The coefficient memory 93 is a memory that stores various candidates for the filter coefficient used by the upsampling filter 94. For example, the coefficient memory 93 stores each filter coefficient set of each combination of the number of taps and a pixel position to be interpolated. The filter coefficient set stored by the coefficient memory 93 is read by the upsampling filter 94 according to the setting by the filter control section 92. The filter coefficient may be dynamically calculated by the filter control section 92.

(4) Upsampling Filter

The upsampling filter 94 upsamples the image of the base layer referred to at the time of the local decoding of the image of the enhancement layer with a higher space resolution than the base layer under the control of the filter control section 92. The image upsampled by the upsampling filter 94 may be one or both of the predicted error image and the decoded image of the base layer. More specifically, the upsampling filter 94 identifies the filter configuration set in regard to the image of the base layer acquired from the common memory 7 according to the resolution ratio and the strength of the high-pass component for each block. Then, the upsampling filter 94 calculates an interpolation pixel value of each of the interpolation pixels scanned in order according to the resolution ratio by filtering the image of the base layer with the filter coefficient acquired from the coefficient memory 93. Therefore, it is possible to improve the space resolution of the image of the base layer used as the reference block up to the same resolution as the enhancement layer. The upsampling filter 94 outputs the reference image data after the upsampling to the frame memory 69.

### 4-3. Upsampling Section

### Second Execution Example

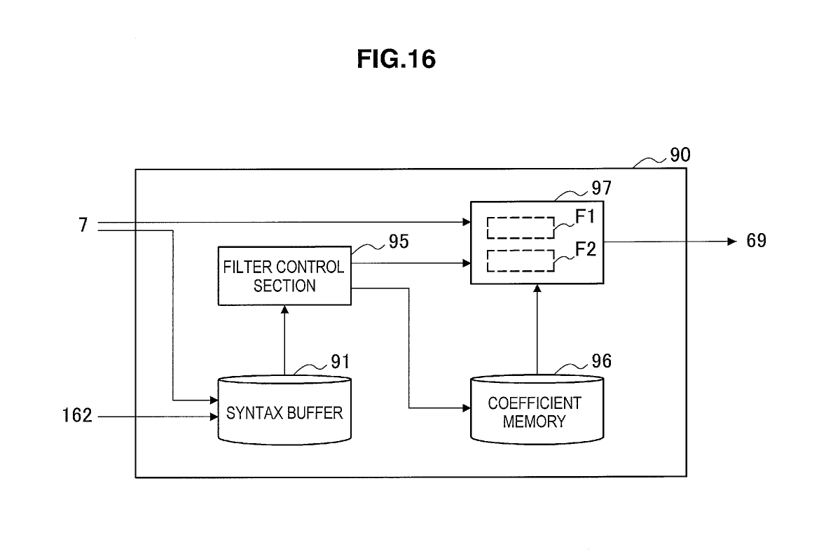

FIG. 16 is a block diagram illustrating an example of the configuration of the upsampling section 90 according to the second execution example. Referring to FIG. 16, the upsampling section 90 includes a syntax buffer 91, a filter control section 95, a coefficient memory 96, and an upsampling filter 97.

(1) Syntax Buffer

The syntax buffer 91 is a buffer that stores a parameter used when the filter control section 95 controls the upsampling. For example, the syntax buffer 91 stores the resolution ratio between the base layer image and the enhancement layer image. The resolution ratio can be decoded from the VPS, or the SPS or the PPS of the enhancement layer by the lossless decoding section 62. The syntax buffer 91 stores the filter configuration information which can be decoded for each block of the base layer. The syntax buffer 91 may store the picture type of each picture when the picture type is referred to in order to decide the filter configuration.

(2) Filter Control Section

The filter control section 95 selects the filter configuration corresponding to the filter configuration information stored by the syntax buffer 91 from the candidates of the plurality of filter configuration for the upsampling of the image of the base layer for each block. The image to be upsampled may be one or both of the predicted error image and the decoded image of the base layer. Typically, the filter configuration information indicates one of two or more filter configurations for each block. Here, the block may be the PU or may be another unit such as the LCU, the CU, or the TU. In the second execution example, the filter control section 95 may also perform the control of the adaptive upsampling for each block depending on the picture type.

(3) Coefficient Memory

The coefficient memory 96 is a memory that stores various candidates for the filter coefficient used by the upsampling filter 97. For example, the coefficient memory 96 stores each filter coefficient set in regard to each combination of the number of taps and a pixel position to be interpolated. For example, in the first filter configuration, 7 or 8 taps and the same filter coefficient as an interpolation filter for the motion compensation can be present for the luma component. In the second filter configuration, 4 taps and the same filter coefficient as an interpolation filter for the DCT can be present. In the first filter configuration, 4 taps and the same filter coefficient as the interpolation filter for the motion compensation can be present for the chroma component. In the second filter configuration, 2 taps and a filter coefficient corresponding to linear interpolation can be present. The filter coefficient set stored by the coefficient memory 96 is read by the upsampling filter 97.

(4) Upsampling Filter

The upsampling filter 97 upsamples the image of the base layer referred to at the time of the decoding of the image of the enhancement layer with a higher space resolution than the base layer under the control of the filter control section 95. More specifically, the upsampling filter 97 identifies the resolution ratio in regard to the image of the base layer acquired from the common memory 7. The upsampling filter 97 acquires, from the coefficient memory 96, the filter coefficient set corresponding to the filter configuration selected for each block by the filter control section 95 according to the filter configuration information. Then, the upsampling filter 97 calculates an interpolation pixel value by filtering the image of the base layer of each of the interpolation pixels scanned in order according to the resolution ratio. Accordingly, the upsampled image with the space resolution increased to the same degree as the enhancement layer is generated. The upsampling filter 97 may include a plurality of filter circuits F1 and F2 corresponding to different filter configurations. The upsampling filter 97 outputs the generated upsampled image (the reference image data after the upsampling) to the frame memory 69.

### 5. Flow of a Process of Decoding

### First Embodiment

### 5-1. Schematic Flow

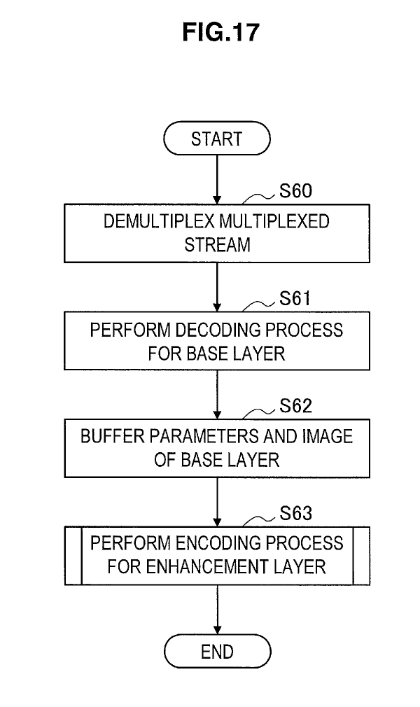

FIG. 17 is a flow chart showing an example of the flow of a schematic process for decoding. For the sake of brevity of description, process steps not directly relevant to the technology in the present disclosure are omitted from the drawing.

Referring to FIG. 17, the demultiplexing section 5 first demultiplexes a multilayer multiplexed stream into an encoded stream of the base layer and an encoded stream of the enhancement layer (Step S60).

Next, the BL decoding section 6a performs a decoding process for the base layer to reconstruct a base layer image from the encoded steam of the base layer (Step S61).

The common memory 7 buffers the high-pass component parameters and the image (one or both of the decoded image and the predicted error image) of the base layer generated through the decoding process for the base layer (step S62). The buffered parameters may additionally include the picture type.

Next, the EL decoding section 6b performs the decoding process for the enhancement layer to reconstruct the enhancement layer image (step S63). In the decoding process for the enhancement layer to be performed herein, the image of the base layer buffered by the common memory 7 is upsampled by the upsampling section 90 and is used as the reference image in the inter layer prediction.

### 5-2. Upsampling Process

### (1) First Execution Example

In the first execution example, the flow of the upsampling process in the decoding process for the enhancement layer may be the same as the flow of the upsampling process in the encoding process described above.

For example, in the first example (see FIG. 10), the filter control section 92 determines whether the high-pass component in the reference block is strong, using the high-pass component parameters of the reference block of the base layer. When it is determined that the high-pass component is not strong, the number of filter taps is set to the first value. When it is determined that the high-pass component is strong, the number of filter taps is set to the second value greater than the first value. Then, the upsampling filter 94 acquires the filter coefficient from the coefficient memory 43 for each interpolation pixel position in a block of interest and calculates the interpolation pixel value by filtering the image of the base layer with the acquired filter coefficient. When the calculation (that is, the upsampling) of the interpolation pixel value ends for all of the interpolation pixel positions in the block of interest, the upsampling filter 94 stores the reference image data after the upsampling in the frame memory 25.

In the second example (see FIG. 11), the filter control section 92 sets the number of filter taps to the first value when the picture type of the reference image is the B picture. When the picture type of the reference image is not the B picture, the filter control section 92 adaptively sets the number of filter taps for each block using the high-pass component parameters.

### (2) Second Execution Example

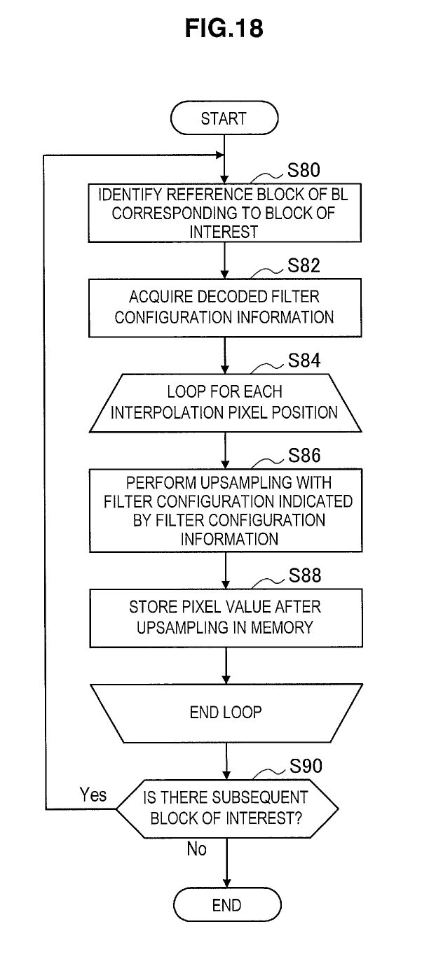

FIG. 18 is a flow chart showing an example of the flow of an upsampling process according to the second execution example in the decoding process for the enhancement layer.

Referring to FIG. 18, the filter control section 95 first identifies the reference block of the base layer corresponding to a block of interest of the enhancement layer (step S80). The reference block identified herein may be a co-located block of the block of interest.

Next, the filter control section 95 acquires the filter configuration information regarding the block of interest decoded by the lossless decoding section 62 (step S82).

The processes of steps S86 to S88 are repeated for each interpolation pixel position in the block of interest (step S84). The interpolation pixel position is decided according to the resolution ratio between the layers. In each repetition, the upsampling filter 97 calculates the interpolation pixel value by filtering the image of the base layer with the filter configuration indicated by the filter configuration information (step S86). Next, the upsampling filter 97 stores the calculated interpolation pixel value after the upsampling in the frame memory 69 (step S88).

When there is a subsequent block of interest after the end of the loop for all of the interpolation pixel positions in the block of interest, the process returns to step S80 and the above-described processes are repeated on the subsequent block of interest (step S90). When there is no subsequent block of interest, the upsampling process of FIG. 18 ends.

### 5-3. Modification Example

In a modification example, the filter control section 92 may switch the filter configuration of the upsampling filter 94 according to the chroma format when the chroma component of the image of the base layer is upsampled by the upsampling filter 94.

The flow of the upsampling process in the modification example may be the same as the flow of the upsampling process described with reference to FIG. 13. For example, when the chroma format is 4:2:0, the filter control section 92 can set the number of filter taps of the upsampling filter applied to the chroma component to a smaller value than the upsampling filter applied to the luma component in both of the horizontal direction and the vertical direction. When the chroma format is 4:2:2, the filter control section 92 can set the number of filter taps of the upsampling filter applied to the chroma component to a smaller value than the upsampling filter applied to the luma component in the horizontal direction and can set the number of filter taps to the same value as that of the upsampling filter applied to the luma component in the vertical direction. When the chroma format is 4:4:4, the filter control section 92 can set the number of filter taps of the upsampling filter applied to the chroma component to the same value as that of the upsampling filter applied to the luma component in both of the horizontal direction and the vertical direction.

### 5-4. Inverse Quantization Process

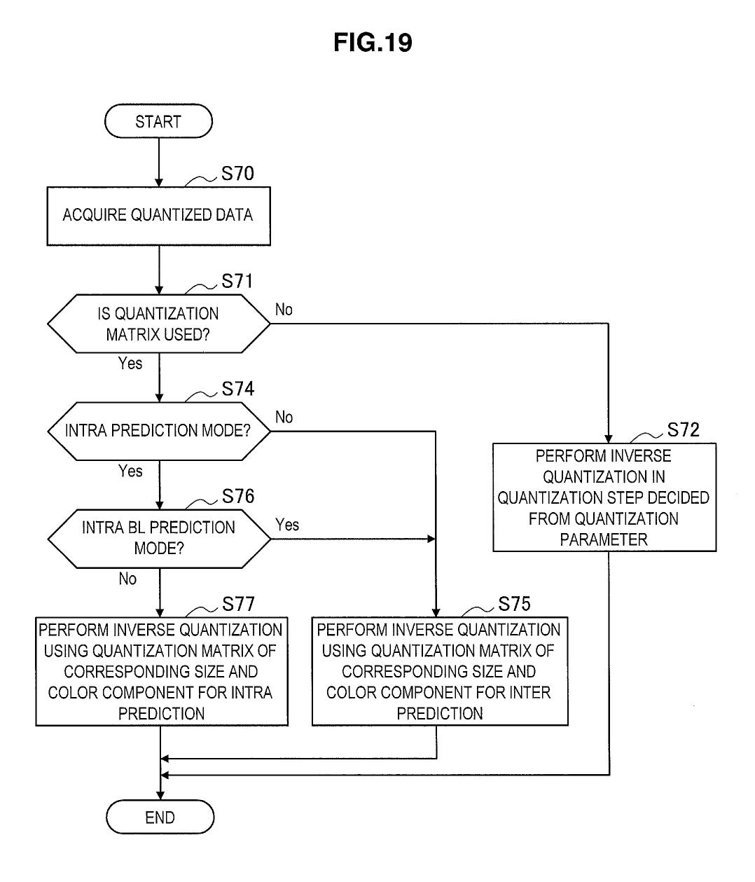

FIG. 19 is a flow chart showing an example of the flow of an inverse quantization process in the decoding process for the enhancement layer. Even when the EL encoding section 1b performs the encoding process for the enhancement layer, the transform coefficient data may be quantized and inversely quantized, as in the inverse quantization process described herein.

Referring to FIG. 19, the inverse quantization section 63 first acquires the quantized data (that is, the transform coefficient data quantized in the encoder) input from the lossless decoding section 62 (step S70).

Next, the inverse quantization section 63 determines whether the quantized matrix is used for the inverse quantization (step S71). When the inverse quantization section 63 determines that the quantization matrix is not used, the inverse quantization section 63 inversely quantizes the quantized data in the quantization step decided from the quantization parameter (step S72).

Conversely, when the inverse quantization section 63 determines that the quantization matrix is used, the inverse quantization section 63 determines the prediction mode to be applied to a processing target block (steps S74 and S76). Then, when the applied mode is the inter prediction mode, the inverse quantization section 63 inversely quantizes the quantized data using the quantization matrix of the corresponding block size and color component defined for the inter prediction (step S75).

When the applied mode is the intra BL prediction mode of the intra prediction mode, the inverse quantization section 63 inversely quantizes the quantized data using the quantization matrix defined for the inter prediction (step S75).

When the applied mode is the intra prediction mode other than the intra BL prediction mode, the inverse quantization section 63 inversely quantizes the quantized data using the quantization matrix of the corresponding block size and color component defined for the intra prediction (step S77).

The inverse quantization section 63 outputs the transform coefficient data restored as the result of the inverse quantization process to the inverse orthogonal transform section 64.

### 6. Second Embodiment

In a second embodiment to be described in this section, a filter configuration of an upsampling filter is switched adaptively in units rougher than video data, a picture, a sequence, or the like rather than a block of an image. The basic configurations of an encoder and a decoder in the second embodiment may be the same as the configurations of the first embodiment described with reference to FIGS. 3 and 4.

[6-1. Configuration Example of EL Encoding Section]

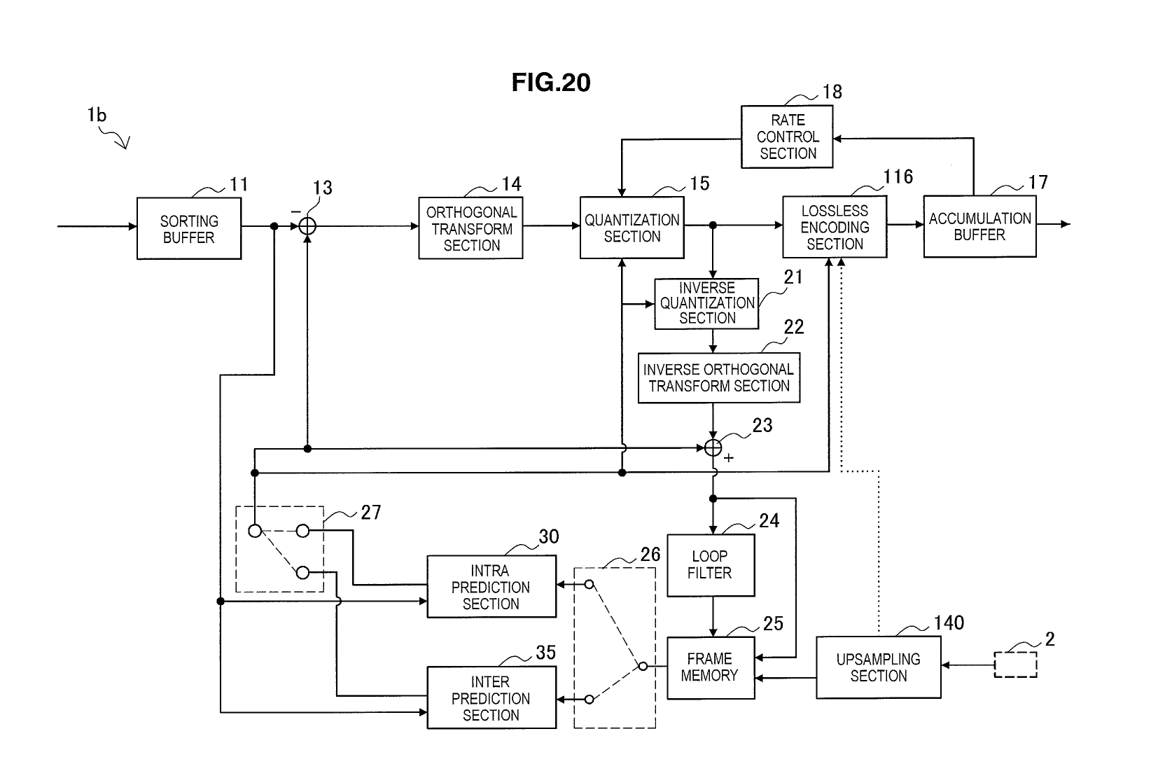

FIG. 20 is a block diagram showing an example of the configuration of the EL encoding section 1b according to the second embodiment. Referring to FIG. 20, the EL encoding section 1b includes a sorting buffer 11, a subtraction section 13, an orthogonal transform section 14, a quantization section 15, a lossless encoding section 116, an accumulation buffer 17, a rate control section 18, an inverse quantization section 21, an inverse orthogonal transform section 22, an addition section 23, a loop filter 24, a frame memory 25, selectors 26 and 27, an intra prediction section 30, an inter prediction section 35, and an upsampling section 40.

The lossless encoding section 116 performs a lossless encoding process on the quantized data input from the quantization section 15 to generate an encoded stream of the enhancement layer. The lossless encoding section 116 encodes various parameters referred to when the encoded stream is decoded and inserts the encoded parameters into a header region of the encoded stream. The parameters encoded by the lossless encoding section 116 can include information regarding intra prediction and information regarding inter prediction. In the embodiment, the lossless encoding section 116 encodes the filter configuration information indicating the optimum filter configuration of the upsampling filter to the VPS, the SPS, or the PPS of the encoded stream. Then, the lossless encoding section 16 outputs the generated encoded stream to the accumulation buffer 17.

The upsampling section 140 upsamples the image of the base layer buffered by the common memory 2 according to the resolution ratio between the base layer and the enhancement layer. The image upsampled by the upsampling section 140 can be stored in the frame memory 25 and can be used as a reference image in the inter layer prediction by the intra prediction section 30 or the inter prediction section 35. The upsampling section 140 may switch the optimum filter configuration of the upsampling filter in each processing unit such as video data, a sequence, or a picture and causes the lossless encoding section 116 to encode the filter configuration information corresponding to the filter configuration applied to each processing unit.

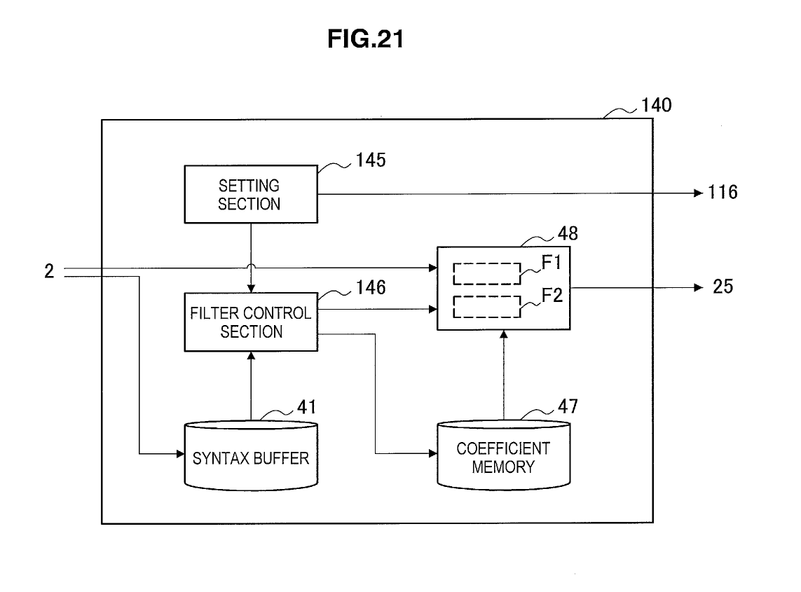

FIG. 21 is a block diagram illustrating an example of the configuration of the upsampling section illustrated in FIG. 20. Referring to FIG. 21, the upsampling section 140 includes a syntax buffer 41, a setting section 145, a filter control section 146, a coefficient memory 47, and an upsampling filter 48.

For example, the setting section 145 sets the filter configuration determined to be optimum based on an application prerequisite (a bit rate or the like), analysis of previous video data, a frame size, or the like in each of the processing units corresponding to the video data, the sequence, and the picture.

The filter control section 146 selects the filter configuration of the upsampling filter 48 to be used at the time of the decoding for each processing unit from a plurality of different configurations according to the setting of the setting section 145. An image to be upsampled may be one or both of the decoded image and the predicted error image of the base layer. The upsampled image generated by the upsampling filter 48 is stored in the frame memory 25. The filter control section 146 generates the filter configuration information corresponding to the filter configuration selected in each processing unit and outputs the generated filter configuration information to the lossless encoding section 116. The output filter configuration information is encoded by the lossless encoding section 116.

In the embodiment, the filter configuration can also include the number of filter taps and the filter coefficient. In the first filter configuration, 7 or 8 taps and the same filter coefficient as the interpolation filter for the motion compensation can be present for the luma component. In the second filter configuration, 4 taps, and the same filter coefficient as the interpolation filter for the DCT can be present. In the first filter configuration, 4 taps and the same filter coefficient as the interpolation filter for the motion compensation can be present for the chroma component. In the second filter configuration, 2 taps and the filter coefficient corresponding to linear interpolation can be present. The upsampling filter 48 generates the upsampled image corresponding to the filter configuration selected by the filter control section 146 by upsampling the image of the base layer referred to at the time of the local decoding of the image of the enhancement layer.

In a typical example, the filter configuration information may be an index indicating one among two or more candidates for the filter configuration for each video data, sequence, or picture. The filter coefficient may be indicated by the filter configuration information or may be defined in advance and stored by the encoder and the decoder.

In a certain modification example, the filter configuration information may include a hierarchy threshold value compared to time hierarchy of each picture. The time hierarchy means individual hierarchy of a hierarchy structure based on a reference relation between pictures. For example, in the latest specification of SHVC, the VPS is defined such that parameters vps_max_layers_minus1 and vps_max_sub_layers_minus1 are included. The parameter vps_max_layers_minus1 defines the maximum number of layers (minus 1) subjected to scalable video coding in the encoded stream. The parameter vps_max_sub_layers_minus1 defines the allowable maximum numerical value (minus 1) of the time hierarchy included in each of the base layer and the enhancement layer. In the modification example, in an extension (vps_extension) of the VPS in addition to these parameters, a hierarchy threshold value may be defined for each enhancement layer as in the following Table 1.

TABLE 1
Syntax example related to hierarchy threshold value

vps_extension( ) {

...
for( i = 1; i <= vps_max_layers_minus1; i++ )
max_sub_layer_with_longer_tap_filter_for_il_upsampling[i]
...

}

In Table 1, the hierarchy threshold value compared to the time hierarchy is defined for each enhancement layer specified by an index i by a parameter max_sub_layer_with_longer_tap_filter_for_il_upsampling[i]. This parameter is encoded by the lossless encoding section 116. When the enhancement layer is encoded, the filter control section 146 selects the first number of filter taps (for example, 7 or 8 taps for the luma component) for a picture of the time hierarchy shallower than the hierarchy threshold value which can be defined in this way. Further, the filter control section 146 selects the second number of filter taps (for example, 4 taps for the luma component) less than the first number of filter taps for a picture of the time hierarchy deeper than the hierarchy threshold value.

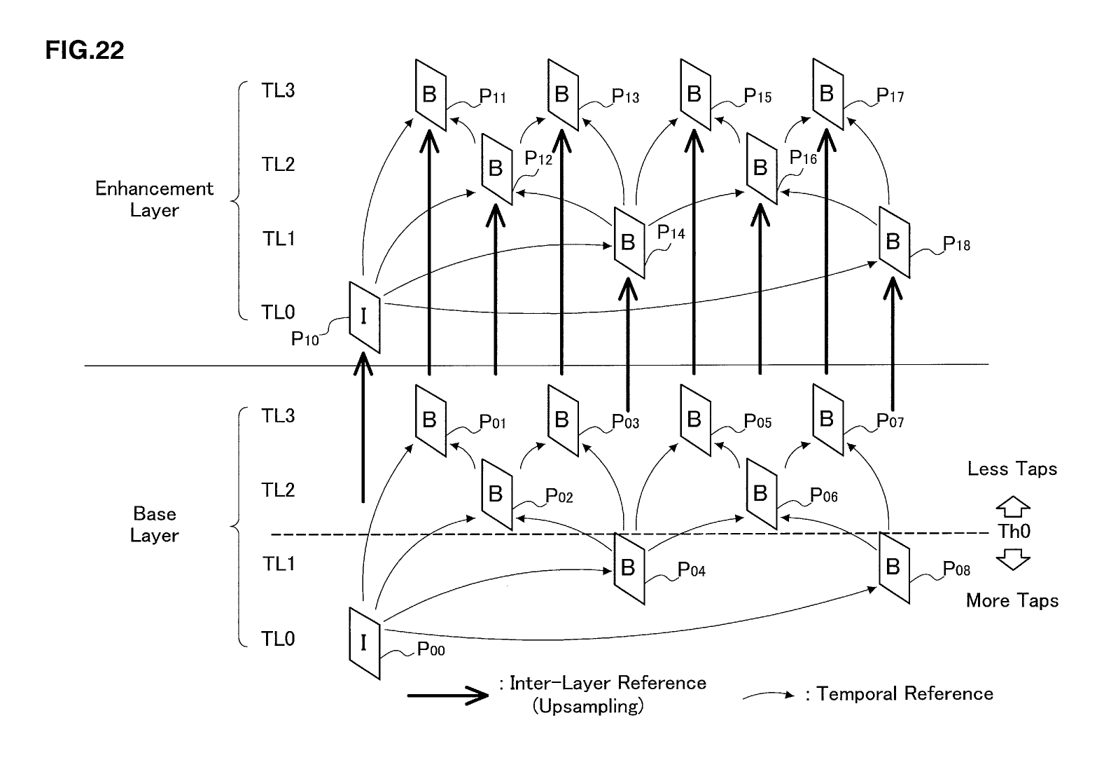

FIG. 22 is an illustrative diagram for further describing the above-described modification example of the second embodiment. Pictures P₀₀ to P₀₈ included in the base layer are illustrated in the lower part of FIG. 22 and pictures P₁₀ to P₁₈ included in the enhancement layer are illustrated in the upper part. The picture P₀₀ is an I picture and can be decoded without referring to another picture. Time hierarchy TL0 of the picture P₀₀ is the shallowest. The pictures P₀₄ and P₀₈ belonging to the next shallow time hierarchy TL1 can be decoded by referring to only the picture P₀₀. The pictures P₀₂ and P₀₆ belonging to the next shallow time hierarchy TL2 can be decoded by referring to one or more of the pictures P₀₀, P₀₄, and P₀₈. The pictures P₀₁, P₀₃, P₀₅, and P₀₇ belonging to the deepest time hierarchy TL3 can be decoded by referring to one or more of the pictures P₀₀, P₀₂, P₀₄, P₀₆, and P₀₈. The shallowest time hierarchy TL0 may also include a picture type of a picture other than the I picture without being limited to the example of FIG. 22. The pictures P₁₀ to P₁₈ of the enhancement layer can be decoded by referring to the upsampled images of the pictures P₀₀ to P₀₈ of the base layer in the inter layer prediction. For example, when a hierarchy threshold value Th0 is the same as 2 in the time hierarchies, more filter taps can be used at the time of the upsampling of the pictures P₀₀, P₀₄, and P₀₈ belonging to the time hierarchies TL0 and TL01. On the other hand, fewer filter taps can be used at the time of the upsampling of the remaining pictures belonging to the time hierarchies TL2 and TL03.

Deterioration in the image quality caused by the upsampling of a certain picture has an adverse influence on prediction accuracy of another picture that refers to the certain picture. Accordingly, as in the above-described modification example, by increasing the number of filter taps of the upsampling filter in regard to a picture for which the time hierarchy to which a greater number of other pictures refer is shallow, it is possible to improve the prediction accuracy, and thus improve coding efficiency. In contrast, by reducing the number of filter taps of the upsampling filter in a regard to a picture for which the time hierarchy to which other pictures do not refer (at all or very much) is deep, it is possible to reduce a calculation cost without sacrificing the coding efficiency.

[6-2. Configuration Example of EL Decoding Section]

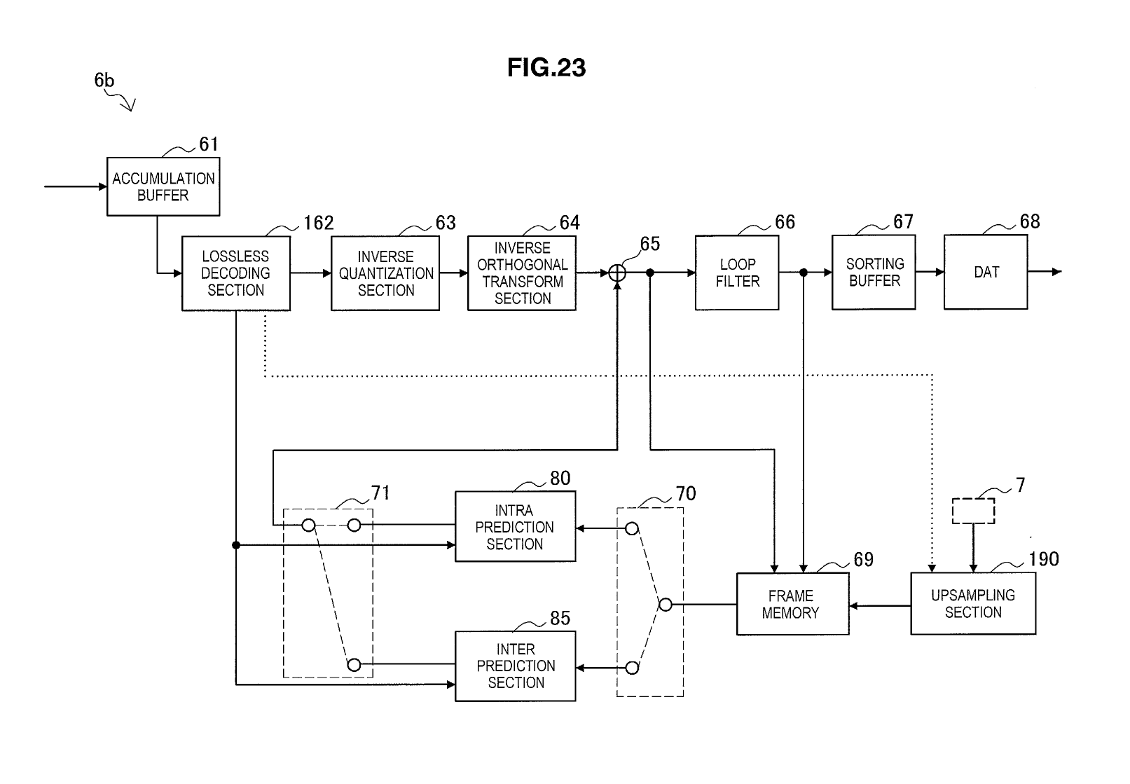

FIG. 23 is a block diagram showing an example of a configuration of the EL decoding section 6b according to the second embodiment. Referring to FIG. 23, the EL decoding section 6b includes an accumulation buffer 61, a lossless decoding section 162, an inverse quantization section 63, an inverse orthogonal transform section 64, an addition section 65, a loop filter 66, a sorting buffer 67, a D/A conversion section 68, a frame memory 69, selectors 70 and 71, an intra prediction section 80, an inter prediction section 85, and an upsampling section 190.

The lossless decoding section 162 decodes the quantized data of the enhancement layer from the encoded stream of the enhancement layer input from the accumulation buffer 61 according to the encoding scheme used at the time of the encoding. In addition, the lossless decoding section 162 decodes the information inserted into the header region of the encoded stream. The information decoded by the lossless decoding section 162 can include, for example, information relating to intra prediction and information relating to inter prediction. In the embodiment, the lossless decoding section 162 decodes the filter configuration information indicating the optimum filter configuration of the upsampling filter from the VPS, the SPS, or the PPS of the encoded stream. The filter configuration information may be information that indicates one of two or more candidates for the filter configuration for each piece of video data, sequence, or picture, as described above. In a simple example, the information may include an index that indicates one of the candidates for the filter configuration. Instead, as in the above-described modification example, the information may include a hierarchy threshold value compared to the time hierarchy of each picture. The lossless decoding section 162 outputs the quantized data to the inverse quantization section 63. The lossless decoding section 162 outputs the information regarding the intra prediction to the intra prediction section 80. The information regarding the intra prediction may be output to the inverse quantization section 63 to switch the quantization matrix. The lossless decoding section 162 outputs the information regarding the inter prediction to the inter prediction section 85. The lossless decoding section 162 outputs the filter configuration information to the upsampling section 190.

The upsampling section 190 upsamples the image of the base layer buffered by the common memory 7 according to the resolution ratio between the base layer and the enhancement layer. The image upsampled by the upsampling section 190 can be stored in the frame memory 69 and can be used as a reference image in the inter layer prediction by the intra prediction section 80 or the inter prediction section 85. The upsampling section 190 selects the filter configuration of the upsampling filter according to the filter configuration information decoded from the encoded stream.

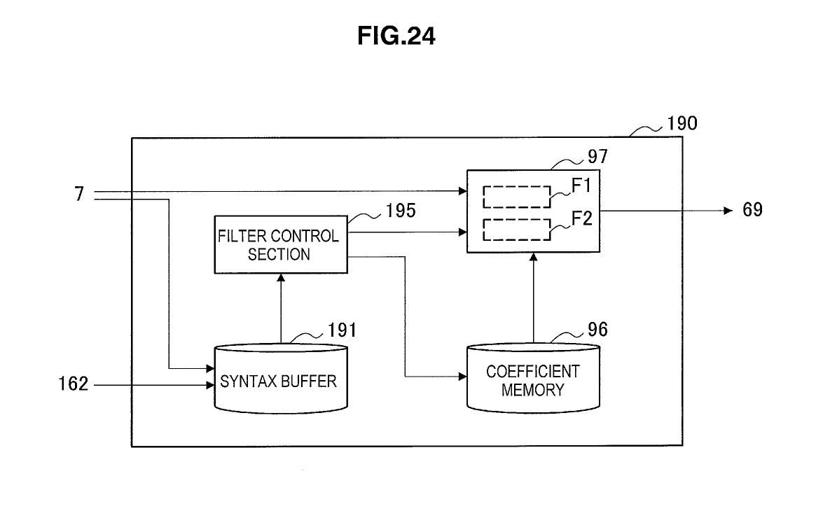

FIG. 24 is a block diagram illustrating an example of a configuration of the upsampling section 190 illustrated in FIG. 23. Referring to FIG. 24, the upsampling section 190 includes a syntax buffer 191, a filter control section 195, a coefficient memory 96, and an upsampling filter 97.

The syntax buffer 191 is a buffer that stores parameters used when the filter control section 195 controls the upsampling. For example, the syntax buffer 191 stores the resolution ratio between the base layer image and the enhancement layer image. The resolution ratio can be decoded from the VPS, or the SPS or the PPS of the enhancement layer by the lossless decoding section 62. The syntax buffer 191 stores the filter configuration information which can be decoded by the lossless decoding section 162.

The filter control section 195 selects the filter configuration corresponding to the filter configuration information stored by the syntax buffer 191 from the candidates of the plurality of filter configurations for the upsampling of the image of the base layer for each processing unit such as the video data, the sequence, or the picture. The image to be upsampled may be one or both of the predicted error image and the decoded image of the base layer. The upsampling filter 97 generates the upsampled image corresponding to the filter configuration selected by the filter control section 195 by upsampling the base layer image. The upsampled image generated by the upsampling filter 97 is stored in the frame memory 69.

In a typical example in which the filter configuration information indicates one of the candidates for the filter configuration by the index, the filter control section 195 selects the filter configuration for each processing unit such as the video data, the sequence, or the picture according to the index.

In a modification example in which the filter configuration information includes the hierarchy threshold value compared to the time hierarchy of each picture, the filter control section 195 selects the first number of filter taps for the picture of the time hierarchy shallower than the decoded hierarchy threshold value (for example, max_sub_layer_with_longer_tap_filter_for_il_upsampling[i] exemplified in Table 1) and selects the second number of filter taps less than the first number of filter taps for the picture of the time hierarchy deeper than the hierarchy threshold value.

[6-3. Flow of Upsampling Process for Encoding]

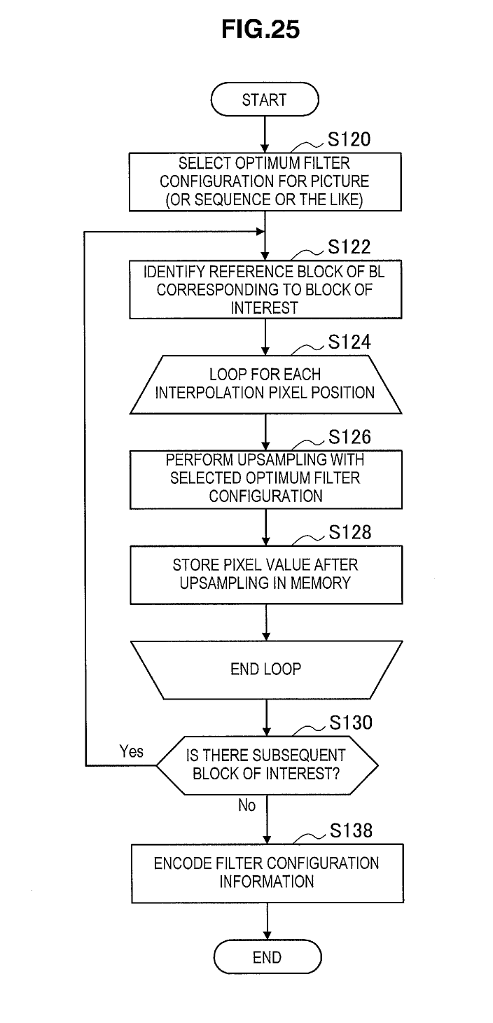

FIG. 25 is a flow chart showing an example of the flow of an upsampling process in the encoding process for the enhancement layer.

Referring to FIG. 25, the filter control section 146 first selects the optimum filter configuration of the upsampling filter 48 for each processing unit of the picture (or the sequence or the like) according to the setting of the setting section 145 (step S120). Next, the filter control section 146 first identifies the reference block of the base layer corresponding to a block of interest of the enhancement layer (step S122). The reference block identified herein may be a co-located block of the block of interest.

The processes of steps S126 and S128 are repeated for each interpolation pixel position in the block of interest (step S124). The interpolation pixel position is decided according to the resolution ratio between the layers. In each repetition, the upsampling filter 48 calculates the interpolation pixel value by filtering the image of the base layer with the filter configuration selected by the filter control section 146 (step S126). Next, the upsampling filter 48 stores the interpolation pixel value after the upsampling in the frame memory 25 (step S128).

When the loop ends for all of the interpolation pixel positions in the block of interest, the filter control section 146 determines whether there is a subsequent block of interest (step S130). When there is the subsequent block of interest, the process returns to step S120 and the above-described processes are repeated on the subsequent block of interest. When there is no subsequent block of interest, the filter configuration information regarding the block of interest generated by the filter control section 146 can be encoded by the lossless encoding section 116 (step S138). Then, the upsampling process of FIG. 25 ends.

[6-4. Flow of Upsampling Process for Decoding]

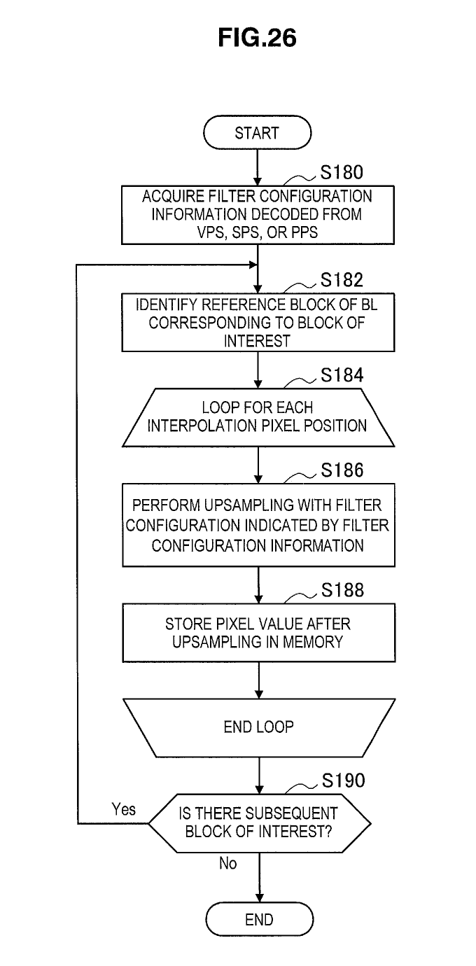

FIG. 26 is a flow chart showing an example of the flow of the upsampling process in the decoding process for the enhancement layer.

Referring to FIG. 26, the filter control section 195 first acquires the filter configuration information decoded from the VPS, the SPS, or the PPS from the syntax buffer 191 (step S180).

Next, the filter control section 195 identifies the reference block of the base layer corresponding to the block of interest of the enhancement layer (step S182). The reference block identified herein may be a co-located block of the block of interest.

The processes of steps S186 and S188 are repeated for each interpolation pixel position in the block of interest (step S184). The interpolation pixel position is decided according to the resolution ratio between the layers. In each repetition, the upsampling filter 97 calculates the interpolation pixel value by filtering the image of the base layer with the filter configuration indicated by the filter configuration information (step S186). Next, the upsampling filter 97 stores the calculated interpolation pixel value after the upsampling in the frame memory 69 (step S188).

When there is a subsequent block of interest after the end of the loop for all of the interpolation pixel positions in the block of interest, the process returns to step S182 and the above-described processes are repeated on the subsequent block of interest (step S190). When there is no subsequent block of interest, the upsampling process of FIG. 26 ends.

### 7. Application Example

### 7-1. Application to Various Products

The image encoding device 10 and the image decoding device 60 according to the various embodiment described above can be applied to various electronic appliances such as a transmitter and a receiver for satellite broadcasting, cable broadcasting of a cable TV, distribution on the Internet, distribution to terminals via cellular communication, and the like, a recording device that records images in a medium such as an optical disc, a magnetic disk or a flash memory, a reproduction device that reproduces images from such storage media, and the like. Four application examples will be described below.

### (1) First Application Example

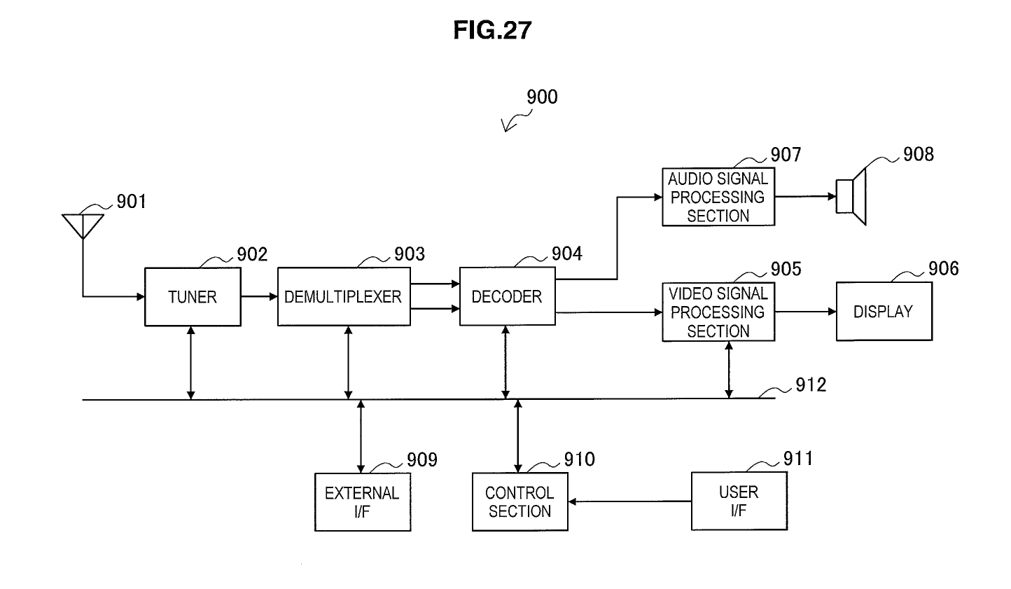

FIG. 27 illustrates an example of a schematic configuration of a television device. A television device 900 includes an antenna 901, a tuner 902, a demultiplexer 903, a decoder 904, a video signal processing section 905, a display 906, an audio signal processing section 907, a speaker 908, an external interface 909, a control section 910, a user interface 911, and a bus 912.

The tuner 902 extracts a signal of a desired channel from a broadcast signal received through the antenna 901 and demodulates the extracted signal. The tuner 902 then outputs an encoded bit stream obtained by the demodulation to the demultiplexer 903. That is, the tuner 902 has a role as a transmission means receiving the encoded stream in which an image is encoded, in the television device 900.

The demultiplexer 903 separates a video stream and an audio stream of a program to be viewed from the encoded bit stream and outputs each of the separated streams to the decoder 904. The demultiplexer 903 also extracts auxiliary data such as an electronic program guide (GEP) from the encoded bit stream and supplies the extracted data to the control section 910. Here, the demultiplexer 903 may descramble the encoded bit stream when it is scrambled.

The decoder 904 decodes the video stream and the audio stream that are input from the demultiplexer 903. The decoder 904 then outputs video data generated by the decoding process to the video signal processing section 905. Furthermore, the decoder 904 outputs audio data generated in the decoding process to the audio signal processing section 907.

The video signal processing section 905 reproduces the video data input from the decoder 904 and displays the video on the display 906. The video signal processing section 905 may also display an application screen supplied through the network on the display 906. The video signal processing section 905 may further perform an additional process, for example, noise reduction on the video data according to the setting. Furthermore, the video signal processing section 905 may generate an image of a graphical user interface (GUI) such as a menu, a button, or a cursor and superpose the generated image onto the output image.

The display 906 is driven by a drive signal supplied from the video signal processing section 905 and displays video or an image on a video screen of a display device (such as a liquid crystal display, a plasma display, or an OELD).

The audio signal processing section 907 performs a reproduction process such as D-A conversion and amplification on the audio data input from the decoder 904 and outputs the audio from the speaker 908. The audio signal processing section 907 may also perform an additional process such as noise reduction on the audio data.

The external interface 909 is an interface for connecting the television device 900 with an external device or a network. For example, the decoder 904 may decode a video stream or an audio stream received through, for example, the external interface 909. In other words, the external interface 909 also has a role as the transmission means receiving the encoded stream in which an image is encoded, in the television device 900.

The control section 910 includes a processor such as a central processing unit (CPU) and a memory such as a random access memory (RAM) and a read only memory (ROM). The memory stores a program executed by the CPU, program data, EPG data, and data acquired through the network. The program stored in the memory is read by the CPU at the start-up of the television device 900 and executed, for example. By executing the program, the CPU controls operations of the television device 900 in accordance with an operation signal that is input from the user interface 911, for example.

The user interface 911 is connected to the control section 910. The user interface 911 includes a button and a switch for a user to operate the television device 900 as well as a reception part of a remote control signal, for example. The user interface 911 detects a user operation through these components, generates the operation signal, and outputs the generated operation signal to the control section 910.

The bus 912 connects the tuner 902, the demultiplexer 903, the decoder 904, the video signal processing section 905, the audio signal processing section 907, the external interface 909, and the control section 910 to each other.

The decoder 904 in the television device 900 configured in the aforementioned manner has a function of the image decoding device 60. Accordingly, it is possible to suppress the calculation cost of the upsampling while preventing the deterioration in the image quality when the television device 900 decodes images of the layers with different space resolutions.

### (7) Second Application Example

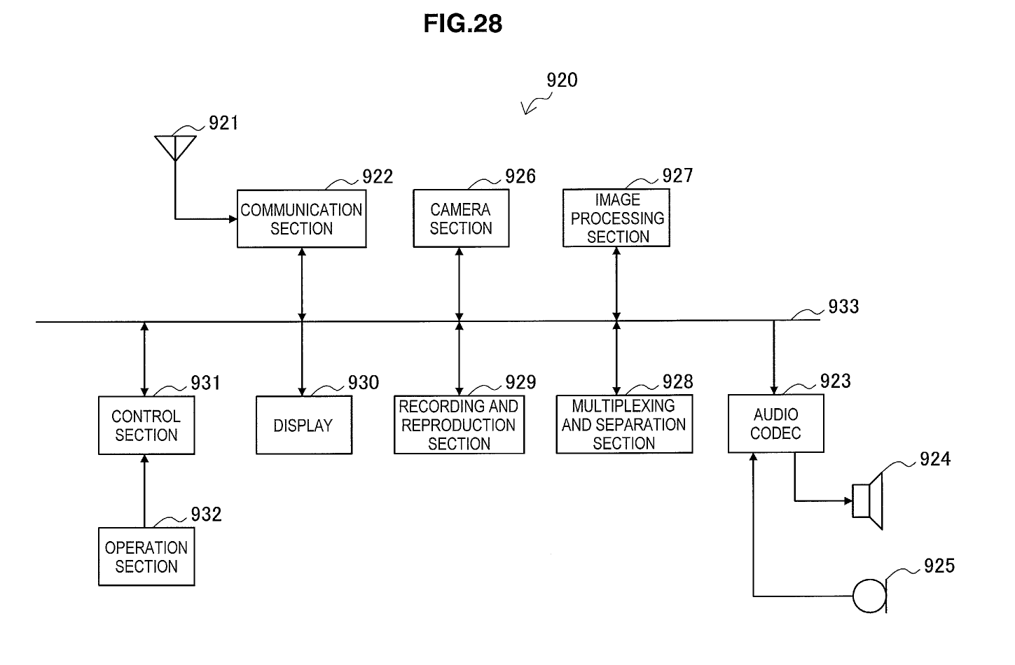

FIG. 28 illustrates an example of a schematic configuration of a mobile telephone. A mobile telephone 920 includes an antenna 921, a communication section 922, an audio codec 923, a speaker 924, a microphone 925, a camera section 926, an image processing section 927, a multiplexing and separation section 928, a recording and reproduction section 929, a display 930, a control section 931, an operation section 932, and a bus 933.

The antenna 921 is connected to the communication section 922. The speaker 924 and the microphone 925 are connected to the audio codec 923. The operation section 932 is connected to the control section 931. The bus 933 connects the communication section 922, the audio codec 923, the camera section 926, the image processing section 927, the multiplexing and separation section 928, the recording and reproduction section 929, the display 930, and the control section 931 to each other.

The mobile telephone 920 performs operations such as transmitting/receiving an audio signal, transmitting/receiving an electronic mail or image data, imaging an image, and recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A-D conversion on the converted audio data, and compresses the data. The audio codec 923 thereafter outputs the compressed audio data to the communication section 922. The communication section 922 encodes and modulates the audio data to generate a transmission signal. The communication section 922 then transmits the generated transmission signal to a base station (not illustrated) through the antenna 921. Furthermore, the communication section 922 amplifies a radio signal received through the antenna 921, converts a frequency of the signal, and acquires a reception signal. The communication section 922 thereafter demodulates and decodes the reception signal to generate the audio data and output the generated audio data to the audio codec 923. The audio codec 923 decompresses the audio data, performs D-A conversion on the data, and generates the analog audio signal. The audio codec 923 then outputs the audio by supplying the generated audio signal to the speaker 924.

In addition, in the data communication mode, for example, the control section 931 generates character data constituting an electronic mail, in accordance with a user operation through the operation section 932. The control section 931 further causes characters to be displayed on the display 930. Moreover, the control section 931 generates electronic mail data in accordance with a transmission instruction from a user through the operation section 932 and outputs the generated electronic mail data to the communication section 922. The communication section 922 encodes and modulates the electronic mail data to generate a transmission signal. Then, the communication section 922 transmits the generated transmission signal to the base station (not illustrated) through the antenna 921. The communication section 922 further amplifies a radio signal received through the antenna 921, converts a frequency of the signal, and acquires a reception signal. The communication section 922 thereafter demodulates and decodes the reception signal, restores the electronic mail data, and outputs the restored electronic mail data to the control section 931. The control section 931 causes the content of the electronic mail to be displayed on the display 930 as well as the electronic mail data to be stored in a storage medium of the recording and reproduction section 929.

The recording and reproduction section 929 includes an arbitrary readable and writable storage medium. For example, the storage medium may be a built-in storage medium such as a RAM or a flash memory, or may be an externally-mounted storage medium such as a hard disk, a magnetic disk, a magneto-optical disc, an optical disc, a USB memory, or a memory card.

In the photography mode, for example, the camera section 926 images an object, generates image data, and outputs the generated image data to the image processing section 927. The image processing section 927 encodes the image data input from the camera section 926 and stores an encoded stream in the storage medium of the recording and reproduction section 929.

In addition, in the videophone mode, for example, the multiplexing and separation section 928 multiplexes a video stream encoded by the image processing section 927 and an audio stream input from the audio codec 923, and outputs the multiplexed streams to the communication section 922. The communication section 922 encodes and modulates the streams to generate a transmission signal. The communication section 922 then transmits the generated transmission signal to the base station (not illustrated) through the antenna 921. Moreover, the communication section 922 amplifies a radio signal received through the antenna 921, converts a frequency of the signal, and acquires a reception signal. The transmission signal and the reception signal can include an encoded bit stream. Then, the communication section 922 demodulates and decodes the reception signal to restore the stream, and outputs the restored stream to the multiplexing and separation section 928. The multiplexing and separation section 928 separates the video stream and the audio stream from the input stream and outputs the video stream and the audio stream to the image processing section 927 and the audio codec 923, respectively. The image processing section 927 decodes the video stream to generate video data. The video data is then supplied to the display 930, and thereby the display 930 displays a series of images. The audio codec 923 decompresses and performs D-A conversion on the audio stream to generate an analog audio signal. The audio codec 923 then supplies the generated audio signal to the speaker 924 to output the audio.

The image processing section 927 in the mobile telephone 920 configured in the aforementioned manner has a function of the image encoding device 10 and the image decoding device 60. Accordingly, it is possible to suppress the calculation cost of the upsampling while preventing the deterioration in the image quality when the mobile telephone 920 encodes or decodes images of the layers with different space resolutions.

### (7) Third Application Example

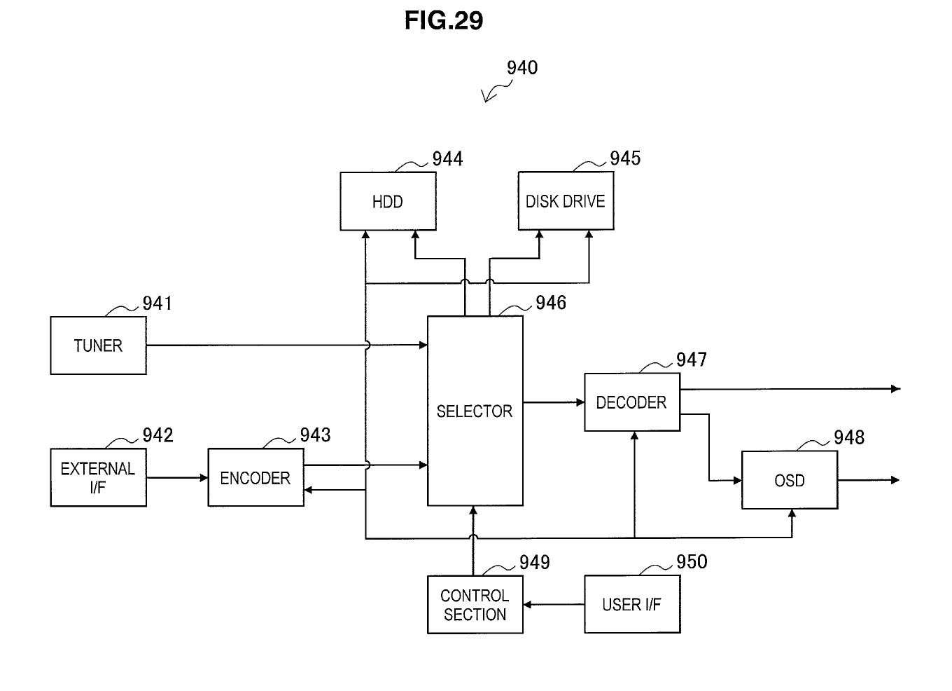

FIG. 29 illustrates an example of a schematic configuration of a recording and reproduction device. The recording and reproduction device 940 encodes audio data and video data of a received broadcast program and records the data into a recording medium, for example. The recording and reproduction device 940 may also encode audio data and video data acquired from another device and record the data into the recording medium, for example. In addition, in response to a user instruction, for example, the recording and reproduction device 940 reproduces the data recorded in the recording medium on a monitor and from a speaker. The recording and reproduction device 940 at this time decodes the audio data and the video data.

The recording and reproduction device 940 includes a tuner 941, an external interface 942, an encoder 943, a hard disk drive (HDD) 944, a disk drive 945, a selector 946, a decoder 947, an on-screen display (OSD) 948, a control section 949, and a user interface 950.

The tuner 941 extracts a signal of a desired channel from a broadcast signal received through an antenna (not illustrated) and demodulates the extracted signal. The tuner 941 then outputs an encoded bit stream obtained from the demodulation to the selector 946. That is, the tuner 941 has a role as a transmission means in the recording and reproduction device 940.

The external interface 942 is an interface for connecting the recording and reproduction device 940 with an external device or a network. The external interface 942 may be, for example, an IEEE 1394 interface, a network interface, a USB interface, or a flash memory interface. The video data and the audio data received through the external interface 942 are input to the encoder 943, for example. That is, the external interface 942 has a role as a transmission means in the recording and reproduction device 940.

The encoder 943 encodes the video data and the audio data when the video data and the audio data input from the external interface 942 are not encoded. The encoder 943 thereafter outputs an encoded bit stream to the selector 946.

The HDD 944 records the encoded bit stream in which content data such as video and audio is compressed, various programs, and other data into an internal hard disk. In addition, the HDD 944 reads these data from the hard disk when reproducing the video and the audio.

The disk drive 945 records and reads data into and from a recording medium which is mounted to the disk drive. The recording medium mounted to the disk drive 945 may be, for example, a DVD disk (such as DVD-Video, DVD-RAM, DVD-R, DVD-RW, DVD+R, or DVD+RW) or a Blu-ray (registered trademark) disk.

The selector 946 selects the encoded bit stream input from the tuner 941 or the encoder 943 when recording the video and audio, and outputs the selected encoded bit stream to the HDD 944 or the disk drive 945. In addition, when reproducing the video and audio, the selector 946 outputs the encoded bit stream input from the HDD 944 or the disk drive 945 to the decoder 947.

The decoder 947 decodes the encoded bit stream to generate the video data and the audio data. Then, the decoder 947 outputs the generated video data to the OSD 948. In addition, the decoder 904 outputs the generated audio data to an external speaker.

The OSD 948 reproduces the video data input from the decoder 947 and displays the video. The OSD 948 may also superpose an image of a GUI, for example, a menu, a button, or a cursor on the displayed video.

The control section 949 includes a processor such as a CPU and a memory such as a RAM and a ROM. The memory stores a program executed by the CPU as well as program data. The program stored in the memory is read by the CPU at the start-up of the recording and reproduction device 940 and executed, for example. By executing the program, the CPU controls operations of the recording and reproduction device 940 in accordance with an operation signal that is input from the user interface 950, for example.

The user interface 950 is connected to the control section 949. The user interface 950 includes a button and a switch for a user to operate the recording and reproduction device 940 as well as a reception part of a remote control signal, for example. The user interface 950 detects a user operation through these components, generates the operation signal, and outputs the generated operation signal to the control section 949.

The encoder 943 in the recording and reproduction device 940 configured in the aforementioned manner has a function of the image encoding device 10. In addition, the decoder 947 has a function of the image decoding device 60. Accordingly, it is possible to suppress the calculation cost of the upsampling while preventing the deterioration in the image quality when the recording and reproduction device 940 encodes or decodes images of the layers with different space resolutions.

### (7) Fourth Application Example

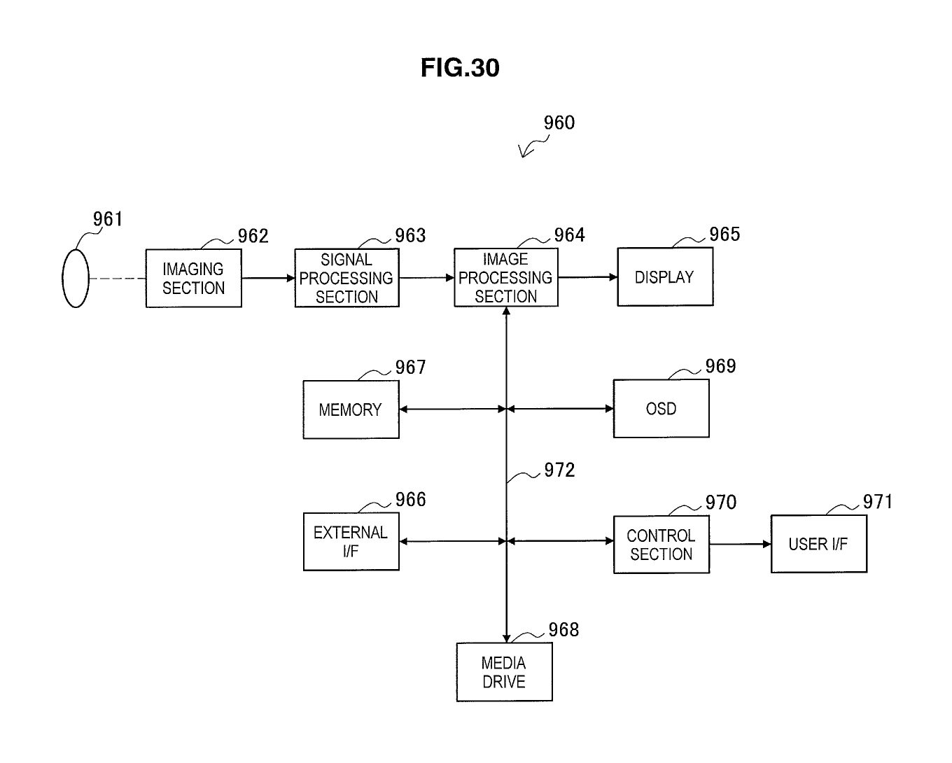

FIG. 30 illustrates an example of a schematic configuration of an imaging device. The imaging device 960 images an object, generates an image, encodes image data, and records the data into a recording medium.

The imaging device 960 includes an optical block 961, an imaging section 962, a signal processing section 963, an image processing section 964, a display 965, an external interface 966, a memory 967, a media drive 968, an OSD 969, a control section 970, a user interface 971, and a bus 972.

The optical block 961 is connected to the imaging section 962. The imaging section 962 is connected to the signal processing section 963. The display 965 is connected to the image processing section 964. The user interface 971 is connected to the control section 970. The bus 972 connects the image processing section 964, the external interface 966, the memory 967, the media drive 968, the OSD 969, and the control section 970 to each other.

The optical block 961 includes a focus lens and a diaphragm mechanism. The optical block 961 forms an optical image of a subject on an imaging surface of the imaging section 962. The imaging section 962 includes an image sensor such as a CCD or a CMOS and performs photoelectric conversion to convert the optical image formed on the imaging surface into an image signal as an electric signal. Then, the imaging section 962 outputs the image signal to the signal processing section 963.

The signal processing section 963 performs various camera signal processes such as knee correction, gamma correction and color correction on the image signal input from the imaging section 962. The signal processing section 963 outputs the image data, on which the camera signal process has been performed, to the image processing section 964.

The image processing section 964 encodes the image data input from the signal processing section 963 to generate the encoded data. The image processing section 964 then outputs the generated encoded data to the external interface 966 or the media drive 968. The image processing section 964 also decodes the encoded data input from the external interface 966 or the media drive 968 to generate image data. The image processing section 964 then outputs the generated image data to the display 965. Moreover, the image processing section 964 may output to the display 965 the image data input from the signal processing section 963 to display the image. Furthermore, the image processing section 964 may superpose display data acquired from the OSD 969 on the image that is output on the display 965.

The OSD 969 generates an image of a GUI, for example, a menu, a button, or a cursor and outputs the generated image to the image processing section 964.

The external interface 966 is configured as a USB input and output terminal, for example. The external interface 966 connects the imaging device 960 with a printer when printing an image, for example. Moreover, a drive is connected to the external interface 966 as needed. A removable medium such as a magnetic disk or an optical disc is mounted to the drive, for example, so that a program read from the removable medium can be installed in the imaging device 960. The external interface 966 may also be configured as a network interface that is connected to a network such as a LAN or the Internet. That is, the external interface 966 has a role as a transmission means in the imaging device 960.

The recording medium mounted to the media drive 968 may be an arbitrary readable and writable removable medium, for example, a magnetic disk, a magneto-optical disc, an optical disc, or a semiconductor memory. Furthermore, the recording medium may be fixedly mounted to the media drive 968 so that a non-transportable storage unit such as a built-in hard disk drive or a solid state drive (SSD) is configured, for example.

The control section 970 includes a processor such as a CPU and a memory such as a RAM and a ROM. The memory stores a program executed by the CPU as well as program data. The program stored in the memory is read by the CPU at, for example, the start-up of the imaging device 960 and then executed. By executing the program, the CPU controls operations of the imaging device 960 in accordance with an operation signal that is input from the user interface 971, for example.

The user interface 971 is connected to the control section 970. The user interface 971 includes a button and a switch for a user to operate the imaging device 960, for example. The user interface 971 detects a user operation through these components, generates the operation signal, and outputs the generated operation signal to the control section 970.

The image processing section 964 in the imaging device 960 configured in the aforementioned manner has the functions of the image encoding device 10 and the image decoding device 60. Accordingly, it is possible to suppress the calculation cost of the upsampling while preventing the deterioration in the image quality when the imaging device 960 encodes or decodes images of the layers with different space resolutions.

### 7-2. Various Uses of Scalable Video Coding

Advantages of scalable video coding described above can be brought to various uses. Three use examples will be described below.

### (1) First Example

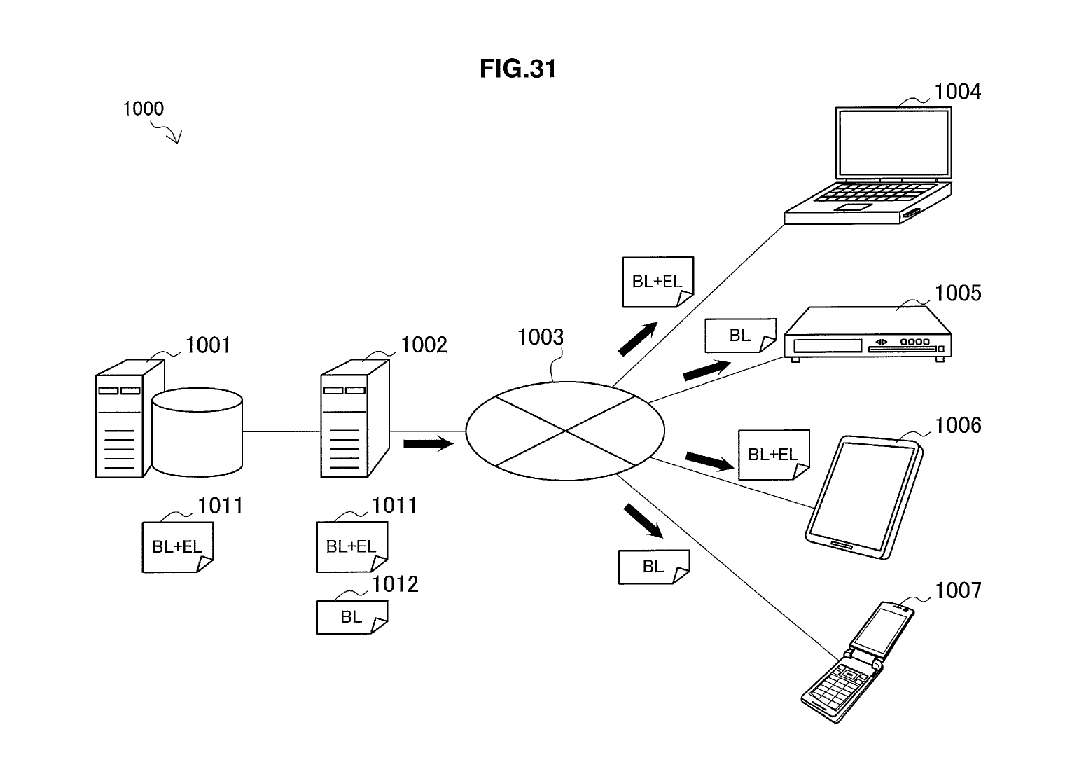

In the first example, scalable video coding is used for selective transmission of data. Referring to FIG. 31, a data transmission system 1000 includes a stream storage device 1001 and a delivery server 1002.

The delivery server 1002 is connected to some terminal devices via a network 1003. The network 1003 may be a wired network or a wireless network or a combination thereof. FIG. 31 shows a personal computer (PC) 1004, an AV device 1005, a tablet device 1006, and a mobile phone 1007 as examples of the terminal devices.

The stream storage device 1001 stores, for example, stream data 1011 including a multiplexed stream generated by the image encoding device 10. The multiplexed stream includes an encoded stream of the base layer (BL) and an encoded stream of an enhancement layer (EL). The delivery server 1002 reads the stream data 1011 stored in the stream storage device 1001 and delivers at least a portion of the read stream data 1011 to the PC 1004, the AV device 1005, the tablet device 1006, and the mobile phone 1007 via the network 1003.

When a stream is delivered to a terminal device, the delivery server 1002 selects the stream to be delivered based on some conditions such as capabilities of the terminal device or a communication environment. For example, the delivery server 1002 may avoid a delay in a terminal device or an occurrence of overflow or overload of a processor by delivering no encoded stream having high image quality exceeding image quality that can be handled by the terminal device. In addition, the delivery server 1002 may also avoid occupation of communication bands of the network 1003 by delivering no encoded stream having high image quality. On the other hand, when there is no risk to be avoided or it is considered to be appropriate based on a user's contract or some conditions, the delivery server 1002 may deliver an entire multiplexed stream to a terminal device.

In the example of FIG. 31, the delivery server 1002 reads the stream data 1011 from the stream storage device 1001. Then, the delivery server 1002 delivers the stream data 1011 directly to the PC 1004 having high processing capabilities. Because the AV device 1005 has low processing capabilities, the delivery server 1002 generates stream data 1012 containing only an encoded stream of the base layer extracted from the stream data 1011 and delivers the stream data 1012 to the AV device 1005. The delivery server 1002 delivers the stream data 1011 directly to the tablet device 1006 capable of communication at a high communication rate without change. Because the mobile phone 1007 can communicate only at a low communication rate, the delivery server 1002 delivers the stream data 1012 containing only an encoded stream of the base layer to the mobile phone 1007.

By using the multiplexed stream in this manner, the amount of traffic to be transmitted can be adaptively adjusted. In addition, the code amount of the stream data 1011 is reduced when compared with a case when each layer is individually encoded and thus, even if the whole stream data 1011 is delivered, the load on the network 1003 can be lessened. Further, memory resources of the stream storage device 1001 are saved.

Hardware performance of the terminal devices is different from device to device. In addition, capabilities of applications run on the terminal devices are diverse. Further, communication capacities of the network 1003 are varied. Capacities available for data transmission may change every moment due to other traffic. Thus, before starting delivery of stream data, the delivery server 1002 may acquire terminal information about hardware performance and application capabilities of terminal devices and network information about communication capacities of the network 1003 through signaling with the delivery destination terminal device. Then, the delivery server 1002 can select the stream to be delivered based on the acquired information.

Incidentally, the layer to be decoded may be extracted by the terminal device. For example, the PC 1004 may display a base layer image extracted and decoded from a received multiplexed stream on the screen thereof. In addition, after generating the stream data 1012 by extracting an encoded stream of the base layer from the received multiplexed stream, the PC 1004 may cause a storage medium to store the generated stream data 1012 or transfer the stream data to another device.

The configuration of the data transmission system 1000 shown in FIG. 31 is only an example. The data transmission system 1000 may include any number of the stream storage device 1001, the delivery server 1002, the network 1003, and the terminal devices.

### (2) Second Example

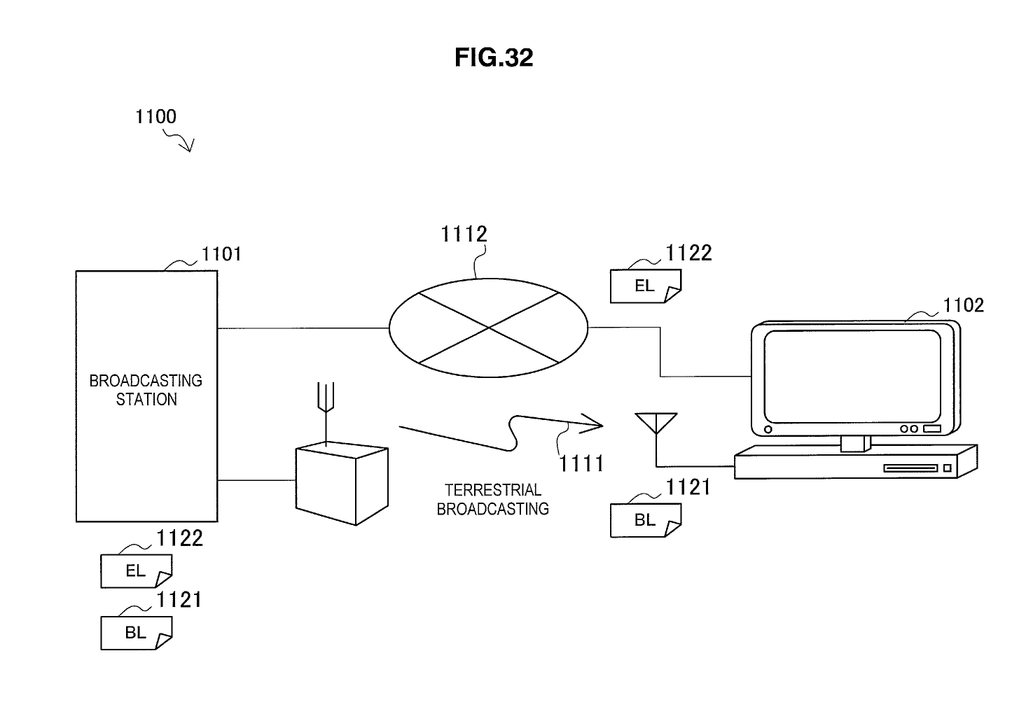

In the second example, scalable video coding is used for transmission of data via a plurality of communication channels. Referring to FIG. 32, a data transmission system 1100 includes a broadcasting station 1101 and a terminal device 1102. The broadcasting station 1101 broadcasts an encoded stream 1121 of the base layer on a terrestrial channel 1111. The broadcasting station 1101 also transmits an encoded stream 1122 of an enhancement layer to the terminal device 1102 via a network 1112.

The terminal device 1102 has a receiving function to receive terrestrial broadcasting broadcast by the broadcasting station 1101 and receives the encoded stream 1121 of the base layer via the terrestrial channel 1111. In addition, the terminal device 1102 also has a communication function to communicate with the broadcasting station 1101 and receives the encoded stream 1122 of the enhancement layer via the network 1112.

After receiving the encoded stream 1121 of the base layer, for example, in response to user's instructions, the terminal device 1102 may decode a base layer image from the received encoded stream 1121 and display the base layer image on the screen. Alternatively, the terminal device 1102 may cause a storage medium to store the decoded base layer image or transfer the base layer image to another device.

In addition, after receiving the encoded stream 1122 of the enhancement layer via the network 1112, for example, in response to user's instructions, the terminal device 1102 may generate a multiplexed stream by multiplexing the encoded stream 1121 of the base layer and the encoded stream 1122 of the enhancement layer. The terminal device 1102 may also decode an enhancement layer image from the encoded stream 1122 of an enhancement layer to display the enhancement layer image on the screen. Alternatively, the terminal device 1102 may cause a storage medium to store the decoded enhancement layer image or transfer the enhancement layer image to another device.

As described above, an encoded stream of each layer contained in a multiplexed stream can be transmitted via a different communication channel for each layer. Accordingly, a communication delay or an occurrence of overflow can be suppressed by distributing loads exerted on individual channels.

Furthermore, the communication channel to be used for transmission may be dynamically selected in accordance with some conditions. For example, the encoded stream 1121 of the base layer whose data amount is relatively large may be transmitted via a communication channel having a wider bandwidth and the encoded stream 1122 of the enhancement layer whose data amount is relatively small may be transmitted via a communication channel having a narrower bandwidth. In addition, the communication channel on which the encoded stream 1122 of a specific layer is transmitted may be switched in accordance with the bandwidth of the communication channel. Accordingly, the load exerted on individual channels can be suppressed more effectively.

Note that the configuration of the data transmission system 1100 illustrated in FIG. 32 is only an example. The data transmission system 1100 may include any number of communication channels and terminal devices. The configuration of the system described herein may also be applied to uses other than broadcasting.

### (3) Third Example

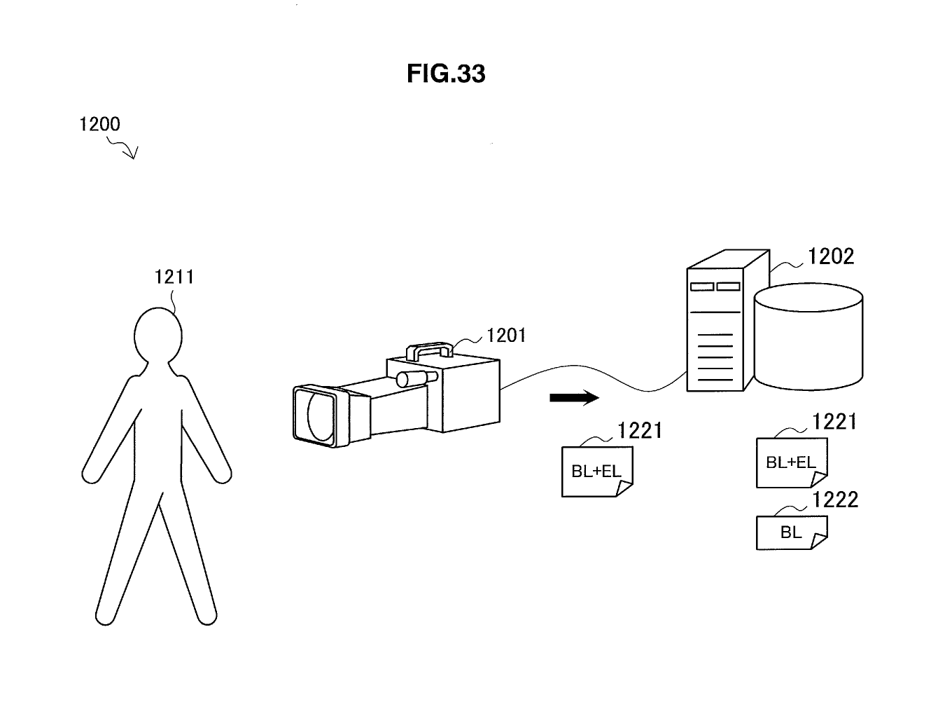

In the third example, scalable video coding is used for storage of videos. Referring to FIG. 33, a data transmission system 1200 includes an imaging device 1201 and a stream storage device 1202. The imaging device 1201 scalable-encodes image data generated with a subject 1211 being imaged to generate a multiplexed stream 1221. The multiplexed stream 1221 includes an encoded stream of the base layer and an encoded stream of an enhancement layer. Then, the imaging device 1201 supplies the multiplexed stream 1221 to the stream storage device 1202.

The stream storage device 1202 stores the multiplexed stream 1221 supplied from the imaging device 1201 in different image quality for each mode. For example, the stream storage device 1202 extracts the encoded stream 1222 of the base layer from the multiplexed stream 1221 in a normal mode and stores the extracted encoded stream 1222 of the base layer. On the other hand, in a high quality mode, the stream storage device 1202 stores the multiplexed stream 1221 as it is. Accordingly, the stream storage device 1202 can record a high-quality stream with a large amount of data only when recording of a video in high image quality is desired. Therefore, memory resources can be saved while the influence of image quality degradation on users is curbed.

For example, the imaging device 1201 is assumed to be a surveillance camera. When no surveillance object (for example, an intruder) appears in a captured image, the normal mode is selected. In this case, the captured image is likely to be unimportant and priority is given to the reduction of the amount of data so that the video is recorded in low image quality (that is, only the encoded stream 1222 of the base layer is stored). On the other hand, when a surveillance object (for example, the subject 1211 as an intruder) appears in a captured image, the high-quality mode is selected. In this case, the captured image is likely to be important and priority is given to high image quality so that the video is recorded in high image quality (that is, the multiplexed stream 1221 is stored).

In the example of FIG. 33, a mode is selected by the stream storage device 1202 based on, for example, an image analysis result. However, the present embodiment is not limited to such an example and the imaging device 1201 may select a mode. In the latter case, the imaging device 1201 may supply the encoded stream 1222 of the base layer to the stream storage device 1202 in the normal mode and the multiplexed stream 1221 to the stream storage device 1202 in the high-quality mode.

Any criteria are possible to select a mode. For example, a mode may be switched in accordance with the loudness of voice acquired through a microphone or the waveform of voice. In addition, a mode may also be periodically switched. Also, a mode may be switched in response to user's instructions. Further, the number of selectable modes may be any number as long as it does not exceed the number of hierarchized layers.

The configuration of the data transmission system 1200 illustrated in FIG. 33 is only an example. The data transmission system 1200 may include any number of the imaging device 1201. The configuration of the system described herein may also be applied to uses other than the surveillance camera.

### 6-3. Others

(1) Application to a Multi-View Codec

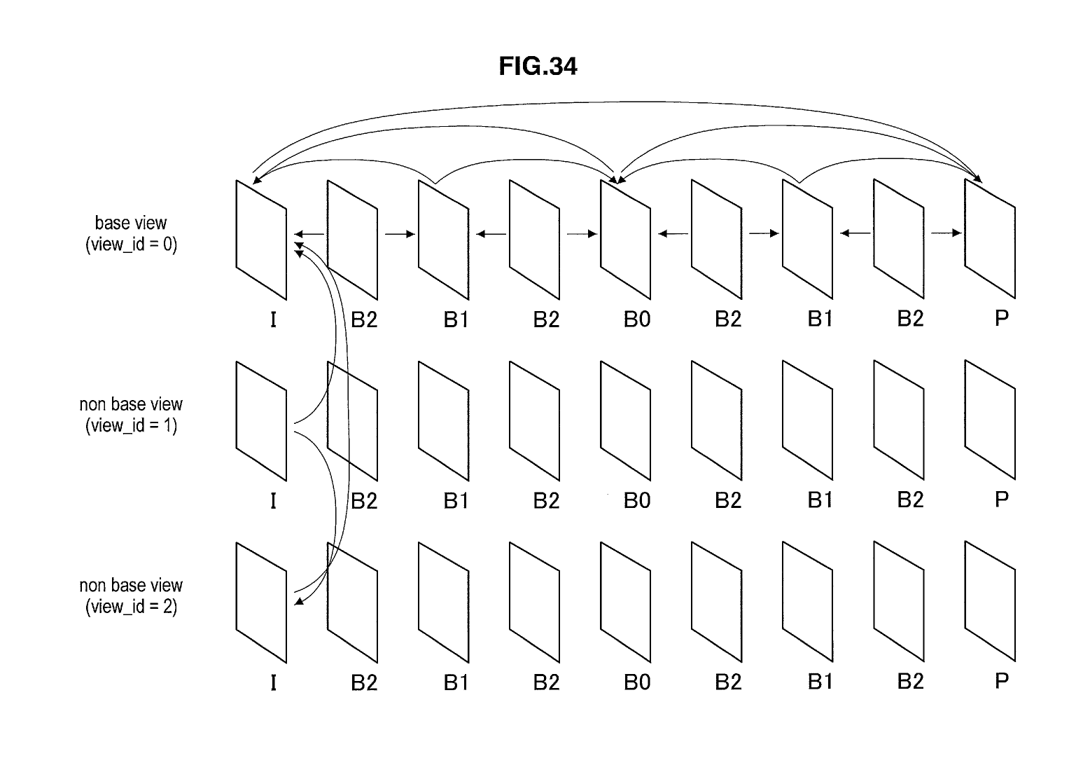

The multi-view codec is a kind of multi-layer codecs and is an image coding scheme to encode and decode so-called multi-view videos. FIG. 34 is an illustrative diagram for describing a multi-view codec. Referring to FIG. 34, sequences of three view frames captured from three viewpoints are shown. A view ID (view_id) is given to each view. Among a plurality of these views, one view is specified as the base view. Views other than the base view are called non-base views. In the example of FIG. 34, the view whose view ID is “0” is the base view and two views whose view ID is “1” or “2” are non-base views. When these views are hierarchically encoded, each view may correspond to a layer. As indicated by arrows in FIG. 34, an image of a non-base view is encoded and decoded by referring to an image of the base view (an image of the other non-base views may also be referred to).

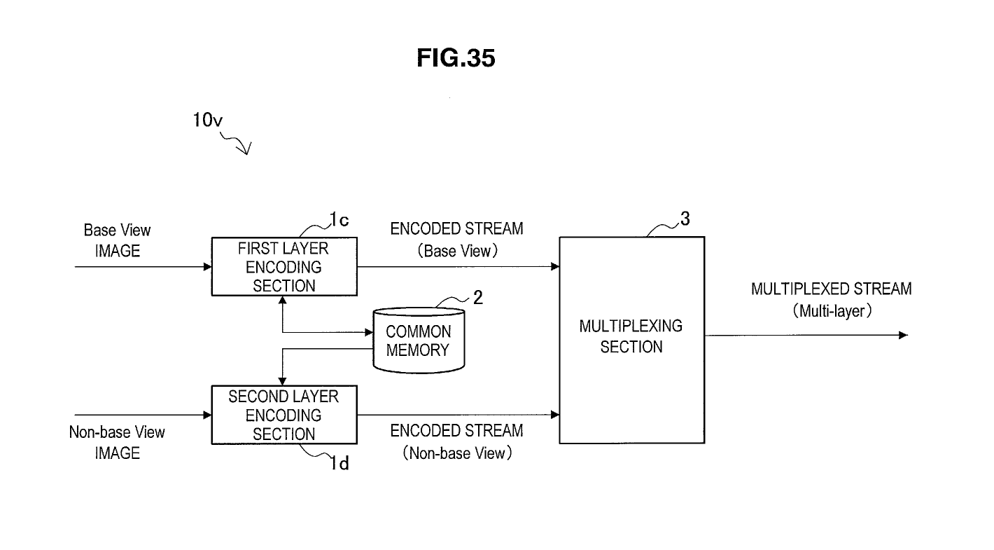

FIG. 35 is a block diagram showing a schematic configuration of an image encoding device 10v supporting the multi-view codec. Referring to FIG. 35, the image encoding device 10v is provided with a first layer encoding section 1c, a second layer encoding section 1d, the common memory 2, and the multiplexing section 3.

The function of the first layer encoding section 1c is the same as that of the BL encoding section 1a described using FIG. 3 except that, instead of a base layer image, a base view image is received as input. The first layer encoding section 1c encodes the base view image to generate an encoded stream of a first layer. The function of the second layer encoding section 1d is the same as that of the EL encoding section 1b described using FIG. 3 except that, instead of an enhancement layer image, a non-base view image is received as input. The second layer encoding section 1d encodes the non-base view image to generate an encoded stream of a second layer. The common memory 2 stores information commonly used in the layers. The multiplexing section 3 multiplexes an encoded stream of the first layer generated by the first layer encoding section 1c and an encoded stream of the second layer generated by the second layer encoding section 1d to generate a multilayer multiplexed stream.

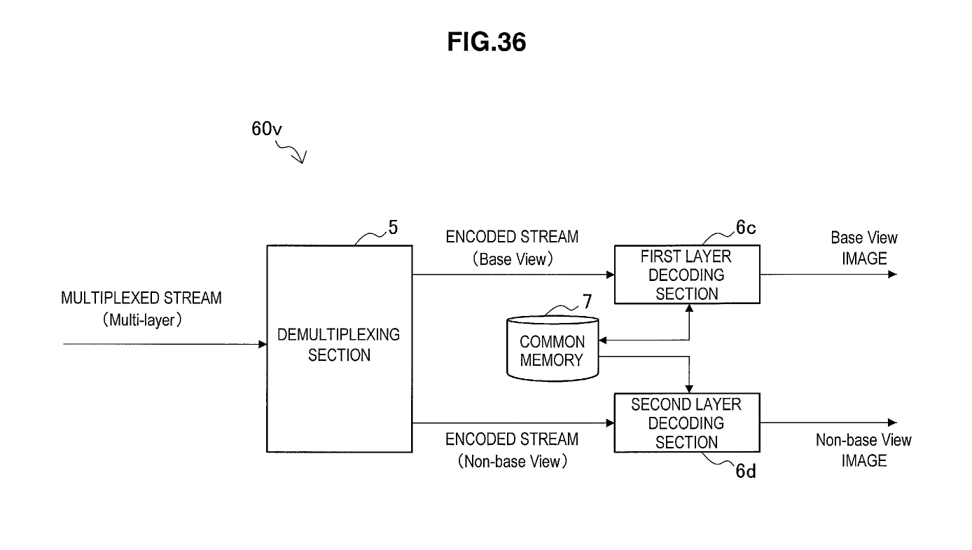

FIG. 36 is a block diagram showing a schematic configuration of an image decoding device 60v supporting the multi-view codec. Referring to FIG. 36, the image decoding device 60v is provided with the demultiplexing section 5, a first layer decoding section 6c, a second layer decoding section 6d, and the common memory 7.

The demultiplexing section 5 demultiplexes a multilayer multiplexed stream into an encoded stream of the first layer and an encoded stream of the second layer. The function of the first layer decoding section 6c is the same as that of the BL decoding section 6a described using FIG. 4 except that an encoded stream in which, instead of a base layer image, a base view image is encoded is received as input. The first layer decoding section 6c decodes a base view image from the encoded stream of the first layer. The function of the second layer decoding section 6d is the same as that of the EL decoding section 6b described using FIG. 4 except that an encoded stream in which, instead of an enhancement layer image, a non-base view image is encoded is received as input. The second layer decoding section 6d decodes a non-base view image from the encoded stream of the second layer. The common memory 7 stores information commonly used in layers.

When multi-view image data is encoded or decoded and the space resolution is different between the views, the upsampling between the views may be controlled according to a technology related to the present disclosure. Accordingly, as in the case of the scalable video coding, in the multi-view codec, it is also possible to efficiently suppress the calculation cost of the upsampling while preventing the deterioration in the image quality.

(2) Application to Streaming Technology

The technology of the present disclosure may also be applied to a streaming protocol. In Dynamic Adaptive Streaming over HTTP (MPEG-DASH), for example, a plurality of encoded streams having mutually different parameters such as resolution are prepared in a streaming server in advance. Then, the streaming server dynamically selects appropriate data to be streamed from the plurality of encoded streams in units of segments and delivers the selected data. In such a streaming protocol, the upsampling between the encoded streams may be controlled according to a technology related to the present disclosure.

### 8. Conclusion

Various embodiments of the technology related to the present disclosure have been described in detail above with reference to FIGS. 1 to 36. In the first embodiment, in a case in which an image of a first layer is used as a reference image at the time of decoding of an image of a second layer with a higher space resolution than the first layer, the filter configuration of the upsampling filter that upsamples the reference image is switched for each block. Accordingly, while there is a risk of the image quality deteriorating in some of the blocks in a method of simplifying the filter configuration uniformly, it is possible to prevent the deterioration in the image quality for each block. In the first execution example, the filter configuration is switched according to the strength of the high-pass component of each block. Accordingly, for example, by setting the number of filter taps to a small value in the block in which the high-pass component to be reproduced is not present or is weak, it is possible to efficiently suppress the calculation cost of the upsampling. In the second execution example, the filter configuration is switched by searching for the optimum configuration from the viewpoint of the coding efficiency and the filter configuration information indicating the selected filter configuration is transmitted from the encoding side to the decoding side. Accordingly, on the decoding side, the upsampling can be performed with the optimum filter configuration according to the filter configuration information without determining the strength of the high-pass component.

When the above-described structure is applied to the upsampling of the decoded image of the base layer, the suppression of the calculation cost and the prevention of the deterioration in the image quality of the reference image are achieved in, for example, the intra BL prediction, and thus the prediction accuracy can be improved. When the above-described structure is applied to the upsampling of the predicted error image of the base layer, the suppression of the calculation cost and the prevention of the deterioration in the image quality of the reference image are achieved in, for example, the intra residual prediction or the inter residual prediction, and thus the prediction accuracy can be improved.

In the first execution example, one or more of the TU size, the quantization parameter, the number of nonzero transform coefficients, the reference direction information in the inter prediction, the kind of offset in the sample adaptive offset process, and the intra prediction mode can be used to determine the strength of the high-pass component. Since these values can be known from coding parameters already specified in HEVC, additional parameters may not be introduced to realize the first execution example.

In a certain modification example, in a case in which an image of a first layer is used as a reference image at the time of decoding of an image of a second layer with a higher space resolution than the first layer, the filter configuration of the upsampling filter that upsamples the chroma component of the reference image is switched according to a chroma format. Accordingly, when the chroma format indicates that a chroma component has the same space resolution as a luma component, the number of same filter taps as the luma component can be ensured for the chroma component, and thus it is possible to prevent the deterioration in the image quality of the chroma component of the reference image caused by the upsampling. Accordingly, it is possible to improve the prediction accuracy of the inter layer prediction of the chroma component, and thus improve the coding efficiency.

In a certain execution example, when an image of a base layer is used as a reference image for the intra BL prediction at the time of decoding of an image of an enhancement layer, the transform coefficient data of the image of the enhancement layer is inversely quantized using the quantization matrix defined for the inter prediction mode rather than the intra prediction mode. Accordingly, since the appropriate quantization matrix proper for the tendency of a predicted error of the inter layer prediction is used, it is possible to prevent unintended deterioration in the image quality caused by the quantization.

In the second embodiment, the filter configuration is switched in the processing unit such as the video data, the picture, the sequence, or the like and the filter configuration information indicating the optimum filter configuration for each processing unit is transmitted from the encoding side to the decoding side. Even in this case, by performing the upsampling with the optimum filter configuration according to the filter configuration information on the decoding side, it is possible to suppress the calculation cost of the upsampling while preventing the deterioration in the image quality for each block. When the first embodiment is compared to the second embodiment, the coding amount of the filter configuration information encoded in the second embodiment is less.

In the foregoing description, a context related to the chroma format has been excluded and a difference in the number of taps between the horizontal direction and the vertical direction has not been particularly mentioned. However, the numbers of taps of the upsampling filter in both directions may be the same or may be different. When fewer taps of the upsampling filter are assigned in the vertical direction than in the horizontal direction, the size of a line memory necessary for the upsampling can be further decreased, and thus memory resources can be efficiently used.

The terms “CU,” “PU,” and “TU” described in the present specification refer to logic units also including the syntaxes relevant to the individual blocks in HEVC. When only individual blocks of a part of an image are of interest, these terms may be replaced with “coding block (CB),” “prediction block (PB),” and “transform block (TB),” respectively. A CB is formed by dividing a coding tree block (CTB) in a quad-tree form hierarchically. One entire quad-tree corresponds to the CTB and a logic unit corresponding to the CTB is referred to as a coding tree unit (CTU). The CTB and the CB in HEVC have roles similar to that of a macro block in H.264/AVC in that the CTB and the CB are processing units of the encoding process. However, the CTB and the CB are different from the macro block in that the sizes thereof are not fixed (the size of the macro block is normally 16×16 pixels). The size of the CTB is selected from 16×16 pixels, 32×32 pixels, and 64×64 pixels and is designated by a parameter in an encoded stream. The size of the CB can be varied according to the depth of the division of the CTB.

Mainly described herein is the example in which the various pieces of information such as the information related to upsampling control are multiplexed to the header of the encoded stream and transmitted from the encoding side to the decoding side. The method of transmitting these pieces of information however is not limited to such example. For example, these pieces of information may be transmitted or recorded as separate data associated with the encoded bit stream without being multiplexed to the encoded bit stream. Here, the term “association” means to allow the image included in the bit stream (the image may be a part of the image such as a slice or a block) and the information corresponding to the image to establish a link when decoding. Namely, the information may be transmitted on a different transmission path from the image (or the bit stream). In addition, the information may also be recorded in a different recording medium (or a different recording area in the same recording medium) from the image (or the bit stream). Furthermore, the information and the image (or the bit stream) may be associated with each other in an arbitrary unit such as a plurality of frames, one frame, or a portion within a frame.

The preferred embodiments of the present disclosure have been described above with reference to the accompanying drawings, whilst the present disclosure is not limited to the above examples, of course. A person skilled in the art may find various alternations and modifications within the scope of the appended claims, and it should be understood that they will naturally come under the technical scope of the present disclosure.

Additionally, the present technology may also be configured as below.

(1)

An image processing device including:

an upsampling filter configured to upsample an image of a first layer referred to at a time of decoding of an image of a second layer with a higher space resolution than the first layer; and

a control section configured to switch a filter configuration of the upsampling filter for each block of an image.

(2)

The image processing device according to (1), wherein the control section selects the filter configuration corresponding to encoded or decoded filter configuration information for each block.

(3)

The image processing device according to (1), wherein the control section selects the filter configuration according to strength of a high-pass component of each block for each block.

(4)

The image processing device according to any one of (1) to (3), wherein the filter configuration includes a number of filter taps.

(5)

The image processing device according to any one of (1) to (4), wherein the upsampling filter upsamples a decoded image of the first layer.

(6)

The image processing device according to any one of (1) to (4), wherein the upsampling filter upsamples a predicted error image of the first layer.

(7)

The image processing device according to (2), further including:

a decoding section configured to decode the filter configuration information from an encoded stream.

(8)

The image processing device according to (2), further including:

an encoding section configured to encode the filter configuration information to an encoded stream.

(9)

The image processing device according to (7) or (8), wherein the block is a prediction unit (PU).

(10)

The image processing device according to (3), wherein the control section determines the strength of the high-pass component using a size of a transform unit (TU) of the first layer.

(11)

The image processing device according to (3), wherein the control section determines the strength of the high-pass component using a quantization parameter of the first layer.

(12)

The image processing device according to (3), wherein the control section determines the strength of the high-pass component using a number of nonzero transform coefficients of the first layer.

(13)

The image processing device according to (3), wherein the control section determines the strength of the high-pass component using reference direction information in inter prediction of the first layer.

(14)

The image processing device according to (3), wherein the control section determines the strength of the high-pass component using a kind of offset in a sample adaptive offset process of the first layer.

(15)

The image processing device according to (3), wherein the control section determines the strength of the high-pass component in regard to each block of the first layer according to whether a smoothing filter is applied according to a selected intra prediction mode.

(16)

In the image processing device described in the above (10), the control section may set the number of filter taps of the upsampling filter to a first value when the TU size is greater a threshold value, and set the number of filter taps to a second value greater than the first value when the TU size is less than the threshold value.

(17)

In the image processing device described in the above (11), the control section may set the number of filter taps of the upsampling filter to a first value when the quantization parameter is greater than a threshold value, and set the number of filter taps to a second value greater than the first value when the quantization parameter is less than the threshold value.

(18)

In the image processing device described in the above (12), the control section may set the number of filter taps of the upsampling filter a first value when the number of nonzero transform coefficients is less than the threshold value, and set the number of filter taps to a second value greater than the first value when the number of nonzero transform coefficients is greater than the threshold value.

(19)

In the image processing device described in the above (13), the control section may set the number of filter taps of the upsampling filter to a first value when the reference direction information indicates bi-prediction, and set the number of filter taps to a second value greater than the first value when the reference direction information does not indicate the bi-prediction.

(20)

In the image processing device described in the above (14), the control section may set the number of filter taps of the upsampling filter to a first value when the kind of offset indicates edge offset, and set the number of filter taps to a second value greater than the first value when the kind of offset does not indicate the edge offset.

(21)

In the image processing device described in the above (15), the control section may set the number of filter taps of the upsampling filter to a first value in regard to a block to which the smoothing filter is applied, and set the number of filter taps to a second value greater than the first value in regard to a block to which the smoothing filter is not applied.

(22)

In the image processing device described in any one of the above (3) and (10) to (21), the control section may switch a filter configuration of the upsampling filter according to a picture type and strength of the high-pass component determined for each block.

(23)

In the image processing device described in any one of the above (1) to (22), the filter configuration may include a filter coefficient.

(24)

The image processing device described in any one of the above (1) to (23) may further include an inverse quantization section configured to inversely quantize transform coefficient data of an image of the second layer using a quantization matrix defined for an inter prediction mode when an image of the first layer is used as a reference image for intra BL prediction at a time of decoding of the image of the second layer.

(25)

In the image processing device described in the above (4), the control section may select 8 or 7 taps or 4 taps for a luma component and select 4 taps or 2 taps for a chroma component.

(26)

An image processing method includes upsampling an image of a first layer referred to at a time of decoding of an image of a second layer with a higher space resolution than the first layer using an upsampling filter; and switching a filter configuration of the upsampling filter for each block of an image.

The following configurations also pertain to the technical scope of the present disclosure.

(1)

An image processing device includes: an upsampling filter configured to upsample a chroma component of an image of a first layer referred to at a time of decoding of an image of a second layer with a higher space resolution than the first layer; and a control section configured to switch a filter configuration of the upsampling filter according to a chroma format.

(2)

In the image processing device described in the above (1), the control section may switch the number of filter taps of the upsampling filter according to the chroma format.

(3)

In the image processing device described in the above (1) or (2), the upsampling filter may upsample a chroma component of a decoded image of the first layer.

(4)

In the image processing device described in any one of the above (1) to (3), the upsampling filter may upsample the chroma component of a predicted error image of the first layer.

(5)

In the image processing device described in any one of the above (1) to (4), the control section may set the number of filter taps of the upsampling filter to a smaller value than the number of filter taps for a luma component in both of a horizontal direction and a vertical direction when the chroma format is 4:2:0.

(6)

In the image processing device described in any one of the above (1) to (5), the control section may set the number of filter taps of the upsampling filter to a smaller value than the number of filter taps for the luma component in the horizontal direction and may set the number of filter taps to the same value as the filter taps for the luma component in the vertical direction when the chroma format is 4:2:2.

(7)

In the image processing device described in any one of the above (1) to (6), the control section may set the number of filter taps of the upsampling filter to the same value as the number of filter taps for the luma component in both of the horizontal direction and the vertical direction when the chroma format is 4:4:4.

(8)

An image processing method includes upsampling a chroma component of an image of a first layer referred to at a time of decoding of an image of a second layer with a higher space resolution than the first layer using an upsampling filter; and switching a filter configuration of the upsampling filter according to the chroma format.

The following configurations also pertain to the technical scope of the present disclosure.

(1)

An image processing device includes: an upsampling filter configured to upsample an image of a first layer referred to at a time of decoding of an image of a second layer with a higher space resolution than the first layer; and an inverse quantization section configured to inversely quantize transform coefficient data of the image of the second layer using a quantization matrix defined for an inter prediction mode when the image of the first layer is used as a reference image for intra BL prediction at a time of decoding of the image of the second layer.

(2)

An image processing method includes: upsampling an image of a first layer referred to at a time of decoding of an image of a second layer with a higher space resolution than the first layer; and inversely quantizing transform coefficient data of the image of the second layer using a quantization matrix defined for an inter prediction mode when the image of the first layer is used as a reference image for intra BL prediction at a time of decoding of the image of the second layer.

The following configurations also pertain to the technical scope of the present disclosure.

(1)

An image processing device includes: a control section configured to select a filter configuration for upsampling an image of a first layer referred to at a time of decoding of an image of a second layer with a higher space resolution than the first layer from a plurality of different configurations; and an upsampling filter configured to generate an upsampled image corresponding to the filter configuration selected by the control section by upsampling the image of the first layer.

(2)

In the image processing device described in the above (1), the control section may select the filter configuration corresponding to encoded or decoded filter configuration information.

(3)

In the image processing device described in the above (2), the filter configuration may include the number of filter taps.

(4)

In the image processing device described in any one of the above (1) to (3), the upsampling filter may upsample a decoded image of the first layer.

(5)

In the image processing device described in any one of the above (1) to (3), the upsampling filter may upsample a predicted error image of the first layer.

(6)

The image processing device described in the above (2) or (3) may further include a decoding section configured to decode the filter configuration information from an encoded stream.

(7)

In the image processing device described in the above (6), the decoding section may decode the filter configuration information from a video parameter set (VPS), a sequence parameter set (SPS), or a picture parameter set (PPS) of an encoded stream.

(8)

In the image processing device described in the above (7), the filter configuration information may include a threshold value compared to time hierarchy of each picture. The control section may select the first number of filter taps for a picture of time hierarchy shallower than the threshold value decoded by the decoding section and select the second number of filter taps less than the first number of filter taps for a picture of time hierarchy deeper than the threshold value.

(9)

The image processing device described in the above (2) or (3) may further include an encoding section configured to encode the filter configuration information to an encoded stream.

(10)

In the image processing device described in the above (9), the encoding section may encode the filter configuration information to a video parameter set (VPS), a sequence parameter set (SPS), or a picture parameter set (PPS) of an encoded stream.

(11)

In the image processing device described in the above (10), the filter configuration information may include a threshold value compared to time hierarchy of each picture. The control section may select the first number of filter taps for a picture of time hierarchy shallower than the threshold value encoded by the encoding section and select the second number of filter taps less than the first number of filter taps for a picture of time hierarchy deeper than the threshold value.

(12)

In the image processing device described in the above (3), the control section may select 8 or 7 taps or 4 taps for a luma component and select 4 taps or 2 taps for a chroma component.

(13)

In the image processing device described in the above (8) or (11), for the luma component, the first number of filter taps may be 8 or 7 taps and the second number of filter taps may be 4 taps.

(14)

In the image processing device described in any one of the above (1) to (13), the filter configuration may include a filter coefficient.

(15)

An image processing method includes: selecting a filter configuration for upsampling an image of a first layer referred to at a time of decoding of an image of a second layer with a higher space resolution than the first layer from a plurality of different configurations; and generating an upsampled image corresponding to the selected filter configuration by upsampling the image of the first layer.

### REFERENCE SIGNS LIST

10, 10v image encoding device (image processing device)
16, 116 lossless encoding section
21 inverse quantization section
42, 46, 146 filter control section
44, 48 upsampling filter
60, 60v image decoding device (image processing device)
62, 162 lossless decoding section
63 inverse quantization section
92, 95, 195 filter control section
94, 97 upsampling filter

1. An image processing device comprising:
an upsampling filter configured to upsample an image of a first layer referred to at a time of decoding of an image of a second layer with a higher space resolution than the first layer; and
a control section configured to switch a filter configuration of the upsampling filter for each block of an image.

2. The image processing device according to claim 1, wherein the control section selects the filter configuration corresponding to encoded or decoded filter configuration information for each block.

3. The image processing device according to claim 1, wherein the control section selects the filter configuration according to strength of a high-pass component of each block for each block.

4. The image processing device according to claim 1, wherein the filter configuration includes a number of filter taps.

5. The image processing device according to claim 1, wherein the upsampling filter upsamples a decoded image of the first layer.

6. The image processing device according to claim 1, wherein the upsampling filter upsamples a predicted error image of the first layer.

7. The image processing device according to claim 2, further comprising:
a decoding section configured to decode the filter configuration information from an encoded stream.

8. The image processing device according to claim 2, further comprising:
an encoding section configured to encode the filter configuration information to an encoded stream.

9. The image processing device according to claim 7, wherein the block is a prediction unit (PU).

10. The image processing device according to claim 3, wherein the control section determines the strength of the high-pass component using a size of a transform unit (TU) of the first layer.

11. The image processing device according to claim 3, wherein the control section determines the strength of the high-pass component using a quantization parameter of the first layer.

12. The image processing device according to claim 3, wherein the control section determines the strength of the high-pass component using a number of nonzero transform coefficients of the first layer.

13. The image processing device according to claim 3, wherein the control section determines the strength of the high-pass component using reference direction information in inter prediction of the first layer.

14. The image processing device according to claim 3, wherein the control section determines the strength of the high-pass component using a kind of offset in a sample adaptive offset process of the first layer.

15. The image processing device according to claim 3, wherein the control section determines the strength of the high-pass component in regard to each block of the first layer according to whether a smoothing filter is applied according to a selected intra prediction mode.

16. The image processing device according to claim 3, wherein the control section switches the filter configuration of the upsampling filter according to a picture type and the strength of the high-pass component determined for each block.

17. The image processing device according to claim 1, wherein the filter configuration includes a filter coefficient.

18. The image processing device according to claim 1, further comprising:
an inverse quantization section configured to inversely quantize transform coefficient data of the image of the second layer using a quantization matrix defined for an inter prediction mode when the image of the first layer is used as a reference image for intra BL prediction at a time of decoding of the image of the second layer.

19. The image processing device according to claim 4, wherein the control section selects 8 or 7 taps or 4 taps for a luma component and selects 4 taps or 2 taps for a chroma component.

20. An image processing method comprising:
upsampling an image of a first layer referred to at a time of decoding of an image of a second layer with a higher space resolution than the first layer using an upsampling filter; and
switching a filter configuration of the upsampling filter for each block of an image.
